(19) United States
(12) Patent Application Publication
(10) Pub. No.: US 2009/0287737 A1
(43) Pub. Date: Nov. 19, 2009

(54) ARCHITECTURE FOR ENABLING RAPID DATABASE AND APPLICATION DEVELOPMENT

(76) Inventor: Wayne Hammerly, Newport Beach, CA (US)

Correspondence Address: CHANCELLOR IP, 3463 RED BLUFF CT., SEMI VALLEY, CA, 93063, US

(21) Appl. No.: 12/258,412

(22) Filed: Oct. 26, 2008

Related U.S. Application Data
(60) Provisional application No. 61/001,328, filed on Oct. 31, 2007.

(51) Int. Cl. G06F 7/00

(52) U.S. Cl. 707/103 R; 707/E17.055

(57) ABSTRACT

Raptive is a technical, object-oriented database and architecture allowing for rapid development process cycles. It is a process of three technologies that are unique. The first process technology is an object-oriented, entity-centric database technology process. This process is called Raptor. The second process is a browser-based UI/IDE process that allows for rapid Integrated Design, and the management of objects within a database. The process allows users to interact with data and the database. The third process is a series of objects that access the Raptive database using program languages.

This application claims the benefit of U.S. Provisional Pat. Appl. No. 61/001,328 filed Oct. 31, 2007 entitled Architecture That Enables Rapid Database And Application Development.

### SUMMARY OF THE INVENTION

Now, in accordance with the invention, there has been found a database architecture comprising a relational database management system and a database schema, the database schema being object oriented and entity centric and the database schema running on the relational database management system.

In an embodiment, a plurality of entities are stored in the database architecture, each one of said entities being related to at least another one of said entities and the relationship including at least one of an attribute relationship and a hierarchical relationship. In some embodiments, a plurality of the relationships comprise attribute and hierarchical relationships.

In some embodiments, no primary key is used by the database architecture. And in some embodiments, no foreign key is used by the database architecture.

### BRIEF DESCRIPTION OF THE DRAWINGS

The present invention is described with reference to the accompanying drawings that illustrate the present invention and, together with the description, explain the principles of the invention enabling a person skilled in the relevant art to make and use the invention.

FIG. 1 is a block diagram in accordance with the database architecture of the present invention.

FIG. 2 is a block diagram of related entities stored in the database architecture of FIG. 1.

### DESCRIPTION OF THE PREFERRED EMBODIMENTS

While various embodiments of the present invention will be described below, it should be understood that they are presented by way of example only, and not limitation. It will be apparent to those skilled in the art that various changes in the form and details can be made without departing from the spirit and scope of the invention. As such, the breadth and scope of the present invention should not be limited by the below-described exemplary embodiments, but should be defined only in accordance with the claims and equivalents thereof.

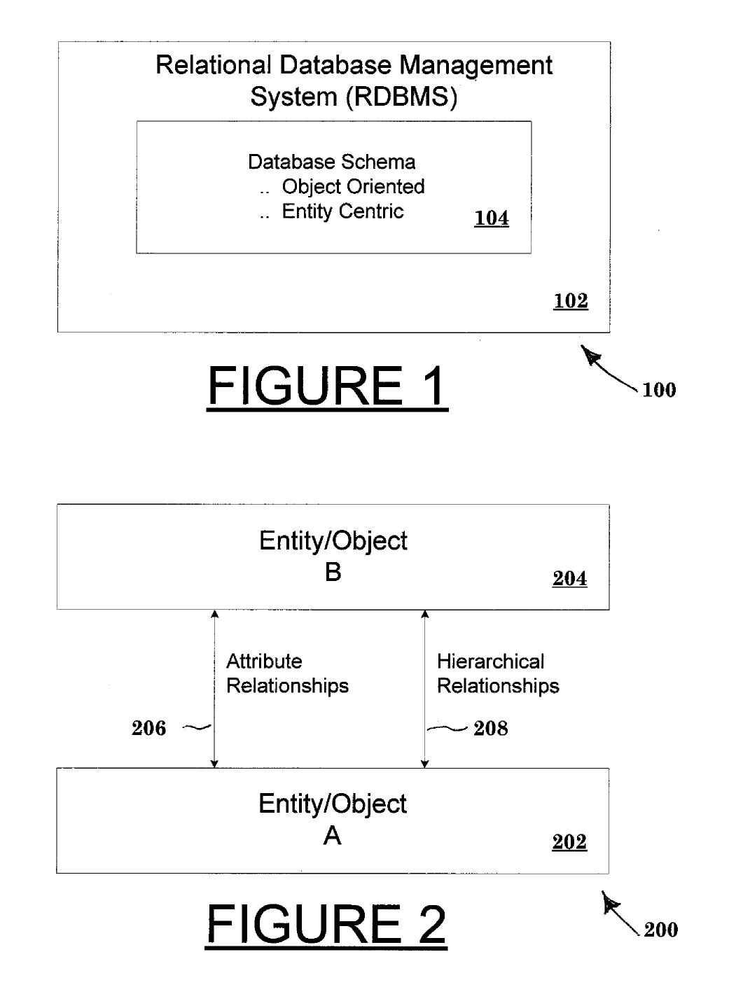

FIG. 1 shows a block diagram in accordance with the database architecture of the present invention 100. As shown in the figure, an object oriented, entity centric database schema 104 runs on a relational database management system (RDMS) 102.

FIG. 2 shows a block diagram of related entities stored in the database architecture 200. As shown in the figure, two entities or objects A and B 202, 204 are related. In an embodiment the relationship is an attribute relationship 206. In another embodiment, the relationship is a hierarchical relationship 208. And, in some embodiments, the relationship comprises both attribute and hierarchical relationships.

Raptive® is an object-oriented database and a Very Rapid Application Development (VRAD) tool and process that allows you to build and manage object-oriented databases point-and-click without programming.

Raptive is based on three proprietary technologies that we created here at Raptive Technologies:
1. The first technology is the object-oriented, entity-centric database technology that we call Raptor.
2. The second technology is a browser-based software application that we call the Raptive UI/IDE which provides both an Integrated Design Environment (IDE) to create and manage the objects in the database as well as an extensible User Interface that allows users to interact with the data and the database.
3. The third technology is a set of .Net Application Programming Interface (API) objects that are used to access the Raptive database using Visual Studio programming languages such as C# or Visual Basic.Net that we call Raptive.Net

These technologies are collectively known as the Raptive Framework.

### Prerequisite Knowledge

Persons of ordinary skill in the art will be familiar with the following:
Basic database concepts such as Structured Query Language (SQL), schemas, tables, and stored procedures
Microsoft Visual Studio 2005 and .Net development. The examples in this manual focus on mainly creating web or browser-based user interfaces. These examples can be easily adapted to meet other needs such as desktop or automated applications.

### Raptive Overview

This overview describes some of the database and design concepts used in Raptive including object-oriented concepts.

### Relational Database Design

Most modern database systems, such as Oracle, Sybase, and Microsoft SQL Server, are known as “relational” databases. The term “relational” means that each piece of data that is stored in the database is related to some other piece of data in some fashion. Without going into a tutorial on database design theory, what this means is that each piece of data is uniquely identified via a key or a relationship with some other unit of data and cannot be confused with any other unit of data. For example, a unit of information, such as a particular expense, cannot be confused with any other expense.

The standard and accepted relational database design principles that have been honed over the past 25 or so years are based on the concept of rows and columns stored in a table. This table-based principle allows the database designer to “model” a database schema to meet a wide range of needs and requirements. Let's use an on-line store as an example. In this example, the database modeler must design a database in which to store the various products that the on-line store sells. Since the store sells a wide range of products, traditional database design techniques would call for a set of tables in which to store the data. Let's start with a table to store music CD's. The table could have columns for:
ProductID
Artist
Title
SKU
Manufacturer
Release Date

In SQL Server, the table would look something like this:

Each row in the table would contain one CD. The information in the table would look something like this:

| Product | | | | | Release |
|---|---|---|---|---|---|
| ID | Artist | Title | SKU | Manufacturer | Date |
| 1001 | Janis | Pearl | CK 65786 | Columbia | 1970 |
| | Joplin | | | | |
| 1002 | Kansas | Best of Kansas | ZK 39283 | CBS | 1984 |
| 1003 | Eric | Unplugged | 9 45024-2 | Reprise | 1992 |
| | Clapton | | | | |

Since we also want to store a list of songs for each CD, we would need another table for the songs. The songs (tracks) in the Tracks table are related to the CD table via the ProductID and would look like this:

The Tracks table contains the song information for each CD, keyed on the Product ID. There would be one row of data for each song on the CD:

| ProductID | Title | Length |
|---|---|---|
| 1001 | Move Over | 3:40 |
| 1001 | Cry Baby | 3:56 |
| 1001 | A Woman Left Lonely | 3:28 |
| 1001 | Half Moon | 3:52 |
| 1001 | Buried Alive In The Blues | 2:25 |
| 1001 | My Baby | 3:45 |
| 1001 | Me And Bobby McGee | 4:30 |
| 1001 | Mercedes Benz | 1:46 |
| 1001 | Trust Me | 3:15 |
| 1001 | Get It While You Can | 3:23 |
| 1002 | Carry On Wayward Son | 5:22 |
| 1002 | Point of Know Return | 3:11 |
| 1002 | Fight With Fire | 3:40 |
| 1002 | Dust InThe Wind | 3:27 |

In this example, Janis Joplin's Pearl CD has a ProductID of 1001 that acts as the unique key. We can find all of the songs on the Pearl CD by looking at the rows in the Tracks table that also have a ProductID of 1001. This linking of data in multiple tables using a “key” is the very essence of a “relational” database.

The Problems with Standard Database Design

This is a good example of the basic premise of a relational database, and this type of design has been used for decades. This design is all well and good when the database designer knows in advance exactly what the data will look like and is sure that the data requirements will not change. But what happens when our on-line store adds another product line such as books, computers, printers, and so on?

Obviously, we cannot store printers in the CD table, because printers require a totally different set of columns. Printers do not have Artist or Title columns, nor does a printer have tracks (songs). This highlights one of the problems with conventional database design: How to effectively store information about all of the products for the on-line store requires one or more tables for each type of product that the store sells. At one international e-commerce web site, I was appalled to find over 330 different product tables—with another 400 being planned! The design was a house of cards that was completely unmanageable.

Another common flaw with standard database design emerges when management needs to relate a single data item to dozens or hundreds of other structured and unstructured data items in ways that make sense to both the business and to the user. Modern relational databases have severe limitations on the number of relationships per table. Working within the relational constraints of even the latest versions of Oracle or Microsoft SQL Server will test the mettle of even the best database designers and will typically result in a massive database with a table schema that can (and usually will) boggle the mind.

These problems can be easily and effectively eliminated using object-oriented principals (OOP). Using an object-oriented design, it is quite easy to design a class for each product in the database. Music CD's would have a class with the fields for required for a CD, and a Printer class would have the fields required to describe a printer. An object-oriented database knows how to store objects and does not care if it is a CD object or a printer object—it just knows objects. Thus, in an object-oriented database, all of the information pertaining to a CD, a printer, and any other class of object can be stored in the same place in the same manner. Similarly, an object can contain either structured or unstructured data and object relationships do not have the same limitations as table relationships.

Raptive is the realization of the OO database design goal: any piece of data that one can imagine can be stored in Raptive. Raptive is a revolutionary design that overcomes the traditional problems associated with fixed tables with fixed columns and allows literally any type of data to be stored in a single, cohesive manner within a database.

### Object-Oriented Design

To the layman, the term “object-oriented” (aka “00”) sounds like some esoteric programming jargon (which it actually is). With Raptive, OO is not just for programmers anymore. Managers, end users, analysts, programmers, and database administrators will all interact with Raptive and each will have impact on the design of new applications. So what the heck is an “object”? That depends on your point of view. Most programmers know about Object-Oriented Principles (OOP) from a computer science and programming language point of view. Others who use Raptive may not be so familiar with the concepts so let's start with the basics.

Object-Oriented Concepts

So back to our question of what the heck is an “object”?

In short, everything that you can possibly imagine can be thought of as an object. A pen, or a pad of paper, or a saltshaker—each can be thought of as an object. Let's use the saltshaker as an example of objects and how OO is just as important to the person talking about Raptive as it is to the programmer designing and building Raptive.

So, a saltshaker is an object—as such, it has “properties” that describe the object and “methods” that define what the object does or what can be done with the object. Everything that a human can imagine can be boiled down to objects that have properties and methods. In the OO world, each object is based on class which is a template that describes what objects that are based on that template look like. We can simplify things if we think of a class as an abstract idea and an object as a real-world physical manifestation of a class.

Using our saltshaker object as an example, we can say that the saltshaker is based on the shaker class. Our shaker class can have the following properties:
Size—the dimensions of the shaker
Shape—the shape of the shaker
Material—what it is made of such as glass, wood, metal, etc.
Color—the color of the shaker
Contents—what it is filled with (which in turn is another object)

Once we have filled in all of the blanks (properties) and created an instance of the shaker class, we get an object. If we specify that the Contents property of our shaker class is salt, we have a saltshaker object. If we specify a different Contents property for the shaker class, such as pepper, we get a peppershaker object. Both the saltshaker and peppershaker objects are instances of the shaker class.

Objects have methods that describe how the object is used or what the object does. Continuing with our example, a shaker class could have the following methods:
Fill—put something in the shaker
Empty—remove all contents from the shaker
Pour—empty the contents from the shaker real fast
Sprinkle—empty the contents from the shaker a little at a time
Clean—wash the shaker (Business Rule: Run the Empty method first!)

Objects can be nested together to create even more complex objects. For example, the salt in our shaker is an object that has its own set of properties and methods. This nesting of objects can be handled in multiple ways and the object oriented programming terms of polymorphism and inheritance come into play here. While it is beyond the scope of this introduction to get into such arcane subjects, suffice to say that objects can be nested into a more complex object by either merging some of the traits of the two classes (polymorphism) or by having one class inherit the characteristics of one or more other classes (inheritance).

Objects are powerful tools for the design and the implementation of software as well as visualizing or conceptualizing abstract ideas. OO principals can be used both to simplify a design and to make it more powerful and flexible. One of the real powers in OO is the fact that we can work at two levels: the class level, and the object level. At the class level, we are dealing with “an object” without caring what the object really is. That means that a concept or a piece of code can deal with the object without caring if it is a saltshaker, a pepper shaker, or a Mack truck. In this regard, we can say, “an object is an object is an object”.

At the object level, once we have instantiated¹ the class, we can differentiate between a saltshaker and a peppershaker. When we want salt, we use an instance of² the saltshaker object, and when we want pepper, we use an instance of the peppershaker object—both of which are based on the shaker class. Business rules such as don't shake the Mack Truck object over your morning eggs come into play here as well. So far this seems rather abstract, but as we get into the underlying design of the Raptive software and the Raptor database, it will become apparent why this information is important in understanding what Raptive can do for you. ¹Instantiation is a fancy OOP way of saying “created”.²An instance of an object is the physical manifestation of a class. We could easily create hundreds of instances of the object and then use just one, just as a manufacturer could make many saltshakers but the one on the table in front of us is the “instance” we use to spice up our eggs.

Object-Oriented Database Design

Modern database systems such as Oracle and Microsoft SQL Server are “relational” databases and, by definition and design, are not object-oriented. What we have done with the Raptor database design is to use OO (object-oriented) principals in the design of the database and to utilize state-of-the-art relational database engines to implement a radical new concept in table and index design and usage. The end result is a fully object-oriented, entity-centric system that merges OO and relational database principles to provide the benefits of an object-oriented approach without sacrificing the power, speed, flexibility and maturity of the modern relational database.

We call the result of implementing this object-oriented design in a relational database “Entity-Centric Design”.

### Entity-Centric Design

In order to differentiate between programming objects and database objects, we utilized the concept of an “Entity” which is analogous to an object for programming. Each Entity in Raptive is based on an “Entity Template”, which is analogous to a base class. Each Entity has “Attributes” which are analogous to properties, and “Activities” which are analogous to methods. Thus, since objects with properties and methods can represent anything in the conceptual universe, we can use the same concept at the physical database level and use Entities with Attributes and Activities represent anything in the universe in a database. The Raptive design is based on the object-oriented concept of an Entity—thus we call it an “Entity-Centric” design. With Raptive, the mantra to remember is: “an Entity is an Entity is an Entity”.

What this means is that almost everything in Raptive is really an Entity (capitalized to denote that we are speaking of a Raptive Entity as opposed to just any old entity) under the covers. So what is an “Entity”? There are two ways to look at this, and it is important to understand both.

First, at the conceptual level, an Entity is an OO object. Just like any OO object, each Entity has attributes (properties) that describe the Entity and Activities (methods) that describe what the Entity can do or what can be done to the Entity. Even though attributes and properties are synonymous, as are activities and methods, we will use the terms Entity, Attributes, and Activities (capitalized) when talking about objects in the Raptive database and reserve the terms objects, properties, and methods for actual code-based objects and classes written in OO languages such as C++, C#, Java, or Visual Basic. This helps clarify when we are talking about database entities as opposed to code-based objects.

Raptive Entities are based on Entity Templates which can be thought of as a class. For example, let's say that we create an Employee Entity Template in Raptive. The Employee Entity Template is the class for our employees and defines what an Employee object “looks like” and how it “works”. Each Employee Entity that we create will be an instance of the Employee Entity Template class. In OO this is known as an “Is a” relationship.

Entities have an “Is a” relationship to the Entity Template. In the example shown above, the Entity “Employee—John Doe” “is a” Employee. Every Employee Entity in the database will inherit from the Employee Template class. If we add a new Attribute or Activity (property or method) to the Employee Template class, each Employee object will inherit the new Attribute or Activity.

Since Raptive is a database and must adhere to database concepts as well as OO concepts, there can be only one “Employee—John Doe” Entity in Raptive. From a database perspective, this is a one-to-one relationship between the employee data for John Doe in the database and the “Employee—John Doe” Entity.

The second way to look at entities is a more generalist approach that is better suited to the layman. Since everything in Raptive is an Entity, one can say that there is no difference between a “project” and a “department” or between a “computer” and an “employee”—at least as far as Raptive is concerned. Forget for a moment that there are massive differences between a computer and an employee insofar as one is a piece of equipment and one is a person. The point is that as far as Raptive is concerned, they are all Entities that merely have different Attributes and Activities.

That means that any capability that we design for one Entity can be inherited by any other Entity. For example, if we empower one type of Entity with a particular activity, we can apply the same activity to any other Entity within Raptive. This means that if someone asks: “if a project can do this, can a department also do this?” the unequivocal answer would always be yes because an Entity is an Entity is an Entity.

Raptive Entity and Activity Basics

The basic design of the Raptive database revolves around the concept of an Entity. A Raptive Entity can represent virtually anything that can be imagined. It is essential to bear in mind that at the database level, almost everything within Raptive is an Entity. Thus, a company can create one or more “project” Entities while a farmer can create “cow” entities. This allows a company to track the progress of a project while a farmer tracks the progress of a bovine.

Each Entity within Raptive has a basic logical structure (object model):

This diagram is quite similar to an object UML (Unified Modeling Language) diagram. In fact, UML can be used to model any Entity within Raptive. This is especially helpful to customers who have an IT department that is familiar with OOP and UML. For the .Net programmer, this structure can be thought of as:
.Entity
.Entity.Attributes( )
.EntityActivities( )
.Entity.Addresses( )
.Entity.Phones( )
.Entity.Contacts( )
   .Entity.Contacts( ).Addresses( )
   .Entity.Contacts( ).Phones

This structure should be very familiar to .Net programmers, which is not surprising considering that the Raptive database design is based on object-oriented principles. Bear in mind that we are talking about the database model here. As we will see a bit later on, Raptive.Net closely mirrors the Raptive database model.

Entity Attributes

As the Entity object model on the previous page shows, each Entity in Raptive has a collection of Entity Attributes that can be thought of as properties or fields in which to store information. Each Entity Attribute contains one piece of data such as a First Name or a Date of Birth. In many ways Attributes really work just like a field in a traditional database.

Addresses, Phones, & Contacts

In addition to the Entity Attributes, each Entity also has a collection of Addresses, a collection of Phones or electronic addresses, and a collection of Contacts, each of which in turn have their own collections of Addresses and Phones.

These collections are built in to every Entity so that you don't have to define and use Entity Attributes for standard structures such as address, or phone, or contact information. Since these are collections, you can have as many phones or addresses as needed.

You can specify any number of Address Types (such as Billing, Shipping, etc.), any number of Phone Types (such as Work, Home, Cell 1, Cell 2, etc.), and any number of Contact Types (such as Billing, Technical, etc.) using the Raptive UI/IDE.

Activities

Each Entity in Raptive may have zero or more Activities which are analogous to methods which defines what an object does or what can be done with the object. From the database or DBA point of view, Activities are used to store recurring information concerning the Entity and represent a one-to-many relationship between the Entity data item and the recurring data entries. For example, we could create a Log Time Activity for the Employee Entity that is used to record time on a daily basis. Activities allow a one-to-many relationship between the Entity data and the Activity. For example, there can be only one “Employee—John Doe” Entity but John Doe may have many Log Time Activity Entries—one for each time the Employee records time information. Just as Entities are based on Entity Templates, Activities are based on Activity Templates. The Activity Template defines the Activity Attributes or fields for the Activity. In this example, the Log Time Activity Template defines the Attributes (fields) for the Log Time Activity just as the Employee Entity Template defined the Attributes for the Employee Entity.

To the OO programmer, a method (Activity in Raptive) does not necessarily have anything to do with a database. Methods are used to create program logic, business rules, and on occasion, read or write to some data store somewhere. In OO parlance, Activities are used to represent a “Has a” relationship to an Entity. While Activities are often used to record recurring data about the Entity such as logging time we will see a bit later how Activities can be used in the manner familiar with OO programmers as well as from the database perspective.

You have probably noticed that Activity Templates look and act a lot like Entity Templates. That is because an Activity is really just a special type of Entity under the covers. That is why we say that almost everything in Raptive is an Entity. Here is an illustration of how Entity Templates, Entities, Activity Templates, and Activities all work together:

As the figure above illustrates, each Employee Entity “Is a” class based on the Employee Entity Template. Each Log Time Activity “Is a” class based on the Log Time Activity Template. Each Employee Entity Template “Has a” Log Time Activity Template and since Employees inherit from the Entity Template, the Employee—John Doe Entity “Has a” Log Time Activity.

The Entity Template and Activity Templates are both classes that define both the “shape” and “behavior” of the objects based on the class. As such, Activity Templates are associated with Entity Templates in a “Has a” relationship at the class level that we call an Entity/Activity Pair. Since the Entity and Activity objects that are based on these classes inherit from the template classes, each Employee Entity (such as John Doe) will also have a Log Time Activity representing a “Has a” relationship between the “Employee—John Doe” Entity and the Log Time Activity.

Note that the Log Time Activity associated with “Employee—John Doe” is an Activity Template as well. When the user enters Log Time data, the Activity Template defines the Activity Attributes that are stored in the database as an Activity Entry—which explains how there can be multiple Log Time Activity Entries for “Employee—John Doe”. We will examine the precise mechanics of this as we delve deeper into how Raptive works.

Entity Relationships

In order for data to be meaningful there has to be some way to relate information with other information. If a number of departments each have a number of projects, there must be some way to define which project belongs to which department. It is also necessary to define who is working on each project, how much time is being recorded against each project, and by whom. Accounting will need to know how much is being spent on each project, in terms of hours and expenses, and how these project-level costs impact each department's budget. Thus, it is necessary to create relationships between the various Entities in Raptive just as a DBA creates relationships between tables in a traditional relational database. Raptive provides two different mechanisms for relating data: Entity Attribute relationships and Parent/Child relationships.

Attribute Relationships

The first way to relate data in Raptive is via Attribute Relationships which are conceptually the same as the familiar Primary Key/Foreign Key (PK/FK) relationships in modern relational databases. However, Raptive Attribute Relationships are far more efficient and flexible than PK/FK relationships or constraints in a traditional database for a number of reasons:
First, each PK/FK relationship creates an index containing the total number of rows in Table A times the total of rows in Table B. Indexes containing millions of rows are not uncommon. These indexes slow database inserts and must be correctly and finely tuned or they slow database reads down as well. Raptive does not create such indexes and uses a different method that is actually some 70% faster.
Secondly, since these relationships and indexes put a tremendous burden on the database engine, database administrators are taught to create no more than 3 or 4 such relationships per table. With the explosion of data in the enterprise today, this limitation has become a major problem for the DBA as business requirements dictate the need for many more relationships per data entity. Raptive on the other hand can support any number of Attribute relationships per Entity or per Activity without slowing the system down. Consider the example of a Raptive customer that required a medical invoice with 58 attributes—over 20 of which were relationships pointing to physicians, treating physicians, referring physicians, hospitals, medical plans, insurance providers, and so on. This would be real problem for a traditional database yet Raptive can handle hundreds of relationships per Entity or Activity with no problem and without slowing the system.
Finally, Attribute Relationships can be used in conjunction with Parent/Child relationships to allow you to utilize this relationship as either a one-to-one relationship (the current Entity to the target Entity) or expand this to a one-to-many relationship (the current Entity to the target Entities children) without breaking DRI and without performing cumbersome and inefficient table joins or unions.

Parent/Child Entity Relationships

Hierarchical relationships are typically used to organize large amounts of data that needs to be displayed visually and traversed by a wide range of users. This is the relationship model that was used extensively in older hierarchical legacy databases and is used in modern computers to provide easy access to great quantities of data. Think of the standard organization of a disk drive into folders and displayed on a tree as an example. This type of relationship is known as a Parent/Child Relationship.

Parent/Child relationships are also inherent in OOP. Think of the standard OO nomenclature of something like “System.Data.SqlClient” where .SqlClient is a child of Data which in turn is a child of System.

Raptive makes use of Parent/Child relationships to allow the creation of an organizational chart or tree structure of Entities that is literally infinite in nature. With this approach, Raptive can map out the entire U.S. federal government—every branch, department, state, agency, and so on, from the President of the U.S. down to a substitute janitor at the local post office, or every asset from the President's desk in the oval office down to a particular mop in the local post office.

Such parent/child relationships can be used to define a tree:

In this example, we can see that the IT Department contains two projects, “Raptor 1.5” and “Viper 1.0”. This is accomplished by setting the parent for the two project entities to be the IT Department Entity. Similarly, we can see that project Viper 1.0 has two Project Managers, “David Jones” and “Chris Smith”. That means that “David Jones” has Viper 1.0 as a parent. Similarly we can see that the “Peter Wilson” and “Jane Doe” Entities have “Chris Smith” as a parent to signify that these two programmers report to “Chris Smith”. From this we can see at a glance, and thus report on, who is working on which project and in what capacity.

Since an Entity may have zero or more parents, Entities can appear in multiple places on the tree. This allows an organization to create customized views of their data for individuals or groups of user so that the data is presented in a logical manner to that user or group. Parent/child relationships also allow you to organize data in one way when entering data and a different way for reporting the data. Parent/child relationships can also be used for reporting and accounting purposes. For example, a report can add up all of the time and expense information for any child of the “Viper 1.0” project to determine how much we have spent on the project. Similarly, we could do the same for the IT Department Entity and determine how much money the IT Department has spent on all of its projects. If we do the same for all of the departments within the company, we can determine how much money the company has spent on projects during a given time period, such as a month or a fiscal quarter.

Parent/child relationships can also facilitate things like sales force automation, business process management, or project management. For example, Entities can be created for each step in the business process. Activities can then be associated with each Entity to record the progress each step of the way and provide conditional branches for a decision tree.

Parent/Child relationships can be used for one-to-many, many-to-many, and many-to-one relationships.

Security and Permissions

Raptive includes a security sub-system that allows you to easily control permissions and access on a user-by-user/Entity-by-Entity basis. Raptive provides a very flexible and robust security model that has very little impact on the programmer accessing Raptive via Raptive.Net.

### The Raptive Database

The heart of the Raptive database is an object-oriented entity-centric database schema running on a Relational Database Management System (RDMBS). Raptive supports the following RDBMS products:
Microsoft SQL Server 2005
Oracle 9i/10 g
IBM DB2
Sybase ASE

The information presented here applies to any Raptive installation, regardless of which RDBMS product is used. All of the examples and discussions in this manual will focus on Raptive running within the Microsoft SQL Server 2005 environment,

### The Four Raptive Databases

A single installation of Microsoft SQL Server may contain any number of databases. Here is a screen snapshot of the list of databases in a typical Raptive installation:

Raptive consists of four databases as shown above:
Archive—This is an optional Raptive feature that may or may not be active in your installation. The Archive database is used for archiving data and is generally used only by the DBA.
Audit—This is an optional Raptive feature that may or may not be active in your installation. The Audit database is used for audit purposes and stores all changes that are made to user data, including the ID of the user making the changes and the timestamp.
PropertyBag—The PropertyBag database is used as a temporary storage area. Web pages often store information to the PropertyBag prior to saving the data to the main Raptor database.
Raptor—This is the main database in Raptive and is the database you will be using most of the time.

### The Raptive OO Schema

When we talk about a database schema, we are talking about the user-created objects in the database such as tables, views, triggers, indexes, and stored procedures. When a new database is first created in SQL Server, it is a blank database with no schema. It is up to the DBA to create the schema by defining database objects such as tables, indexes, views, triggers, stored procedures and so forth. Typically each database schema is different to meet the precise requirements of the database design.

Traditionally, database schemas generally fall into two main categories:
On-Line Transaction Processing (OLTP)—An OLTP schema is usually designed for fast transactional processing and is the preferred choice for situations where there is a great deal of reading and writing of data.

Generally, speed is a major or even the primary design consideration when designing an OLTP schema since OLTP databases are usually interactive in nature and no one wants to sit around waiting for the database to read or write information. In all likelihood, most of the databases you have encountered have used an OLTP schema.

On-Line Analytical Processing (OLAP)—OLAP schemas are designed for analytical processing and are generally called “data warehouses”. While execution speed is always a design consideration, the real focus for an OLAP database is the ability to “slice and dice” or “data mine” the data. The major design goal with an OLAP database is to organize the data in such a manner so that the data can be analyzed in a wide variety of ways. OLAP databases are generally designed more for reports and ad-hoc queries rather than fast user interaction. OLAP databases are generally based on either a “snowflake” or “star” schema design.

Raptive is an Object-Oriented database schema that incorporates the best aspects of both OLTP and OLAP design. Raptive is exceptionally fast and fully transactional like an OLTP database, and also allows data to be data mined like an OLAP database. What this means is that Raptive is an OO schema that is built into the database and is not an OO layer sitting on top of the database to slow things down. Raptive's schema is optimized and fine-tuned for today's modern RDBMS platforms and is generally much faster than a traditional OLTP schema.

As you may know, modern databases do not physically store data in tables consisting of rows and columns. Manufacturers such as Oracle or Microsoft use different technologies to store the data (and each manufacturer will claim that theirs is the best). Tables are an abstraction designed for humans to interact with the data in the database. Most of the details regarding tables and other aspects of SQL were standardized by the ANSI 92 SQL standards. This standardization is why a table in Oracle works just like a table in MS SQL Server or Sybase.

The idea of abstracting data into tables made up of rows and columns probably came from the earlier and much older analog concept of a ledger sheet. Humans can assimilate data in this form rather quickly and easily. The concept of presenting information in rows and columns has been used for popular relational databases as well as spreadsheets. While presenting or abstracting data as tables works well with a limited amount of data, things can get rather complicated when there are a lot of tables. In large databases, the number of tables can grow to the point that a typical human can not easily visualize of understand the tables. This tends to defeat the entire reason for abstracting the data as tables.

Raptive presents the data to you, the developer, with an object-oriented view of the data as opposed to a table-drive view. This makes your life much easier and results in a database design that is significantly faster and more flexible.

In this section, we'll examine some of the important aspects of the Raptive database schema. The Raptive database is probably quite different from most databases you have worked with in the past, but it is very easy to understand.

Raptive is far easier to work with than the traditional databases you have worked with in the past for a number of reasons:
The Raptive schema does not change as you add new objects to the database. Raptive does not generate any code nor does it create any tables, views, or stored procedures. When you use the Raptive IDE or the APIs (Application Programming Interfaces) to create a new Entity Template, such as an Employee, there is no corresponding Employee table. We'll examine how this feat is accomplished a bit later in this manual but for now it is important to understand that you will not need to learn the Raptive schema in detail in order to write a user interface that utilizes the data in Raptive.
Virtually everything in Raptive is an Entity. As you learned in the Raptive Overview White Paper, Raptive uses an object-oriented entity-centric approach to data. While the data will be presented in the familiar tabular format of rows and columns, you will be working with Entities (objects in the OO sense), not tables. When you need to perform create, read, update, or delete (CRUD) operations on a Raptive Entity, you will use the same APIs regardless of what type of Entity it is. Thus, the same stored procedure is used to access any Entity, no matter if the Entity is a Customer, an Order, an Employee or a cow.
You do not need to know or understand all of the tables in the schema. As you will see, you could use the .Net APIs without knowing anything about the database tables or schema. However, we will document a few of the main tables in this manual for clarity and for those who want to understand how Raptive works.

Row-Major and Column-Major Tables

Most OLTP databases organize data in row-major format. In a row-major database, each record is stored on one row of the table. A table for CDs consisting of 3 rows would look something like this:

| Product | | | | | Release |
|---|---|---|---|---|---|
| ID | Artist | Title | SKU | Manufacturer | Date |
| 1001 | Janis | Pearl | CK 65786 | Columbia | 1970 |
| | Joplin | | | | |
| 1002 | Kansas | Best of Kansas | ZK 39283 | CBS | 1984 |
| 1003 | Eric | Unplugged | 9 45024-2 | Reprise | 1992 |
| | Clapton | | | | |

Many of the tables within Raptive utilize this familiar row-major form. However, row-major form is not always the best way to organize data. For example, if the record will consist of a large number of columns, or when columns need to be added and deleted, row-major form presents some serious and major design problems.

To address these problems, a number of the tables in Raptive use a column-major form for storage. In a column-major form, each column is represented on a different row. Here is an example of this. Let's say that we want to create an employee record with four fields:
First Name
Middle Name
Last Name
Date of Birth

In row-major form, the table would look like this:

| EmployeeID | FirstName | MiddleName | LastName | DOB |
|---|---|---|---|---|
| 1001 | Jane | Diane | Smith | Jan. 26, 1988 |
| 1002 | Robert | James | Redford | Mar. 11, 1945 |
| 1003 | John | Q | Public | Sep. 21, 1977 |

This is the traditional OLTP form for a database table. However, suppose we want to add a new field for the employee. We would have to add a new column to the table:

| | | Middle- | | | Stock- |
|---|---|---|---|---|---|
| EmployeeID | FirstName | Name | LastName | DOB | Options |
| 1001 | Jane | Diane | Smith | Jan. 26, 1988 | 1000 |
| 1002 | Robert | James | Redford | Mar. 11, 1945 | 2000 |
| 1003 | John | Q | Public | Sep. 21, 1977 | 3000 |

When the DBA adds a new field, he has to change all of the views and stored procedures associated with the employee table to reflect the new field. Things get even messier when dealing with a large item with 30 or more fields. A medical invoice for example can have as many as 58 fields.

It is important to understand that modern RDBMS products such as Oracle or MS SQL server are highly optimized to retrieve large number of rows consisting of a few columns each very quickly. Microsoft SQL Server can process 1 million rows of 8 columns each faster than it can process 200,000 or 300,000 rows with 20, 30, or 50 columns each.

Raptive uses a column-major approach to many of the data tables. In a column-major approach, each employee's record would consist of one row for each attribute. If an Entity had 6 attributes, there would be 6 rows of data. Thus, to add a new attribute such as the StockOption example we saw above, Raptive would add a new row, rather than modify the table and add a new column. That means that Raptive can modify Entities with the click of a button without having the overhead of modifying the schema or creating new indexes.

### Raptive Organizations

Raptive can host any number of “virtual databases” that we call Organizations. Each Organization within Raptive can be thought of as a separate database or a separate application. Here at Raptive Technologies, Organizations allow us to use a single instance of Raptive running on our hosted servers to support a large number of different customers and applications. Each Organization has its own set of templates and data and is identified by a unique numeric OrgID.

The OrgID is the most important number that you need to know in Raptive.

Organizations can be used in a number of ways. For example, OrgID 1 may be used for production data, while OrgID 2 could be your development or testing environment. You could have additional Organizations for trying out new ideas or concepts or to create separate applications that do not share data with other Organizations. Consult your database administrator or team leader to determine which OrgID you should use.

The OrgID is important since all of the APIs and stored procedures that interact with user data require an OrgID parameter and all of the tables are optimized and indexed based on the OrgID. The OrgID is always the first parameter to any stored procedure and should always be the first item in any WHERE clause.

There are a few generalized lookup tables in Raptive that do not an OrgID. These tables contain generic information used by all Organizations. You can see a list of all Organizations within Raptive by executing the following SQL statement:

### SELECT*FROM Organization

### Raptive Conventions

In this section we will examine the basic naming conventions and standard tables used in Raptive. Note that all of the items that we will discuss in this section are physically located in the Raptor database.

### Data Driven Design Concepts

Raptive utilizes a data-driven design. What this means is that whenever possible, design information is stored in database tables rather than written in code. This allows the system to be very flexible and extensible. For example, instead of hard-coding the various data types that may be used in the database, we utilize a DataType table with one row for each data type:

The data in this table would look like this, sorted either alphabetically (right) or by the DisplayID (left):

This allows Raptive to look at this table and can tell that DataType 6 is a money or currency data type. The idea here is that we can add additional data types to Raptive with either no coding or with minimal coding.

There are literally dozens of such “Type” tables in Raptive. Each table has the same basic design consisting of a numeric TypeID and an alphanumeric Description. Some tables, such as the DataType table used in the previous example may have additional fields such as the DisplayID which tells Raptive how to order the data for display purposes. Other type tables may contain user data and have an OrgID field and additional fields as well. At a minimum, ALL type tables contain numeric TypeID and an alphanumeric Description fields.

All such “Type” tables have the suffix of “Type” in the name. Examples include DataType, CategoryType, AddressType, PhoneType, etc.

### Database Objects and Naming Conventions

Here is a brief overview of the naming conventions used in Raptive. This section also contains useful information on Tables, Views, and stored procedures.

Table Names

All tables in Raptive use a basic naming convention that is as descriptive as possible. We do NOT use the Microsoft Access convention of a prefix of “tbl” for table names and none of the table names contain a space character.

Tables have descriptive names such as Entity or EntityAccess. There are over 280 tables in the Raptor database. Most of these tables are used internally by Raptive and you will probably never need to access them. We document them here for the curious and those who wish to have a deeper understanding of Raptive.

Table names in Raptive utilize standard prefixes and suffixes. Here is a list of the common table prefixes:
Account—These tables are used for billing purposes when running Raptive in a hosted situation. You will probably never have a need to access these tables.
Activity—These tables contain information about Raptive Activities. These tables may only be modified using the Raptive UI/IDE.
Default—These tables are used by the Setup program to create a new Organization. You should never access or modify these tables.
Entity—These tables contain information about Raptive Entities.
Enum—These tables contain information about Raptive Dropdown Lists (enumerations).
Import—These tables are used by the Raptive Import Engine. You should never access or modify these tables.

Maint—These tables are used by the Raptive IDE. You should never access or modify these tables.
Org—These tables contain information regarding the Organization and will be commonly accessed.
OrganizationDefault—These tables contain Organization-specific information used by the Raptive UI/IDE. You must never access or modify these tables.
Report—These tables contain report information. You should never modify these tables.
User—These tables contain information regarding users.

Raptive General Lookup Tables

Raptive makes extensive use of lookup tables. All lookup tables contain the word “Type” as a suffix to the table name. There are a number of standard type tables that you will use regularly:
AccessType—Defines the Access Type for security so that you know what rights the user has on a particular Entity.
CategoryType—Defines the various Entity Category Types in Raptive.
DataType—Defines the data types used in Raptive.
   Generalized lookup tables have the same basic format. Here is an example using the Data Type table:

The TypeID field equates to the DataType. All lookup tables have at least a TypeID field and a Description field and some have additional fields. In the DataType table, the TypeID equates to the DataType. In the EntityType table, the TypeID equates to the EntityType and so on. In this example, the DisplayID shows the order in which to display the values in a list or dropdown.

Raptive Organization Lookup Tables

Raptive contains a number of useful lookup tables that require an OrgID:
EnumType—Defines the enumerations (dropdown lists) by Organization.
EnumGroupType—Defines the dropdown list items by Organization.
OrgAddressType—A list of Address Types by Organization. Use this table when you want to see a list of all of the Address Types for an Organization. Do NOT use the AddressType table which is used by ALL Organizations.
OrgContactType—A list of all Contact Types by Organization. Use this table when you want to see a list of all of the Contact Types for an Organization. Do NOT use the ContactType table which is used by ALL Organizations.
OrgPhoneType—A list of all Phone Types by Organization. Use this table when you want to see a list of all of the Phone Types for an Organization. Do NOT use the PhoneType table which is used by ALL Organizations.

Table View Names

It is our practice here at Raptive Technologies to perform all CRUD (create, read, update, and delete) operations to views rather than to tables. We never read or write directly to the table, but always use a corresponding view instead. This allows us to make changes to the tables when we release a new version of Raptive without breaking anyone's code, including our own. All of our stored procedures use a view as opposed to using the table and we STRONGLY suggest you follow this convention when writing new stored procedures or using in-line SQL (which is not a good programming practice and is not generally recommended).

Here is what we mean by this. Instead of writing code such as:

### SELECT*FROM TableName

We would use:

SELECT*FROM vwIntTableName

And read from (or write to) the view rather than the table.

Each table has ONE internal view associated with it that returns all columns in the table. These views have the prefix “vwInt” for “view internal”. Here is the idea:

| Table | Internal View |
|---|---|
| Entity | vwIntEntity |
| EntityAccess | vwIntEntityAccess |

The rule in Raptive is that ALL database access is done through views, NOT the tables.

| Correct | Incorrect |
|---|---|
| SELECT EntityType FROM | SELECT EntityType FROM Entity |
| vwIntEntity | |

Views that access a single table and return ALL columns of the table have a vwInt prefix. If the view accesses multiple tables, or performs any joins, unions, or does anything other than return all of the columns of the one table, it will have a prefix of “vw” without the “Int”. Thus, the view vwIntEntityAccess will return all columns from the table EntityAccess while the view vwEntityAccess (note that there is no “Int” in the prefix) will return information from multiple tables, with EntityAccess being the primary table. If you look at any Raptive view in SQL Server, you will note that it specifically lists the columns and does not use wildcards. For example the view vwIntEntityAccess looks like this:

SELECT OrgID, EntityID,AccessID,TargetEntityID,AccessType,GroupID
FROM dbo.EntityAccess

The view vwEntityAccess (without the Int) looks like this:

| | |
|---|---|
| SELECT | A.OrgID, A.EntityID, A.AccessID, C.UniqueID, C.Status, |
| | C.EntityType, E.Description AS EntityTypeDescription, |
| | A.TargetEntityID, A.AccessType, |
| | D.Description AS AccessTypeDescription, |
| | A.GroupID, C.CategoryType |
| FROM | dbo.vwIntEntityAccess A INNER JOIN |
| | dbo.vwIntEntity C ON A.OrgID = C.OrgID |
| | AND A.TargetEntityID = C.EntityID INNER JOIN |
| | dbo.vwIntAccessType D ON A.AccessType = D.TypeID |
| | INNER JOIN dbo.vwIntEntityType E ON |
| | C.OrgID = E.OrgID AND C.EntityType = E.TypeID |

Every table in Raptive has at least one corresponding view. The type of view can be determined by the prefix:
vwInt—Almost every table in Raptive has a corresponding view with a vwInt prefix. There are very few exceptions to this rule and if there is no vwInt, it was done on purpose to insure data integrity. For example, the table DataType has a corresponding vwIntDataType view. Views with the vwInt prefix will access/return ALL of the fields in the table. Thus, reading from a vwInt view is the equivalent of executing a SELECT*FROM TableName statement.
vw—These are special views that are usually called only by stored procedures. These views generally access more than one table in order to optimize joins or to handle reads and writes to the Archive and Audit databases.
vwPB—This is a view to a table that resides in the PropertyBag database.

If you follow our recommendations, you will probably not deal with views but will only access the stored procedures that use these views.

Note that all of the classes in the Raptive.Net Object model make use of stored procedures and follow these conventions.

Stored Procedure Names

Stored procedures are the preferred method for accessing data in the Raptive database. Any Raptive stored procedure that you will use with start with one of the following prefixes:
sp—A standard stored procedure. You will use these quite often. Many have descriptive suffixes such as _Search, Select, _Insert and _Delete.
spApp—These are stored procedures written specifically for the Raptive UI/IDE and are so specialized that most will be of little value to you.

spInt—An internal stored procedure that is typically called from another stored procedure (with an sp prefix). There are a number of spInt procedures such as for each table. These will also have descriptive suffixes such as _Search, _Insert and _Delete. Thus, spIntAddressType_Insert would be used to insert a new Address Type into the AddressType table.
spGet—This is a procedure to read information and you will use these often. Procedures with a spGet prefix only read and never write data.
spPB—These procedures work with the PropertyBag database. There are only a few instances where you will work directly with the PropertyBag. Most spPB procedures are called by other stored procedures.

All of the stored procedures in Raptive have a prefix of either “sp” or “pb” (for PropertyBag) with four special exceptions that we will go into later. Stored procedures ALWAYS access the table's view and NEVER access a table directly. Each table has up to four internal stored procedures that correspond to the internal views. These stored procedures begin with the spInt prefix, followed by the table name, and a suffix of _Select, _Insert, _Update, or _Delete. For example to access basic CRUD functionality for the Entity table, the stored procedures would use one of these four internal stored procedures:

| | |
|---|---|
| spIntEntity_Select | spIntEntity_Insert |
| spIntEntity_Update | spIntEntity_Delete |

Note that some tables may only have some of the four possible CRUD functions. For example, some tables may only have the _Insert stored procedure but no corresponding _Update or _Delete procedure. A table may or may not have the _Insert or a _Delete spInt stored procedure if such a stored procedure would break the ACID (Atomic, Consistent, Isolated, and Durable) test or if the information has to be duplicated in the Audit database.

Some tables also have an _Search procedure that allows you to search for a particular value. The idea here is very simple: If the prefix is spInt, you know that it accesses only one table (always via the vwInt view) and that the stored procedure is to be used for basic CRUD functionality.

Stored procedures with just the “sp” prefix (i.e., without the “Int”) generally access more than one table or perform certain tasks as denoted by the name.

Most “read” stored procedures use the “spGet” prefix. For example, spGetEntityAccess or spGetEntityByEntityType

There are a number of stored procedures that utilize the PropertyBag database which will be explained in detail in later sections of this document. These stored procedures have the “spPB” prefix to denote that they are utilizing the PropertyBag. As with all stored procedures they will utilize views such as vwIntEntity or vwPBEntity. As you will learn a bit later, there are many instances where data is written to the PropertyBag, using it as a temporary storage area, and then moving the data to the Raptor database when the user is finished with the data.

Generated Next IDs

We mentioned in the previous section that there were four stored procedures that do not begin with the letters “sp” or “pb”. Three of these procedure deal with generated IDs and the fourth is the ErrorHandler procedure used by many Raptive stored procedures. Raptive does not use “identity seed” fields for system IDs such as keys, but rather uses a table-driven mechanism that serves up the next available ID for a wide range of uses. The IDs for things like Entities Activities and so on are stored on separate rows in the NextID table:

### SELECT*FROM NextID

Here is a shortened list of the returned values to give you the idea:

The stored procedures that provide these generated IDS are NextIDCreate and GetNextID. There is also a GetNextID_EntityAttribute that is used for Generated Values for Attributes. Many of the Raptive procedures will call GetNextID automatically to generate a new ID. Sometimes, such as when you are creating new Entities or Activities, you will call the GetNextID procedure to get the next available ID, such as an EntityID so that you can pass it to multiple stored procedures.

### Basic Raptive Concepts

Before we delve into the details of accessing the data in Raptive, let's examine some basic Raptive concepts that you should keep in mind.

### Category Types

In Raptive, Entities are based on Entity Templates. These Entity Templates in turn are based on a superclass that we call Category Types. The Category Type tells us what type of Entity Template an Entity is and how to display or work with the Entity. There are a number of distinct categories that help differentiate the different types of entities. When a user clicks on an Entity in the tree, the Category Type tells Raptive what to do or what to display in response to the mouse click. Here are the available Category Types:

When you create a new Entity Template, Raptive will ask you to specify the Category Type for the Entity Template. Let's take a moment to examine each Category Type and see what each does.
0—Import Entity—This is a special Category Type used only by the Raptive Import Engine. You should never create or allow a user to create an Import Entity.
1—Org Entity—The basic category in Raptive is an Org Entity (an organizational Entity). Org Entities are typically used to represent abstract objects such as departments, projects, tasks, folders, or groups. When a user clicks on an Org Entity, the Raptive UI/IDE displays a panel to the right of the tree containing three tabs. The three tabs are:

| | |
|---|---|
| Data Entry | Used for data input |
| History | Used to view data input |
| Attributes | Used to view the Entity's Attributes |

In Raptive, one of the primary uses for an Org Entity is to group other entities beneath them and roll values such as expenses up to them. For example, most companies would create an “Employees” Org Entity that acts as a container or a folder, and then place each employee Entity (one for each employee) as a child of the Employees Org Entity.
The Org Entity category is a catchall type of category. Unless the Entity is a living, breathing person who logs into the system (i.e., has a login ID), or the Entity requires the features found with one of the other categories, it should be an Org Entity. Most of the entities in a typical Raptive setup will be of the Org Entity category.
2—User Entity—A User Entity is a human being such as an employee, a supervisor, or a project manager. User Entities generally “do” something such as enter or consume data, run reports, or record time or expenses information against an Org Entity or approve an activity. When a user clicks on a User Entity, the Raptive UI/IDE displays a panel to the right of the tree containing three tabs. The three tabs are the same as an Org Entity:

| | |
|---|---|
| Data Entry | Used for data input |
| History | Used to view data input |
| Attributes | Used to view the Entity's Attributes |

A User Entity always has a Login ID and a password. Each user must have a corresponding User Entity.
3—Web Entity—A Web Entity provides access to any web page on the World Wide Web. When the user clicks on a Web Entity on the tree, the specified web page appears in the right panel. Let's say that you want to add a link to Yahoo.com in a particular place in your tree. Just create an Entity Template based on the Web Entity category, create an Entity based on the Web Entity Template, and specify “www.yahoo.com” as the URL Attribute. Then, when the user clicks on the Entity, the Yahoo web page appears in the right panel in the Raptive UI/IDE. The user may then search Yahoo and return to Raptive by clicking on any other Entity in the Raptive tree that remains visible on the left side of the screen.
6—Document Management System (DMS) Entity—A DMS Entity provides powerful document management functionality. When a user clicks on a DMS Entity on the tree, a file directory appears in the right panel. The user may upload, download, view, edit, rename or delete files in this directory according to the permissions that the user was granted by the Administrator. Let's look at a typical way to use a DMS Entity in the Raptive UI/IDE. For this example, we'll say that there is an Org Entity called “Project X” on the tree and we want to associate some documents with Project X. To do this, we would create a “DOC” Entity Template based on the DMS Entity category. We would then create an Entity based on the “DOC” Entity Template called “DOC—Project X” and make it a child of the “Project X” Entity. Users may then easily share the documents associated with Project X by clicking on the “DOC—Project X” Entity directly beneath the “Project X” Entity on the tree.

The Document Management System provides complete functionality for searching documents, versioning, and tracking who uploaded, viewed, edited, or deleted the document. Access to a DMS Entity can be controlled on a user-by-user basis and file-by-file basis.
7—Report Entity—A Report Entity is used to generate a report. An Entity that is based on a Report Entity category type contains a Report Template that defines the report. The Raptive UI/IDE has a powerful report generation subsystem that allows users to create robust and complex reports. Thus, each Report Entity contains a report template that is used to generate the final report.
When a user clicks the mouse on a Report Entity in the Raptive tree, an input screen appears in the right panel to run the report. This screen allows the user to define certain aspects of the report run, such as the output format (HTML, XML, Excel, Word, or Comma Separated Values), where the report will be sent (screen, file, email address, or FTP address), and enable any filters that are associated with the report prior to running the report.
8—Report Management System (RMS) Entity—An RMS Entity is virtually identical to a DMS Document Management System Entity. The only difference between the two is that a DMS Entity allows users to upload and edit files and an RMS Entity does not. The only way a file can be added to an RMS Entity is via the report engine, and an RMS file cannot be edited. The idea here is that only the output of reports can be stored in an RMS Entity, and the consumer of the report is assured that no one has altered the report.
9—UserGroupMaint—This Category Types is an internal Category Type that is used by the Raptive Security System to manage user groups.
10—UserGroup—This Category Types is an internal Category Type that is used by the Raptive Security System to manage user groups.
12—AdminGroup—This Category Types is an internal Category Type that is used by the Raptive Security System to manage user groups.
13—Data Bin Entity—A Data Bin Entity is a special category of Entity that acts as a physical container for other entities. Think of a Data Bin as a database within a database or as a super filing cabinet. When a user clicks on a Data Bin Entity, the Raptive UI/IDE displays a panel to the right of the tree containing four tabs. The four tabs are:

| | |
|---|---|
| Data Bin | Displays the entities in the Data Bin |
| Data Entry | Used for data input |
| History | Used to view data input |
| Attributes | Used to view the Entity's Attributes |

The Data Bin tab displays a tree containing the DataBin's child Entities. Only Entities that have their Entity Parent set to the DataBin Entity will be displayed.
The Data Bin tab contains search engine functionality and works very much like an Internet search engine such as Lycos or Yahoo. This allows the user to view and search using the familiar search engine interface that supports tens of thousands of possible “hits”. Data Bins may contain any type of Raptive Entity, including other Data Bins.
When the user clicks on a Data Bin Entity, the four tabs appear in the right panel with the first tab showing the first 25 children (entities) and links to each successive page of entities contained within the Data Bin. If the user clicks on plus sign next to an Entity, they can view any children of that Entity.
If the user clicks on the Entity (not the plus or minus sign), they may click over to the Data Entry, History, or Attributes tab and have full functionality, just as if the child Entity was on the tree.
Let's create a scenario and an example to show what Data Bins can do and what they are typically used for. In this scenario, let's say that a Billing Department works with thousands or tens of thousands of invoices every month, and that each invoice is represented by an Entity called Invoice. Having each and every invoice on the tree would make the tree too large and cumbersome to use. The Data Bin is the perfect solution.
For example, we can create a Data Bin Entity and call it “Invoices”. When we import the thousands or tens of thousands of invoices every month, the “Import System” creates an invoice Entity for each invoice and set's the invoice Entity's parent as the Data Bin. Setting an Entity's parent to a Data Bin tells Raptive treat the Entity as an Entity within the Data Bin and to not display the Entity on the tree. We then have complete access to all of our invoices via the Data Bin.
14—Knowledge Management System (KMS) Entity—A KMS Entity allows you to publish information of almost any type and place KMS Entities anywhere on your organizational tree. The information published in a KMS Entity can be an HTML page such as this document, a picture, a sound file, an audio/video file, or any other file that can be displayed in a browser. This allows an organization to create a knowledge base of information, or publish information such as employee handbooks or user manuals.
When a user clicks on a KMS Entity on the tree, the information associated with that KMS Entity is displayed in the right panel. If the information is in the form of an HTML document, that document may contain links to other documents stored either in Raptive or available on the Internet. This allows an organization to publish almost any type of information in almost any manner. For example, an Employee handbook can be created using either one KMS Entity for the entire handbook, or using one KMS Entity per chapter or section.
A KMS Entity can be used to publish a photograph of an employee in order to display a photo ID of the employee, to publish a scanned invoice or purchase order so that you can store the invoice or purchase order with an Asset Entity, or even publish a PowerPoint presentation that is associated with a Project or a Customer. Raptive provides a wide range of management features for KMS entities to allow users with the appropriate privileges to upload and manipulate the file or files for a KMS Entity.
15—Knowledge Management System Link Entity—When the user creates a KMS Entity, Raptive creates a new directory on the file server to hold the file that is to be published. This directory will be named with the EntityID of the KMS Entity. A KMS Link Entity allows you to add additional files to this directory and link the files to the main KMS Entity. Here is an example: Suppose that you wanted to display an HTML document in Raptive as a KMS Entity and that document required ancillary files such as graphics or other HTML pages. The main or “home” page would be a KMS Entity and the graphic files or associated HTML pages (with hypertext links from the home page) could be added to the directory using a KMS Link Entity. This allows you to create complex documents and even entire web sites or portals with Raptive.

### Data Types

Raptive was designed to work with a wide range of database engines such as Microsoft SQL Server, Oracle, Sybase, etc. Each of these database engines implements slightly different data types such as integer, char, varchar, and so on. Also, since the object-oriented entity-centric design of Raptive is based on metadata that needs to be consistent, Raptive uses a data type abstraction to handle the various data types. These are stored in the DataType lookup table:

Raptive stored the DataType for each Entity Attribute or Activity Attribute as part of the metadata for the Attribute. This allows the UI developer to know exactly how to display or manipulate the data. Here's a brief description of each Data Type:
1—Integer—This is a standard integer value. The number of bits depends on the database platform and can be either 32 or 64 bits depending on the database engine used.
2—Text—This is a text field that equates to varchar (8000). In SQL Server this is 4,000 characters of Unicode. Each Attribute has a TextLen field so the length of the text can be specified.
3—Boolean Yes/No—This is a Boolean value of 0 or 1. This can be displayed as a checkbox or a radio button in the Raptive UI/IDE.
4—Numeric with Decimals—Raptive stores these numbers as integers with a companion field (DecimalPlaces) containing the number of decimal places.

Thus the value 123.45 will be stored as integer 12345 and the DecimalPlaces field will contain a value of 2.
5—Date—This is a standard Date/Time field. In Microsoft SQL Server, this is stored as a datetime value. The localization settings on the database will determine the output format such as mm/dd/yyyy or dd/mm/yyyy depending on the country where the database is installed.
6—Money—Raptive stores these numbers as integers with a companion field (DecimalPlaces) containing the number of decimal places. Thus the value $123.45 will be stored as integer 12345 and the DecimalPlaces field will contain a value of 2.
7—Minutes—Raptive stores these numbers as integers.
8—Time—Time in the format of hh:mm:ss for most database installations. In SQL Server this value is stored as the time portion of the datatime data type.
9—Dropdown—This DataType signifies that the Attribute is a list of values. The value will be a pointer to the EnumGroup that contains the list of values for the list. This DataType is typically displayed as a list box or combo dropdown box.
10—Hours in Tenths—Raptive stores these numbers as integers with a companion field (DecimalPlaces) containing the number of decimal places. Thus the value of 4.5 hours will be stored as integer 45 and the DecimalPlaces field will contain a value of 1.
11—Hours and Minutes—Raptive stores these numbers as minutes. Thus 68 minutes equals 1 hour and 8 minutes.
12—Entity—DataType 12 is used for a one-to-one Attribute Relationship. The stored value is the EntityID of the related Entity.
13—Current User Updateable—This is the EntityID of the current user. This is used when you want to log the current user who entered or updated an Entity or Activity and want this value to be updated every time the record is modified.
14—Current User Stamp—Use this DataType when you want to log the EntityID of the current user and not allow this to be changed when the record is modified. This is designed for Attributes such as “Created By”.
15—Generated Value—This data type can be configured a number of ways to have Raptive automatically generate a unique numeric value (based on the EntityID, a sequential number, or a GUID) with optional alphanumeric prefixes and suffixes. The Raptive UI/IDE allows you to use variables such as the current user's name or EntityID and data information in various combinations to name a few, when constructing the prefix and suffix.

Data Types Details

The chart illustrates the concept and shows what field is used for each DataType:

| DataType | ValueText | ValueNumber | ValueDateTime | Note |
|---|---|---|---|---|
| 1 - Integer | | Value | | ³ |
| 2 - Text | Value | | | |
| 3 - Boolean yes/no | | Value | | |
| 4 - Numeric with Decimals | | Value | | ⁴ |
| 5 - Date | | | Value | ⁵ |
| 6 - Money | | Value | | ¹ |
| 7 - Minutes | | Value | | |
| 8 - Time | | | Value | ³ |
| 9 - Drop-down | Value (Text) | Value (Number) | | ⁶ |
| 10 - Hours in Tenths | | Value | | ² |
| 11 - Hours and Minutes | | Value | | ⁷ |
| 12 - Entity | | Value | | ⁸ |
| 13 - Current User Updatable | | Value | | ⁶ |
| 14 - Current User Stamp | | Value | | ⁶ |
| 15 - Generated Value | Value (Text) | Value (Number) | | ⁹ |

³The TextLen field is used to set the maximum length of the text. A 0 value = no limit which is actually a physical limit of 8,000 characters (4,000 characters of Unicode.
⁴All numeric data is stored as an integer. The DecimalPlaces field is used to specify the number of decimal places. For example, currency in the U.S. uses two decimal places so a value of 2 would be used in the DecimalPlaces field. The Raptive UI and Report Engine contains code to automatically do the math based on the number of decimal places
⁵All dates and times are stored in the ValueDateTime field
⁶Drop-down lists use the ValueText field to store the value of the list item that was selected from the drop-down list as text and the ValueNumber field to store the pointer to the drop-down list (EnumGroup table). This allows Raptive to store a value from a specified drop-down list as text and still know the number of the list should the user wish to change the value. It also allows items to be freely deleted from a list without impacting existing data.
⁷Hours and minutes are stored as integers in minutes. For example 2 hours and 4 minutes would be stored as 124 minutes
⁸The EntityID of the target Entity is stored in the valueNumber filed
⁹Optional perfixes and suffixes are stored as flags in the ValueText field. Generated number are stored in the ValueNumber field. The Raptive UI/IDE will concatenate the perfix, the number, and the suffix to display the complete generated value.

### Security

Raptive contains a robust security subsystem that provides precise user-by-user Entity-by-Entity control over what each user can see and do. Many of the Raptive stored procedures utilize this security subsystem to provide access control. Using the Raptive UI/IDE as an example, a user cannot see or interact with any Entity unless they have been expressly granted permission on that Entity. There are a number of possible permissions as defined in the AccessType table:

The Maintenance menu tab in Raptive UI/IDE allows the administrator to set such permissions on a user-by-user Entity-by-Entity basis. Raptive also supports User Groups that make it easy to assign permissions on an Entity to a select number of users at once.

Security Options

You have a number of options when it comes to implementing Raptive security in your custom UI.
Forego all Raptive security and treat all of the information as public. This works well for public sites where the goal is the sharing or publishing information.
Handle security at the UI level. This allows you to control user logins and let each page decide who can see what.
User Raptive's built-in security. This allows you to control security at a number of levels and make your security as simple or robust as desired.

While some of the Raptive stored procedures implicitly implement security, most of the Raptive stored procedures are optimized for speed and do not implicitly implement security. All of the classes in Raptive.Net provide the option of using Raptive Security. Stored procedures with the words “EntityAccess” in the name implicitly implement security while all others do not implicitly implement security.

The Raptive Security model is well suited to a “gated security scheme” that tightly controls what Entities the user may interact with at the top or “gate” level. We implemented such a security scheme in the Raptive UI/IDE whereby users can only initially interact with Entities via a list or a tree. This is the “gate” through which the user must pass. If they have no access, they do not see and thus cannot interact with the Entity. If they do have access, they interact with the Entity based on their access level. For example, if the user has Modify permission on the Entity that they have selected from the list or tree, the UI will present an Edit button. If they do not, the user will not see an Edit button and will not be able to edit the Entity. If the edit button exists, we can use the optimized stored procedures that do not implement security to display the edit page and allow them to edit the Entity. As a final check, we'll use a stored procedure to check or verify that they do have the proper permission before writing to the database.

The point here is that Raptive provides a number of options when implementing security and you should have a well thought out security plan before deciding which scheme and which stored procedure to use.

### Raptive Property Bag Database

Raptive is a transactional database that was designed to work with a browser or web-based UI. As you know, the web is a stateless environment and maintaining state across multiple pages or transactions generally imposes a great deal of overhead and requires you, the UI developer to generate a lot of additional code to maintain state. Raptive helps alleviate most of these headaches via the PropertyBag database. The PropertyBag database has a schema that is virtually identical to the main Raptor database and is used for temporary storage. There are a wide range of stored procedures that work with the PropertyBag to make your life easier.

Here is the idea: When creating or editing an Entity, you may wish to divide the user input into multiple screens or pages. Similarly, there are a number of steps involved in creating the Entity, assigning security permissions, and relating the new Entity with existing Entities. The Raptive PropertyBag allows you to save portions of the Entity to the PropertyBag as the user moves between pages. When the entire process is satisfactorily completed, you can then just use a single stored procedure to copy the data from the PropertyBag to the Raptor database and clear the PropertyBag. Here is an example of editing an existing Entity's Attributes in pseudo-code:

Read the EntityAttribute information using spEntityAttribute_Select
Copy the information to the PropertyBag using
spPBEntityAttribute_Insert
Display the information and allow the user to edit the form
Upon Submit, copy the information from the PropertyBag to Raptor using
spCopyEntityUtilFromPBToRaptor

We'll examine all of this in detail a bit later. The point is that you can use any of the spPB procedures to do all CRUD operations in the PropertyBag first, and then execute the [spCopyEntityUtilFromPBToRaptor] procedure to copy all of the information about the Entity including Attributes, Activities, Parents, and Access from the PropertyBag to Raptor with one call.

### Entity Relationships

Raptive uses two primary methods to relate Entities:
Entity Attribute Relationship—Any Entity or Activity Attribute can be an Entity Relationship attribute. This type of relationship is analogous to the Primary Key/Foreign Key (PK/FK) relationship in a relational database with some very important improvements:
   You may assign as many relationships to an Entity as you like without the overhead of creating huge indexes and slowing the database down.
   Using the Raptive UI/IDE as a good example, user's can click on a web-link to jump directly to the related information. This means that you can have an Entity comprised of dozens of links to other Entities in a manner that most web users are very familiar with.
   Any information in the related Entity can be easily incorporated for reporting purposes. This makes reports easier to create and easier to use.
Parent/Child Relationship—This type of relationship is well suited to presenting the information to the user in the form of a tree. An Entity can have any number of parents and any number of children. Parent/Child relationships are an easy way to create views of the data for different classes of users, and greatly simplify creating reports on the data. When creating or managing data in Raptive, you should always bear in mind where on the tree the data should reside, even if you do not use a tree-view for your UI. Raptive contains a number of stored procedures that make managing Parent/Child relationships easy.

The system architect should define the tree structure and relationship method for you to use.

Raptive.Net

Raptive provides a robust object model for accessing the Raptive database from Visual Studio .Net projects and websites. The Raptive.Net object model is shipped as a dynamic link library and can be found in the file: \Raptive\bin\raptive.dll.

### Setting a Reference to Raptive.DLL

Installing Raptive.Net is simple and straightforward. Just add a reference to your project and work with the classes as you would any .Net classes.

See the section on The Raptive.Net Object Model for detailed information on the entire object model.

### Configuring a Connection to the Raptive Database

TBD—need to document setting the configuration settings . . . .

### Raptive.Net Conventions

Collection Classes

Raptive.Net includes a number of collection classes that are based on and inherit the .Net System.Collections.ArrayList class. This allows you to use these collection classes just like you would use a standard ArrayList class. These collection classes in Raptive.Net follow the same naming convention as used in the .Net object model and each collection class has a suffix containing the word “List”.

All of these collection classes are strongly-typed collections. That means that they may only contain objects of a specified type of class. For example, the AddressList collection class may only contain objects based on the Address data class. Using only strongly-typed collections is a good programming practice that reduces the number of possible bugs and helps insure data relational integrity (DRI) is maintained in the Raptive database. Visual Studio will warn you whenever you attempt to utilize the wrong class with a strongly-typed collection.

Whenever a property or method in Raptive.Net returns a collection, it will be a strongly-typed “List” that inherits the ArrayList class and you will see IntelliSense information telling you which collection class is returned and what data class the collection contains. For example:

In this example we see that the Entity.EntityAttributes property returns an object based on the EntityAttributeList collection class and that the collection is strongly-typed to contain only objects based on the EntityAttribute data class. This provides all of the class information necessary to utilize the property or method.

As we mentioned earlier, each of these collection classes inherits from the ArrayList class. That means that you can use any of the properties and methods exposed by the ArrayList class. Raptive.Net adds one new property and one new method to all of the Raptive.Net “List” collection classes:

Collection.ListItem Property

The ListItem property returns an object from the collection by its positional value in the collection. This property allows you to drill down to items inside the collection without creating a class to hold the item in the collection. For example:

### Textbox 1.Text=EntityAttributes.ListItem(1).AttributeDesc

This will return the AttributeDesc property of the first item in the EntityAttributes collection.

Collection.Search Method

The Search method allows you to search the collection for a particular (string) value and will return the matching object. The property that is used for the match varies according to the class that will be returned. IntelliSense will show what property is the target of the search:

In this example we see that the EntityAttributes.Search property will search the EntityAttributes collection on the Attribute.AttributeDesc property. If a match is found, the method will return an Attribute object that matches the specified criteria of “First Name” otherwise, it will return an empty Attribute object.

### Commonly-Used Raptive.Net Collection/Data Classes

There are a few strongly-typed collection classes that you will use quite often. Let's take a moment to look at these commonly-used collection classes and their strongly-typed data classes.

### Entity.EntityIDList Collection Class & Entity.EntityID Data Class

The EntityIDList collection class contains objects based on the EntityID class. The EntityIDList collection class is often used when a property or method returns a list of Entity IDs. The EntityID class exposes the following properties:
OrgID
EntityID
UniqueID
Description

The OrgID and EntityID properties are the two key values needed to locate a particular Entity in Raptive. The UniqueID and Description properties are generally used for display purposes. As we will see in the following section, the Description property is the name of the Entity Template and the UniqueID property is the name of the Entity. The Raptive standard for displaying a fully-qualified Entity name is to concatenate the Description and UniqueID properties as shown below:

### Name=EntityID.Description.ToString & “-” & EntityID.UniqueID.ToString

See Also Entity.EntityIDList Class, Entity.EntityID Class

TypeTableList Collection Class and TypeTableListItem Data Class

The TypeTableList collection class contains objects based on the TypeTableListItem class. The class is often used when a property or method returns information from a Raptive Type Table such as the DataType or CategoryType tables we examined earlier. The EntityID class exposes the following properties:
ID
Description

These are the two primary key fields found in all Raptive Type Tables.
See Also Entity.TypeTableList Class, Entity.TypeTableListItem Class

Load Methods

The primary function of Raptive.Net is to access the Raptive database. As such, a number of the classes in Raptive.Net have a Load method that reads the database and populates the properties of the class or creates and populates a collection of data classes which contain the data. All of the Load methods in Raptive.Net return a Boolean True/False value to indicate if the database query returned results. Here is an example:

```
Dim bLoaded As Boolean
Dim EntityTemplate As New Raptive.Entity.EntityTemplate
bLoaded = EntityTemplate.Load(OrgID, EntityType,
                                Enums.EntityLoadType.Summary)
If bLoaded Then
    ‘ the database query returned some results so do something
End If
```

This pattern allows you to easily determine if the database read returned information.

Returning Data in DataSet or SqlDataReader Objects

The classes in Raptive.Net that query the Raptive database will generally return the results as an object with the data exposed as properties of the class. When the query may return multiple “rows” such as getting a list of Entities, the result will be returned as a collection of data objects. However, there may be times when it is appropriate to return the results using the System.Data.DataSet class or the System.Data.SqlClient.SqlDataReader class.

Most Raptive.Net classes provide optional methods to return the results in a either a populated DataSet or a SqlDataReader object in addition to returning the data as a Raptive.Net data class.

DataSet Methods

Methods that have a suffix of “DataSet” in the name will return the results as a DataSet object. This is handy for data binding to controls or when working with large result sets.

SqlDataReader Methods

Methods that have a suffix of “DataReader” will return the results as a SqlDataReader object. This is handy when working with large results sets or to “fire hose” data.

### Accessing the Raptive Database

This section will examine how Raptive actually works and how to access the Raptive database.

### Raptive Entity Templates

Every Entity in Raptive is based on an Entity Template. This template contains all of the metadata necessary to create an Entity based on the template. Each Entity Template is identified by a unique integer value known as an EntityType. The EntityType value is the key that Raptive uses. Every Entity will have a pointer to this EntityType. Each EntityType also has an alphanumeric Description that is also unique. It takes two tables to define an Entity Template, the EntityType table and the EntityAttributeType table:

Entity Templates should only be created, modified, or deleted using the Raptive UI/IDE. You are NOT permitted to create, modify, or delete any Entity Template via code. Doing so will invalidate your Raptive Maintenance Contract!

The Raptive UI/IDE allows you to create, modify, manage, and delete Entity Templates with the proper security measures and safeguards to insure the integrity of your Raptive database.

### EntityType Table

The EntityType table is a row-major table that lists all of the Entity Templates in Raptive. Let's look at how this table works as it is a great example of how Raptive is designed. You should also note that many other tables in Raptive follow this same design convention.

Here are the fields in the EntityType table:
OrgID—As we learned earlier, every Organization has a unique OrgID. This OrgID identifies who the data belongs to and is the first and most important field in every table that contains customer data. Thus, you could use simple SQL in the SQL Server Management Studio to view all of the Entity Templates used by OrgID 577 with the SQL statement:
SELECT*FROM EntityType WHERE OrgID=577
TypeID—Every “type” table contains a unique numeric TypeID field. In the EntityType table, the TypeID field equates to an Entity Template's EntityType. In other type tables, such as the DataType table, the TypeID equates to the DataType. It is important to remember that only “type” tables will have a field called TypeID and that all of the other tables which utilize the TypeID value will have logical field names such as EntityType or DataType which equates to the TypeID of the related table.
The TypeID in the EntityType table in and of itself does not guarantee uniqueness. As you will see a bit later, we have a number of default Entity Templates that share the same TypeID. That is why the table uses the compound key of OrgID and TypeID. For example if you executed the statement:
SELECT*FROM EntityType WHERE TypeID=104
You may see data from many OrgIDs because TypeID 104 is our default “Employee” Entity Template. The proper way to execute this statement so that it returns meaningful results is to always add the OrgID as the first condition in the WHERE clause:
SELECT*FROM EntityType WHERE OrgID=577 AND TypeID=104
When using SQL to access Raptive, ALWAYS use the OrgID as the FIRST condition in the WHERE clause when querying any table that has an OrgID field. This is an INVIOLATE rule for all coded queries such as stored procedures or triggers and any ad-hoc queries performed elsewhere, such as in Query Analyzer, TOAD, or the SQL Management Server. You should get into the habit of adding the OrgID as the first condition from day one.
Note also that all indexes are organized with the OrgID as the first field. Placing the OrgID just any old place in the WHERE clause means that you will probably not hit the index and the results will be returned using a full-table scan that is much slower.
Description—This is a text field that describes or “names” the Entity Template. This value is created by the user who creates the Entity Template so it can have just about any name imaginable.
UniqueIDDesc—UniqueID Description. This is a field that is set and displayed by the user. Generally, it will contain the value “Name” but may be changed by the user so that for a Cell Phone template it may contain “Number” or for a Task template it may contain “Description”. It is for user informational display purposes only.
CategoryType—Each EntityType is based on a CategoryType that is stored in the CategoryType table. Think of this as a form of superclassing in OO. The CategeoryType table contains a list of all of the current CategeoryTypes that Raptive supports. See the section on CategoryTypes later in this document.
Status—A status flag. Raptive will only display EntityTypes with the Status set to non-zero (i.e., 1). Setting the Status to 0 hides the Entity Template from the user and is used when the Administrator wants to hide or disable a template without removing it from the database.
UserID—The EntityID of the user who created the Entity Template. As you will soon see, virtually all tables containing data have a UserID field and an UpdateDate field to show who entered or updated data and when.
UpdateDate—The date/time stamp of when the data was entered or updated.

Typically you will use the EntityType table as a lookup table to get a list of all of the Entity Templates in the Organization or to find a Template of a particular EntityType or CategoryType.

The Raptive UI/IDE allows you to create, modify, manage, and delete Entity Templates with the proper security measures and safeguards to insure the integrity of your Raptive database.

Entity Templates should only be created, modified, or deleted using the Raptive UIIDE. You are NOT permitted to create, modify, or delete any Entity Template via code. Doing so will invalidate your Raptive Maintenance Contract!

### EntityAttributeType Table

The EntityAttributeType is a column-major table that lists all of the Attributes (fields) for the specified EntityType. This table will contain one row for each Attribute.

Each EntityType (TypeID in the EntityType table) has 0 or more Attributes in the EntityAttributeType table keyed to the OrgID, EntityType, and the TypeID of the Attribute. Thus, for an Entity Template (EntityType) with four Attributes there would be one row in the EntityType table and four rows in the EntityAttributeType table. Let's take a moment to examine each of the fields in the EntityAttributeType table:
OrgID—All tables that contain user data have an OrgID to identify that data as belonging to the Organization.
EntityType—This is the second part of the compound key that relates the two tables. The EntityType in EntityAttributeType is an FK to TypeID field in the EntityType table.
TypeID—Each Attribute will have its own TypeID in keeping with the basic design of type tables in Raptive. As we will see a bit later on, this allows us to set up default attributes such as FirstName (TypeID=1003) and use the same attribute in multiple Entity Templates in the same organization or different organizations.
Description—This is a text field that describes or “names” the Attribute. This value is created by the user who creates the Entity Template so it can have just about any name imaginable such as FirstName, LastName, etc. It is generally used as the user “prompt” for the Attribute.
DataType—This is a numeric field that defines the data type for the Attribute. It points to the DataType table we examined earlier. Raptive was designed to work on multiple database platforms such as SQL Server and Oracle. These databases store values differently and have slightly different data types so this design allows us to specify the metadata for each data type independently of the RDBMS platform. In addition, it allows us to create new data types that are either object-oriented in nature or are unique to Raptive.
DecimalPlaces—Numeric values in Raptive are always stored as integers in the field ValueNumber (see below). The DecimalPlaces field allows the user to specify the number of decimal places.
TextLen—This field allows the user to specify a maximum length for alphanumeric (text) Attributes. A value of 0 in this field denotes unlimited length.
Required—A flag (either 0 or 1) that denotes if the Attribute is required. If the flag is set to 1 (required) the user will not be allowed to save the data to the database if the value of this Attribute is null.
DefaultAttribute—Unused in this version of Raptive. By default this value is automatically set to 0. Do not use this field for any purpose.
Status—A flag (either 0 or 1) that denotes is the Attribute is “active” and is to be displayed. This allows Attributes to be turned on (1) or off (0). Raptive will only display Attributes with Status=1 to the user.
ValueText—This field is only used if the DataType is 15 (Generated Value) and will contain any optional prefix or suffix for the generate value.
ValueNumber—This field serves a number of purposes depending on the data type.
   DataType 9 (Dropdown)—The ValueNumber field will contain a pointer to the appropriate dropdown list in the EnumGroup table.
   DataType 12 (Entity)—If the Attribute is constrained to a particular EntityType, the EntityType will be stored in ValueNumber. If the Attribute is not constrained, ValueNumber will be null.
   DataType 15 (Generated Value)—ValueNumber will contain the starting number (similar to an identity seed value) for the generated number.
DisplayID—The display order that the Raptive UI will use to order the Attributes.
UserID—The EntityID of the user who created the Entity Template. Virtually all tables containing user data have a UserID field and an UpdateDate field to show who entered or updated data and when.
UpdateDate—The date/time stamp of when the data was entered or updated.

The Raptive UI/IDE allows you to create, modify, manage, and delete Entity Templates with the proper security measures and safeguards to insure the integrity of your Raptive database.

Entity Templates should only be created, modified, or deleted using the Raptive UIIDE. You are NOT permitted to create, modify, or delete any Entity Template via code. Doing so will invalidate your Raptive Maintenance Contract!

### How Entity Template Information is Stored

Let's look at the data for a typical Entity Template:

This snapshot shows all of the information for the Employee Entity Template. We can see in the EntityType table that it is a User Category Entity (CategoryType 2) that it is an active template (Status=1) and that it was created by user 9144 and was last updated on Jul. 31, 2007.

The EntityAttributeType table shows that the First Name, Middle Name, and Last Name Attributes are DataType 2 (Text) with a text length of 20 characters and that the remaining Attributes are DataType 9 (Dropdown). The ValueNumber field for each Attribute shows the ID of the dropdown list for the Attribute. For example, the Employee Type Attribute has a value of 5217 which indicates that it is using dropdown list 5217 which contains items such as Full Time, Part Time, and Consultant. The DisplayID field shows the order in which to display the Attributes. To display the Attributes in the specified order add an ORDER BY to the statement:

SELECT * FROM EntityAttributeType WHERE OrgID = 577
and EntityType = 104 ORDER BY DisplayID

### What Entity Template Metadata is Used for

Most custom UI implementations will have little direct interaction with Entity Templates. Typically, about the only thing you need from these tables is a list of the available Entity Templates in the Organization. You would use such a list to populate a list box or dropdown list containing all of the Entity Templates so that the user could pick a particular template such as an Employee or Customer.

Another typical use is to make your input forms dynamic to reflect any changes made by to the Entity Template. Rather than hard-code controls on a web page, a better idea is to dynamically create each form based on the Entity Template. That way, when a change is made to a template, the presentation layer automatically reflects the change.

### Reading Entity Template Metadata via Raptive.Net

The classes to work with Entities and Entity Templates are located in the Raptive.Entity namespace. Once you have set a reference to Raptive.dll in your project you may access the classes as you would anything else in .Net. For example:

### Dim EntityUtil As New Raptive.Entity.EntityTemplate

Alternately you can use the Imports statements as shown below:

Imports Raptive
Imports Raptive.Definitions
Imports Raptive.Entity
Imports Raptive.Activity
Imports Raptive.Utils

Adding these lines greatly reduces the typing necessary by eliminating the need to fully qualify names. This allows you to use the shorter syntax of:
Dim EntityUtil As New EntityTemplate

To conserve space, the examples in this section will assume that the Imports statements shown above have been placed at the top of the code and the examples will not use the fully qualified names for the classes and methods in the Raptive namespace. If classes from other namespaces are used, we will fully qualify them.

Let's look at some common classes for accessing Entity Template information.

Entity.EntityTemplate Class

The EntityTemplate class is a data class with following properties:
OrgID
TypeID
Description
Category Type
Status
UserID
UpdateDate
EntityTemplateAttributes
ActivityTemplates

The first seven properties of the EntityTemplate class directly correspond to the fields in the EntityType table. The EntityTemplate class also has an EntityTemplateAttributes property which returns all of the Attributes for the Entity Template. The EntityTemplates property returns all of the Activity Templates that are associated with the Entity Template.

See Also EntityTemplate Class, GetEntitTemplate Method

Entity.EntityTemplate.Load Method

As we mentioned earlier, the EntityTemplate class is the primary way to access the Entity Template metadata. This class can be loaded with all of the information for a particular Entity Template. Once the class is instantiated and populated with data, you can easily access the data just as you would with any class:

Public Function Load(ByVal OrgID As Long, ByVal TypeID As Long, _{—}
ByVal LoadType As EntityLoadType) As Boolean

The TypeID parameter is the EntityType that you are looking for. The LoadType parameter is an Enum that includes options for either Summary, Detail, or LoadAll. Specifying Summary (or 0) will read just the EntityType table and will not return the Attributes. Specifying either Detail or LoadAll will return the Attributes in a collection. Here is an example of using the Load method in code:

Dim bLoaded As Boolean
Dim EntityTemplate As New Raptive.Entity.EntityTemplate
bLoaded = EntityTemplate.Load(OrgID, EntityType,
Enums.EntityLoadType.Summary)

The EntityTemplate class has properties that match the fields in the EntityType. Here is an example of displaying information from the EntityType table using the properties:

TextBox2.Text = EntityTemplate.Description
TextBox3.Text = EntityTemplate.DataType.ToString

Alternately, you could use the data binding features in .Net to bind TextBox2 to the EntityTemplate object:

TextBox2.DataBindings.Add(“Text”, EntityTemplate, “Description”)
TextBox3.DataBindings.Add(“Text”, EntityTemplate, “DataType”)

Entity.EntityTemplateAttribute Class

The EntityTemplate class has an EntityAttributes property which returns all of the Attribute for the Entity Template as an EntityTemplateAttributeList collection which is a strongly-typed collection class that may only contain objects based on the EntityTemplateAttribute class. The EntityTemplateAttribute class is a data class that is used to hold one Entity Template Attribute read from the EntityAttributeType table. The properties correspond to the fields in the EntityAttributeType table:
OrgID As Long
EntityType As Long
TypeID As Long
Description As String
DataType As Long
DecimalPlaces As Integer
TextLen As Integer
Required As Integer
Status As Integer
ValueText As String
ValueNumber As Long
DisplayID As Integer
UswerID As Long
UpdateDate As Date

The class is used by the EntityTemplate class's EntityTemplateAttributes property. Here is an example of accessing the Activities:

Dim ActivityTemplate As New Raptive.Activity.ActivityTemplate
For Each ActivityTemplate In EntityTemplate.ActivityTemplates
ListBox1.Items.Add(ActivityTemplate.Description.ToString)
Next

Entity.EntityUtil Class

The EntityUtil class contains a number of methods that are often useful when working with Entities and Entity Templates. There may be times when you want to load all of the Entity Templates in the Organization for display or comparison purposes. The EntityUtil class provides a number of methods to obtain such a list:

EntityUtil.GetEntityTemplateList Method

The GetEntityTemplateList method will return a list of all of the Entity Templates in the Organization. This is an overloaded method with two signatures:

```
Public Function GetEntityTemplateList(ByVal OrgID As Long) _{—}
                As EntityTemplateList
Public Function GetEntityTemplateList(ByVal OrgID As Long, _{—}
                ByVal CategoryType As Long) _{—}
                As EntityTemplateList
```

You may add a CategoryType parameter to return all of the Entity Templates of a given Category Type. The method returns just the information from the EntityType table only and does not return the Entity Template Attributes. The returned EntityTemplateList collection which is a strongly-typed collection class that may only contain objects based on the EntityTemplate class.

Here is an example of using the GetEntityTemplateList method:

Dim aList As New EntityTemplateList
Dim EntityUtil As New EntityUtil
aList = EntityUtil.GetEntityTemplateList(OrgID)
Dim EntityType As New EntityTemplate
For Each EntityType In aList
ListBox1.Items.Add(EntityType.Description)
Next

EntityUtil.GetEntityTemplateListDataSet Method

The GetEntityTemplateListDataSet method returns a DataSet object containing all of the Entity Templates in the Organization. This is an overloaded method with two signatures:

```
Public Function GetEntityTemplateListDataSet(ByVal OrgID As Long) _{—}
                    As DataSet
Public Function GetEntityTemplateListDataSet(ByVal OrgID As Long, _{—}
                    ByVal CategoryType As Long) _{—}
                    As DataSet
```

Here is an example that gets a list of all Entity Templates in the Organization and populates a list box:

```
Dim EntityUtil As New EntityUtil
Dim ds As System.Data.DataSet
ds = EntityUtil.GetEntityTemplateListDataSet(OrgID)
Dim dbRow As System.Data.DataRow
For Each dbRow In ds.Tables(0).Rows
    ListBox1.Items.Add(dbRow(“EntityTypeID”) & “-”
    & dbRow(“Description”))
Next
```

EntityUtil.GetEntityTemplateListDataReader Method

The GetEntityTemplateListDataReader method returns a SqlDataReader object containing all of the Entity Templates in the Organization. This is an overloaded method with two signatures:

```
Public Function GetEntityTemplateListDataReader(ByVal OrgID
As Long) _{—}
                    As SqlDataReader
Public Function GetEntityTemplateListDataReader(ByVal OrgID
As Long, _{—}
                    ByVal CategoryType As Long) _{—}
                    As SqlDataReader
Dim EntityUtil As New EntityUtil
Dim dr As System.Data.SqlClient.SqlDataReader
dr = EntityUtil.GetEntityTemplateListDataReader(OrgID)
Do While (dr.Read( ))
    ListBox1.Items.Add(dr.Item(“EntityTypeID”) & “-” & _{—}
            dr.Item(“Description”))
Loop
```

EntityUtil.GetEntityTemplateListBrief Method

The GetEntityTemplateListBrief method returns a lightweight TypeTableItem class which contains just the Description and TypeID fields from the EntityType table. This is a handy method to use to populate and display a list box or combo item so that the user can select an Entity Template. When the user selects the item from the list, you can read the TypeID from the control and then use to EntityTemplate.Load method to load the Entity Template.

Public Function GetEntityTemplateListBrief(ByVal OrgID As Long) _{—}
As TypeTableList

Here is some sample code that illustrates the use of the method:

```
Dim aList As New TypeTableList
Dim TypeTableItem As New TypeTableListItem
Dim EntityUtil As New EntityUtil
aList = EntityUtil.GetEntityTemplateListBrief(OrgID)
For Each TypeTableItem In aList
      ListBox2.Items.Add(TypeTableItem.ID & “-” & _{—}
            TypeTableItem.Description)
Next
```

This loads the ListBox with just the text for the two properties as a string. Another way to handle this is to use the DisplayMember and ValueMember properties of the ListBox2 control and add the TypeTableItem collection object to the ListBox:

Dim EntityUtil As New EntityUtil
aList = EntityUtil.GetEntityTemplateListBrief(OrgID)
ListBox2.DisplayMember = “Description”
ListBox2.ValueMember = “TypeID”
For Each TypeTableItem In aList
ListBox2.Items.Add(TypeTableItem)
Next

Note that the TypeTableList class is located in the Raptive.Utils namespace.
See Also: EntityUtil Class, GetEntityTemplateList Method, GetEntityTemplateListBrief Method,
   GetEntityTemplateDataSet Method, GetEntityTemplateDataReader Method,
EntityTemplateList Class, EntitvTemIpate Class, TypeTabeList Class

### Reading Entity Template Metadata via SQL

Here are the commonly used stored procedures associated with the EntityType and EntityAttributeType tables. Note that the OrgID 577 is used in these examples—your OrgID will be different!

spGetOrgEntityTypes

This procedure returns the TypeID and Description for all of the Entity Templates in an Organization and is useful for populating a dropdown list of Entity Templates.

ALTER PROCEDURE [dbo].[spGetOrgEntityTypes](
@OrgID int)

Here is an example:

Typically, you would store the Description as the Text or DisplayMember property of the dropdown list or combo box and store the TypeID in the ListItem.Value or ValueMember property so that you have the EntityType available when the user makes a selection.

spEntityType_Select

This procedure returns just the TypeID and Description fields and is useful for populating a dropdown list of Entity Templates. This procedure allows you to add an optional Category Type parameter to narrow the list to Entity Templates based on a particular Category Type.

ALTER Procedure [dbo].[spEntityType_Select] (
@OrgID int,
@CategoryType int = NULL)

Here is an example of using this to find all of the Entity Types in the Organization:

You can optionally add a CategoryType parameter to return all Entity Templates by Category Type. This is handy when you want to return a list of all of the User Category Types:

This procedure returns exactly the same information as the spEntityType_Select procedure described previously. The only difference is that there is not optional @CategoryType parameter. Either the spEntityType_Select or spGetOrgEntityTypes procedures can be used when you want to present the user with a list of valid Entity Templates. These are the two Entity Template procedures that you will most likely use in a custom UI. The remaining stored procedures for reading Entity Templates are documented here for completeness and for as a reference.

spIntEntityType_Select

This procedure will return information on a selected Entity Type or all Entity Types

```
  ALTER Procedure [dbo].[spIntEntityType_Select](
  @OrgID int,
  @TypeID int = Null)
spIntEntityType_Select 577 -- return info for all Entity Types
  spIntEntityType_Select 577, 104 -- return info on specified Entity
  Type
```

If no EntityType is specified, will spIntEntityType_Select will return all of the Entity Types for the Organization:

Here is an example of using this procedure and specifying an Entity Type of 104:

spEntityType_Search

This is used to search for Entity Templates. The following parameters can be used:

```
ALTER PROCEDURE [dbo].[spEntityType_Search] (
    @OrgID int,
    @TypeID int,
  @CategoryType int)
```

Here are some sample calls with parameters:

spEntityType_Search 577, null, null -- return all Entity Templates
spEntityType_Search 577, 104, null -- return just EntityType 104

Here are some examples of the output:

spGetEntityTypesByOrgIDCategories

This returns a list of Entity Types, optionally by Category Type.

ALTER PROCEDURE [dbo].[spGetEntityTypesByOrgIDCategories](
@OrgID Int,
@Categories varchar(2000) = null)

Here are three valid syntaxes that may be used:

spGetEntityTypesByOrgIDCategories 577
spGetEntityTypesByOrgIDCategories 577, null
spGetEntityTypesByOrgIDCategories 577, ‘1,2,3’

See the Category Type table for a list of valid Category Types.

spIntEntityAttributeType_Select

This procedure returns all of the information about the Entity Attributes for a specified Entity Template in column-major form. The parameters are the OrgID and the EntityTypeID:

```
ALTER PROCEDURE [dbo].[spIntEntityAttributeType_Select](
  @OrgID int,
  @EntityTypeID int)
```

Here is an example of the output:

Here we can see that the first Attribute is called Prefix and that it is a dropdown list (DataType 9) and that the ValueNumber is 5245 which tells us the Enum Group (the ID) for the dropdown list. We can use the following stored procedures to load the dropdown list into a combo box:

Here is an example of what the spEnumsByEnumGroup_Select procedure returns:

spEnumsByEnumGroup_Select 577, 5245

This allows you to see what the currently available items are for the Prefix dropdown list.

spEntityAttributeType_Search

This procedure returns most of the information about the Entity Attributes for a specified Entity Template. The difference here is that it returns the renormalized DataType Description (the name of the DataType) and does not return the UserID and UpdateDate fields.

```
ALTER PROCEDURE [dbo].[spEntityAttributeType_Search](
    @OrgID int,
    @EntityTypeID int)
```

The parameters are the OrgID and the EntityTypeID:

spEntityAttributeType_Search 577, 104

Here is an example of the output:

spEntityAttributeType_Select

This procedure is almost identical to the spEntityAttributeType_Search stored procedure above, except that it returns the DataTypeDescription (the name of the Data Type) as well as the ID number of the DataType.

```
ALTER PROCEDURE [dbo].[spEntityAttributeType_Select](
    @OrgID int,
    @EntityTypeID int)
```

Here is an example of the output:

spEntityAttributeInfo

This procedure will return a set of handy information about the Entity Attributes:

ALTER PROCEDURE [dbo].[spEntityAttributeInfo](
@OrgID int,
@EntityTypeID int)

Here is an example of the output:

This is handy information when creating an input or edit screen.

The IsDefault field is used only by the Raptive UI/IDE you may ignore this value.

The EA_Count field is a computed field that shows that there are currently 42 active Entities in the Organization utilizing each EntityAttribute for this Entity Template.

### Raptive Entities

All user-data in the Raptive database is stored as Entities and Activities Let's begin with Raptive Entities.

### Entity Table

The Entity table is a row-major table that is very similar to, and corresponds directly with the EntityType table. There is one row per Entity in the Entity table. The figure below shows how the Entity and EntityAttribute tables closely mirror the EntityType and EntityAttributeType tables that we examined in the last section:

Once you get the hang of it, the design is really quite simple. By way of example, let's say that we define an Entity Template called “Employee” (EntityType 104 for this example although it could be any number) for OrgID 577. There would be one row in the EntityType table with an OrgID of 577 with a TypeID of 104 with a Description of “Employee”. Continuing with our example, let's say that there are five Entity Attributes associated with the Employee Entity Template for OrgID 577. This would result in five rows in the EntityAttributeType table with the keys of OrgID 577 and EntityType 104. Now let's say that we create one Employee Entity named “Wayne Hammerly”. There would be one row in the Entity table with the OrgID of 577, the EntityType of 104, and a unique EntityID (for this example we will say that the EntityID is 9163) and the UniqueID of “Wayne Hammerly”. Since there are five corresponding rows in the EntityAttributeType table, there would be five rows in the EntityAttribute table containing the actual data for the Entity Employee—Wayne Hammerly—one for each Entity Attribute.

Here are the fields in the Entity table:
OrgID—The obligatory OrgID
EntityID—An integer that will act as the unique numeric identifier of the Entity.
UniqueID—A unique text ID for the Entity. This ID is used only for display purposes and for the occasional search. The UniqueID is generally used as the “name” of the Entity from a user's perspective. Using our Employee Entity Template as an example, we could use a UniqueID of “Wayne Hammerly” or “Hammerly, Wayne” to identify Wayne's Employee Entity. Raptive insures that UniqueID are unique for any given Entity Template. Thus, there may be only one Entity of the Employee Entity Type with a UniqueID of “Wayne Hammerly”. However, there may be Entities of other Entity Types with the same UniqueID. For example, there can be an Employee—Wayne Hammerly, a Cell Phone—Wayne Hammerly, and a Customer—Wayne Hammerly. Each has the same UniqueID but is of a different EntityType. The database uses the OrgID and EntityID, but not the UniqueID to insure overall Entity uniqueness.
EntityType—The integer ID of the Entity Template. This number corresponds to the TypeID in the EntityType table. In our example, the Employee Entity Template has a TypeID of 104 and thus, any Entity we create based on the Employee Entity Template will have an EntityType of 104.
Status—A flag (either 0 or 1) that denotes is the Entity is “active” and is to be displayed. This allows Entities to be turned on (1) or off (0). Raptive's stored procedures and the Raptive UI/IDE will only display Entities with Status=1 to the user. Note that when the user deletes an Entity in Raptive, the data is not deleted but rather, the Entity's Status flag is set to 0.
CategoryType—Each EntityType is based on a Category Type. Think of this as a form of super classing in OO. This is a FK to the CategeoryType table which contains a list of all of the current Categeory Types that Raptive supports. See the section on CategoryTypes later in this document.
RollupEntityID—Unused in this version. Generally set to −1.
Description—The name of the Entity Template. In our example, EntityType 104 is an “Employee” and so this field will contain the text “Employee”. This is a minor de-normalization of the database and allows the system to get the name of the Entity Template without joining to the EntityType table.
StartDate—A start date when the Entity becomes active. This field is not used in the current version of the Raptive UI/IDE. However, you could use this in your custom UI if desired.
EndDate—An end date when the Entity becomes inactive. This field is not used in the current version of the Raptive UI/IDE. However, you could use this in your custom UI if desired.
Note—A textural note for the Entity. This field is not used in the current version of the Raptive UI/IDE. However, you could use this in your custom UI if desired.
UserID—The EntityID of the user who created the Entity.
UpdateDate—The date/time stamp of when the Entity was created.

Raptive was designed to be “pointer-driven” and this table design reflects that aspect of OO design. In almost all instances, the Raptive UI will request data from the database based on some combination of the OrgID and EntityID or the OrgID and EntityType. This makes database reads exceedingly fast and efficient. This approach also works well with just about any custom UI you may design. Unless you are attempting to display all of the information in the database at one time (generally not a good idea), your page or code should always “know” what type of information is to be displayed. For example, your code will know if you are dealing with employee data, customer data, or whatever. This will allow you to zero in on the correct EntityType or EntityID. As you will see, Raptive has APIs to handle these various scenarios.

To aid in general understanding, here is the SQL code required to get a list of all Entities based on an EntityType. We'll cover the APIs that accomplish this a bit later:

SELECT * FROM Entity
WHERE OrgID = 577
AND EntityType = 104

Here is a sample of what is returned:

The Entity table shows the EntityID, the UniqueID, the Status (1 for “active” or 0 for “deleted”), and the Category Type for the Entity. To get the record for a known EntityID, such as 9163 (the first row in the result set above) you could do:

SELECT * FROM Entity
WHERE OrgID = 577 AND EntityID = 9163

Alternately, you could use the combination of UniqueID and EntityType instead of the EntityType or EntityID:

SELECT * FROM Entity
WHERE OrgID = 577
AND EntityType = 104
AND UniqueID = ‘Wayne Hammerly’

Either syntax will return the same result:

Now that we have seen the Entity table, let's examine how the Attributes are stored in the EntityAttribute table.

### EntityAttribute Table

The Entity table that we just examined contains the base information for the Entity and is well suited for displaying a list of Entities in a tree or list. The EntityAttribute table is a column-major table where the data for each Attribute is stored as one Attribute per row. The EntityAttribute table corresponds to the EntityAttributeType table. Using our previous example, here is the basic SQL code to read the Attributes for Employee Wayne Hammerly:

SELECT * FROM EntityAttribute
WHERE OrgID = 577 AND
EntityID = 9163
ORDER BY DisplayID

And here is the result:

Here are the fields in the Entity table:
OrgID—The obligatory OrgID
EntityID—A unique integer generated by Raptive that will act as the numeric identifier of the Entity.
EntityAttributeType—The ID of the AttributeType that corresponds to the TypeID of the Attribute in the EntityAttributeType table.
EntityType—The EntityType of the Entity.
AttributeDesc—The name, description, or prompt for the Attribute. This is any descriptive text to describe the Attribute.
DataType—The DataType of the Attribute. This corresponds to the DataType table.
ValueText—A field for storing alphanumeric values.
ValueNumber—A field for storing numeric values.
ValueNumber—A field for storing date and time values.
DecimalPlaces—The number of decimal places if the DataType is a numeric value.
TextLen—The length of the text if the DataType is an alphanumeric value.
DisplayID—The order that the user has specified to display the Attributes as in ORDER BY DisplayID.
Required—A Boolean value indicated that this is a required Attribute that must contain a value before the data can be saved.
DefaultAttribute—Unused in Entities. This field is used by Activities and is here to maintain consistency.
UserID—The EntityID of the user who created or last updated the Entity Attribute. By Raptive convention, this should only be updated if the user actually updated the Attribute (as opposed to the entire record). This allows you to track who made each change at the Attribute or field level.
UpdateDate—The date/time stamp when the data was stored to the database. This is automatically handled by the Raptive stored procedures.

As you get into writing your application or custom UI, you will find that you will most often access the Entity table to display multiple Entities so that the user can pick from a list or a tree and then access the EntityAttribute table to display the information for the particular Entity that the user has selected.

### Reading Entity Data Via Raptive.Net

In this section we will examine the reading Entity data using the Raptive.Net object model. The classes to work with Entities and Entity Templates are located in the Raptive.Entity namespace. Once you have set a reference to Raptive.dll in your project we suggest that you Import the following namespaces:

Imports Raptive
Imports Raptive.Definitions
Imports Raptive.Entity
Imports Raptive.Entity.Utils
Imports Raptive.Activity

The examples on reading Entity data in this section assume these three namespaces are part of the project.

The main class that is used to access Entity data is the Raptive.Entity class.

### Raptive.Entity.Entity Class

The Entity class is a data class with following properties:
OrgID
EntityID
EntityType
Description
UniqueID
CategoryType
StartDate
EndDate
Note
Status
UserID
UpdateDate
DisplayName
Login
Password
EntityAttributes
EntityAddresses
EntityPhones
EntityContacts
EntityActivityTemplates

The first 12 properties in the list above directly correspond to the fields in the Entity table.

The DisplayName property is used to display the Description and UniqueID properties concatenated into one value for convenient display in list boxes and combo boxes. The Login and Password properties are only populated if the Entity is a User Entity (CategoryType=2) and these values are read from the UserLogin table. The EntityAttributtes property returns a collection containing all of the Entity Attributes. The EntityAddresses property returns a collection containing all of the Addresses. The EntityPhones property returns a collection containing all of the Phones. The EntityContacts property returns a collection containing all of the Contacts. The EntityActivityTemplate property returns a collection containing of all of the Activity Templates associated with the Entity.

### Raptive.Entity.EntityAttribute Class

The EntityAttribute class is a data class with following properties:
OrgID
EntityID
EntityType
EntityAttributeType
DataType
ValueText
ValueNumber
ValueDateTime
TextLen
DecimalPlaces
DisplayID
Required
Description
UserID
UpdateDate
FormattedValue

The first 15 properties in the list above directly correspond to the fields in the EntityAttribute table. The FormattedValue property is an alphanumeric (string) property that contains the formatted value of the Attribute. To understand why this property is important, let's take a moment to examine how Raptive handles Data Types. In the section on Raptive Data Ivpes we saw that Raptive provides a number of different Data Types ranging from common data types such as Integer, Text, and Money to specialized Data Types used for Entity Relationships and Generated IDs. We also saw that Raptive uses the fields ValueText, ValueNumber, and ValueDateTime to store Attribute values according to the Data Type.

Figuring out which field to read for a given Data Type and how to properly format the value can be rather tedious and prone to errors. To avoid this problem, there is code in the Entity class that reads the proper field and properly formats the value for you. The result is returned in the FormattedValue property, ready for display.

### Using the Entity Class to Read Entity Data

Let's begin by examining how to use the class to read Entity data from the Raptor database. Reading and displaying Entity data is one of most common things that you will do in your custom UI.

The Entity.Load method is used to load (read) the information from the database and populate the class. This is an overloaded method with two signatures:

```
Public Function Load(ByVal OrgID As Long, ByVal EntityID As Long, _{—}
      ByVal LoadType As EntityLoadType) As Boolean
Public Function Load(ByVal OrgID As Long, ByVal EntityID As Long, _{—}
      ByVal LoadType As EntityLoadType, _{—}
      ByVal UserID As Long) As Boolean
```

The parameters are:
OrgID—The OrgID of the Organization.
EntityID—The EntityID of the Entity you wish to load.
LoadType—Specifies the type of load. There are three options and Visual Studio will display them via IntelliSense:
   Enums.EntityLoadType.Summary—Load only the information from the Entity table. Use this when you need the basic information such as the UniqueID, EntityType, or the CategoryType for the Entity.
   Enums.EntityLoadType.Detail—Load the information from the Entity and EntityAttribute tables. Use this when you need the Entity Attributes, but do not need or want the Address, Phone, and Contact information.
   Enums.EntityLoadType.LoadAll—Loads all of the information on the Entity including all Address, Phone, and Contact information.
UserID—If the optional UserID parameter is specified, the method will utilize Raptive Security and only load the data if the UserID (the EntityID of the current user) has been granted access to the Entity.

Here is an example of the code required to read an Entity:

Dim Entity As New Entity
bLoaded = Entity.Load(OrgID, EntityID,
Enums.EntityLoadType.LoadAll)

In this example, we used the LoadAll option and have loaded all of the Entity information, including the Attributes, Addresses, Phones, Contacts, Contact Addresses and Contact Phones into the object. Now that the information has been loaded let's work with it.
See Also Raptive.EntityLoadType, Raptive.Entity.Entity Class, Raptive.Entity.Entity.Load Method

Accessing the Entity Properties

Here is an example of accessing the properties and displaying the information to the user:

```
Dim Entity As New Entity
Dim bLoaded As Boolean
bLoaded = Entity.Load(OrgID, EntityID,
Enums.EntityLoadType.LoadAll)
If bLoaded Then
    With Entity
          TextBox1.Text = .OrgID
          TextBox2.Text = .EntityID
          TextBox3.Text = .EntityType
          TextBox4.Text = .Description
          TextBox5.Text = .UniqueID
    End With
End If
```

This is a rather simple example, but it does get the idea across.

Accessing the Entity Attributes

An Entity may have zero or more Entity Attributes. These Attributes are returned as a strongly-typed collection in the EntityAttributes property. Here is an example of accessing the Entity Attributes. For this example, we will load just the Attribute name (AttributeDesc) and Attribute value (FormattedValue) the to a list box:

```
Dim EntityAttributes As New EntityAttributeList
EntityAttributes = EntityAttributes
Dim EntityAttribute As New Raptive.Entity.EntityAttribute
For Each EntityAttribute In Entity.EntityAttributes
    ListBox1.Items.Add(EntityAttribute.AttributeDesc.ToString & _{—}
        “:” & EntityAttribute.FormattedValue.ToString)
Next
```

In this example we have requested an Employee Entity that has six Attributes. The result would be a listbox containing something like this:

### Prefix: Mr.

### First Name: John

### Middle Name: Q.

### Last Name: Public

### Suffix: Jr.

### Start Date Jan. 1, 2000

This is a very simple example of displaying the name and value of the Attribute using the AttributeDesc and FormattedValue properties.

Entity.GetEntityAttributesDataSet Method

There may be times when it is more appropriate to use a System.Data.DataSet object to access Entity Attribute data. Here is an example that loads the summary information for the Entity and then uses the GetEntityAttributeDataSet property to return a DataSet:

bLoaded = Entity.Load(OrgID, EntityID,
Enums.EntityLoadType.LoadSummary)
If bLoaded Then
Dim ds As DataSet = Entity.GetAttributesDataSet( )
End If

Here is an example of the returned DataSet (shown in two snapshots for easy reading):

Note the AttributeValue field at the end. This is a computed field and is the field used for the Entity.FormattedValue property. At first glance, the values for the ValueText and AttributeValues fields appear to be duplicated but that is only because in this example, all of the Employee Attributes in this example happen to be text-based.

This method uses the spIntEntityAttribute_Select stored procedure.

Entity.GetEntityAttributesDataReader Method

Here is the same example using the Entity.GetAttributesDataReader method to return the information in a System.Data.SqlClient.SqlDataReader class:

bLoaded = Entity.Load(OrgID, EntityID,
Enums.EntityLoadType.LoadSummary)
If bLoaded Then
Dim dr As SqlDataReader = Entity.GetAttributesDataReader( )
End If

This method uses the spIntEntityAttribute_Select stored procedure.

When working directly with the EntityAttribute table using the GetAttributesDataSet or GetAttributesDataReader methods, you need to take the Data Type into consideration and may have to access one or more of the ValueText, ValueNumber, and ValueDateTime properties as well as the FormattedValue property. Here is the information you will need to access these fields.

Data Type 9 Attributes

Data Type 9 is the Dropdown Data Type. Attributes with a Data Type value of 9 contain a selection from a dropdown list. When reading or editing an Attribute of this Data Type, you will on occasion need to load a combo or list box control with the entire dropdown list so that a user can make or change a selection. To facilitate this, two values are stored for this Attribute: The first value s the text of the item that was selected from the dropdown list and this value is stored in both the ValueText and FormattedValue properties. You may use either to display the value for the Attribute. The second stored value is the EnumGroupID of dropdown list. This is a pointer that identifies the dropdown list is associated with this Attribute.

Let's take a moment to look at the applicable database tables to see how dropdown lists work in Raptive so that you have the basic concepts down. Later, we'll see how to access this information via the Dropdown class. Here is a look at the pertinent fields for just one sample Entity Attribute (the Prefix Attribute from our example above) in the EntityAttributes table:

Note that the ValueText field contains a value of “Mr.” and the ValueNumber field contains 5253 which is a pointer (PK/FK in database parlance) to the ID of an EnumGroup (dropdown list) in the EnumGroup table. We can view what dropdown list that is with the following SQL code:

We see here that EnumGroup 5253 is named “Prefix Type” and has an EnumGroupTypeID of 323. We can view all of the items that belong on the dropdown list with this code:

Note that we stored the text of “Mr.” in the EntityAttribute table rather than storing the EnumTypeID of 1101 to create a solid database constraint. To a DBA, this would, at first blush, seem to be a design flaw that breaks DRI. There is actually a very good reason for doing things this way. We store the value “Mr.” in the database because that was the value that the user selected and we never change history. Even if the record for 1101 (the record for “Mr.”) is deleted or changed in the dropdown list, and even if the entire dropdown list is deleted at some point in the future, the value of “Mr.” will remain in the database until someone actually changes it physically. Storing the actual value rather than a pointer to the value conforms to the newer standards such as Sarbanes-Oxley. Now that we have the concepts down, let's look at the Utils.Dropdown class which makes all of this very easy and straightforward. We begin by instantiating and then loading an instance of Utils.Dropdown class.

The Utils.Dropdown.Load method has two signatures:

Public Function Load(ByVal EntityAttribute As EntityAttribute) As
Boolean
Public Function Load(ByVal OrgID As Long, _{—}
ByVal EnumGroupID As Long) As Boolean

This makes it handy to get the dropdown information directly from the EntityAttribute object that you are working with. Just pass the Utils.Dropdown.Load method any EntityAttribute that has a Data Type of 9 and the class is populated with all of the information about the proper dropdown list (i.e., the EnumGroup whose ID is stored in the ValueNumber property).

The optional EnumGroupID is the ValueNumber property of the EntityAttribute class. This signature is handy when reading the value from some other source, such as a list of dropdowns or in stateless environments such as a web page. Both methods return Boolean True if the load was successful and the class contains data, otherwise they will return Boolean False. For this next example, we will load an Entity object with data, loop through the EntityAttributes, populate a combo box control with the contents of the dropdown list referenced by the EntityAttribute.ValueNumber property and finally, set the Text property of the combo box to the FormattedValue property of the Entity object:

```
Dim Entity As New Entity
Dim bLoaded As Boolean
bLoaded = Entity.Load(OrgID, EntityID,
Enums.EntityLoadType.LoadAll)
If bLoaded Then
    ‘ load the Entity Attributes...
    Dim EntityAttributes As New EntityAttributeList
    EntityAttributes = EntityAttributes
    Dim EntityAttribute As New EntityAttribute
    ‘ loop through the Entity Attributes...
    For Each EntityAttribute In Entity.EntityAttributes
    If EntityAttribute.DataType =
    Enums.RaptiveDataType.dtDropdown Then
              ‘ load the Dropdown object...
              Dim Dropdown As New Dropdown
        Dropdown.Load(EntityAttribute)
              ‘ get the Dropdown list...
        Dim DItem As New DropdownItem
                    Dim DropdownList As New DropdownList
        DropdownList = Dropdown.DropdownItems
                ‘ loop through the list and populate the appropriate
                combo box...
                    ComboBox1.DisplayMember = “Description”
        For Each DItem In DropdownList
              ComboBox1.Items.Add(DItem)
        ComboBox1.Text = EntityAttribute.FormattedValue
        Next
        End If
        Next
End If
```

There may be times when you want to get a list of all of the dropdown lists in the Organization. For these occasions, use the Dropdown.GetAllDropdownLists method. It will return a collection containing all of the dropdown lists in the Organization:

Public Function GetAllDropdownLists(ByVal OrgID As As Long As TypeTableList

This will return a collection containing one Dropdown object for each list:

Dim DropdownList As New TypeTableList
Dim Dropdown As New Dropdown
DropdownList = Dropdown.GetAllDropdownLists(OrgID)
Dim ListItem As New TypeTableListItem
For Each ListItem In DropdownList
ListBox1.Items.Add(ListItem.Description.ToString)
Next

See Also: Raptive.Utils.Dropdown Class, Raptive.Utils.DropdownItem Class, Raptive.Utils.DropdownList Class, Reading Dropdown Data in SQL

### Data Type 12-14 Attributes

Data Types 12, 13, and 14 are all Entity Relationship Data Types of one form or another. As such, the ValueNumber property contains EntityID of the related Entity and the FormattedValue property contains the UniqueID of the related Entity. The UniqueID is provided for display purposes and the EntityID can be used to load the related Entity:

Dim RelatedEntity As New Entity
Dim bLoaded As Boolean
bLoaded = RelatedEntity.Load(OrgID, EntityAttribute.ValueNumber, _{—}
Enums.EntityLoadType.LoadAll)

Hint: When displaying Attributes with any of these three Data Types in the Raptive UI/IDE, we display the UniqueID of the related Entity (i.e., the EntityAttribute.FormattedValue property) as a link so that the user can click on the link to jump to the related Entity. We set the HREF for the link to an ASPX page and pass the EntityID (read from the Attribute's ValueNumber property) of related Entity to display.

All Other Data Types Attributes

You can display the value of all of the other Data Types using the FormattedValue property.

Accessing Entity Address Data

Every Entity in Raptive has a built-in collection of Addresses. The Entity class returns these to you as a collection via the EntityAddresses property. This collection works just like the EntityAttributes collection we just examined:

Dim Address As New Raptive.Entity.Address
For Each Address In Entity.EntityAddresses
‘ display the properties of the Address class for each address...
Next

The Address class contains all of the fields in the EntityAddress table. It also includes the AddressTypeDescription field from the OrgAddressType table:
OrgID
PartyID
AddressType
AddressTypeDesc
RecipientName
Addr1
Addr2
Addr3
City
State
PostCode
Country
Note
UserID
UpdateDate

See Also Rapive.Entity.Addess Class

Accessing an Entity Phone Data

Every Entity in Raptive has a built-in collection of Phones (and electronic addresses such as email and web site addresses). The Entity class returns these to you as a collection via the EntityPhones property. This collection works just like the other collections we have examined:

Dim Phone As New Raptive.Entity.Phones
For Each Phone In Entity.EntityPhones
‘ display the properties of the Phone class for each entry...
Next

The Phone class contains all of the fields in the EntityPhone table. It also includes the PhoneTypeDescription field from the OrgPhoneType table:
OrgID
PartyID
PhoneType
PhoneTypeDesc
PhoneValue
Note
UserID
UpdateDate

See Also Raptive.Entity.Phone Class

Accessing Entity Contact Data

Every Entity in Raptive has a built-in collection of Contacts. The Entity class returns these to you as a collection via the EntityContacts property. This collection works just like the other collections we have examined:

Dim Contact As New Raptive.Entity.Contacts
For Each Contact In Entity.EntityContatcs
‘ display the properties of the Contact class for each entry...
Next

The Contact class has the following properties:
OrgID
PartyID
ContactType
ContactTypeDesc
ContactID
Prefix
FirstName
MiddleInitial
LastName
Note
ContactAddresses
ContactPhones
UserID
UserID
UpdateDate

Each Contact has a collection of Addresses and a collection of Phones. These are returned in the ContactAddresses and ContactPhones properties. You access these properties in the same way that you accessed the Address and Phone collection properties of an Entity.

See Also Raptive.Entity.Contact Class, Raptive.Entity.Address Class, Raptive.Entity.Phone Class

### Accessing Entity Relationships via Raptive.Net

Getting Entity Children

In the section on Entity Relationships we discussed how an Entity within Raptive can be related to other Entities by creating one or more Parent/Child relationships. As such, any Entity may have zero or more parents, and/or zero or more children.

The EntityChild class provides six methods that return varying amounts of information on an Entity's children:

EntityChild.GetEntityChildCount Method

This method tells you how many children the specified Entity has.

Public Function GetEntityChildCount(ByVal OrgID As Long, _{—}
ByVal EntityID As Long) As Long

Here is an example:

Dim EntityChild As New EntityChild
Dim Count As Long
Count = EntityChild.GetEntityChildCount(OrgID, EntityID)

EntityChild.GetEntityChild Method

The GetEntityChild method will return an EntityList collection that contains all of the Entity's children as Entity objects. This method has one overload:

```
Public Function GetEntityChild(ByVal OrgID As Long, _{—}
            ByVal EntityID As Long, _{—}
                        ByVal LoadType As EntityLoadType) _{—}
            As EntityList
Public Function GetEntityChild(ByVal OrgID As Long, _{—}
            ByVal EntityID As Long, _{—}
            ByVal LoadType As EntityLoadType, _{—}
                        ByVal UserID As Long) As EntityList
```

This method will return the strongly-typed EntityList collection class containing objects based on the Entity class.

The EntityLoadType parameter allows you to define the amount information that is loaded for each Entity (i.e., Summary, Detail or LoadAll). This is the same EntityLoadType parameter in the Entity.Load method that we examined earlier. If the UserID (the EntityID of the current user) parameter is specified, this method will utilize Raptive Security and will return only those children that the user has been granted access. Here is an example that uses the method to populate a list box with all of the children of the specified Entity:

```
Dim EntityChild As New EntityChild
Dim ChildList As New EntityList
ChildList = EntityChild.GetEntityChild(OrgID, EntityID, _{—}
            Enums.EntityLoadType.Summary)
TextBox1.Text = ChildLi  st.Count.ToString
Dim Entity As New Entity
ListBox1.DisplayMember = “DisplayName”
For Each Entity In ChildList
    ListBox1.Items.Add(Entity)
Next
```

This example shows the usef of the Entity.DisplayName property. The property returns a contactenated string that is the fully qualified Raptive “name” of the Entity. It is comprised of the EntityType Description together with the UniqueID. For example, an Entity based on the “Employee” Entity Template, with a UniqueID of “John Doe” would have a DisplayName value of “Employee—John Doe”.

Setting the ListBox1.DisplayMember to “DisplayName” tells the list box to use the Entity.DisplayName property and display the fully-qualified name for the Entity.

Warning: Raptive Entries may have air extremely large number of children! Attempting to load hundreds or thousands of child Entities using this method may overextend servers and cause problems. When dealing with Entities that may have a large number of children, especially Entities of Category Type 13 (Data Bin), you should use the GetEnitityChildCount to get a count of the number of Entities that will be loaded, If the count is high, we recommend that you use one of the other of the GetEntityChild methods.

EntityChild.GetEntityChildList Method

The GetEntityChildList method will return the EntityID and the fully-qualified name of all child Entities of the specified EntityID. This is handy when you want to populate a list, when you are dealing with a large number of children, or you just don't need to load all of the data for each child Entity. This method has one overload:

```
Public Function GetEntityChildList(ByVal OrgID As Long, _{—}
                ByVal EntityID As Long) As TypeTableList
Public Function GetEntityChildList(ByVal OrgID As Long, _{—}
                ByVal EntityID As Long, _{—}
                ByVal UserID As Long) As TypeTableList
```

The list of children is returned in the TypeTableList strongly-typed collection class containing TypeTableItem objects. Note that the property will contain the fully qualified name in the form Description & “-” & UniqueID of the Child Entity.

If the UserID (the EntityID of the current user) parameter is specified, this method will utilize Raptive Security and will return only those children that the user has been granted access.

Here is an example of loading the list of child Entities to a list box:

Dim EntityChild As New EntityChild
Dim ListItem As New TypeTableListItem
Dim ChildList As New TypeTableList
ChildList = EntityChild.GetEntityChildList(OrgID, EntityID)
ListBox1.DisplayMember = “Description”
ListBox1.ValueMember = “ID”
For Each ListItem in ChildList
ListBox1.Items.Add(ListItem)
Next

EntityChild.GetEntityChildListID Method

The GetEntityChildListID method will return the OrgID, EntityID, Description, and UniqueID fields for all child Entities of the specified EntityID. This method has one overload:

```
Public Function GetEntityChildListID(ByVal OrgID As Long, _{—}
                ByVal EntityID As Long) _{—}
                As EntityIDList
Public Function GetEntityChildListID(ByVal OrgID As Long, _{—}
                ByVal EntityID As Long, _{—}
                ByVal UserID As Long) _{—}
                As EntityIDList
```

The list of children is returned in the EntityIDList strongly-typed collection class containing EntityID objects. If the UserID (the EntityID of the current user) parameter is specified, this method will utilize Raptive Security and will return only those children that the user has been granted access. Here is an example of loading the list of child Entities to a list box:

```
Dim EntityChild As New EntityChild
Dim EntityID As New EntityID
Dim ChildList As New EntityIDList
ChildList = EntityChild.GetEntityChildListID(OrgID, EntityID)
ListBox1.ValueMember = “EntityID”
For Each ListItem In ChildList
    ListBox1.Items.Add(EntityID.Description & “ - ” &
    EntityID.UniqueID)
Next
```

EntityChild.GetEntityChildDataSet Method

The GetEntityChildListDataSet method will return a list of all child Entities of the EntityID specified in a DataSet object. The DataSet will contain all of the fields in the Entity Table.

```
Public Function GetEntityChildDataSet(ByVal OrgID As Long, _{—}
                ByVal EntityID As Long) As DataSet
Public Function GetEntityChildDataSet(ByVal OrgID As Long, _{—}
                ByVal EntityID As Long, _{—}
                ByVal UserID As Long) As DataSet
```

Here is an example showing the fields in the DataSet:

This method uses either the spGetEntityChildrenList stored procedure or the spGetEntityChildrenEntityAccess stored procedure to return the data, depending on the value of the UserID parameter.

EntityChild.GetEntityChildDataReader Method

The GetEntityChildDataReader method will return a list of all child Entities of the EntityID specified in a SqlDataReader object. The SqlDataReader will contain all of the fields in the Entity Table.

```
Public Function GetEntityChildDataReader(ByVal OrgID As Long, _{—}
                                    ByVal EntityID As Long) _{—}
                                    As SqlDataReader
Public Function GetEntityChildDataReader(ByVal OrgID As Long, _{—}
                                    ByVal EntityID As Long, _{—}
                                    ByVal UserID As Long) _{—}
                                    As SqlDataReader
```

This method uses either the spGetEntityChildrenList stored procedure or the spGetEntityChildrenEntity Access stored procedure to return the data, depending on the value of the UserID parameter.
See Also Entity.EntityChild Class, Utils.TypeTableList Class, Utils.TypeTableItem Class, Entity.EntityIDList Class, Entity.EntityID Class

Getting Entity Parents

Just as Entities may have zero or more children, they may also have zero or more parents. The EntityParent class provides six methods that return varying amounts of information on an Entity's children. Note that these methods work just like the EntityChild methods examined in the previous section.

EntityParent.GetEntityParentCount Method

This method tells you how many parents the specified Entity has.

Public Function GetEntityParentCount(ByVal OrgID As Long, _{—}
ByVal EntityID As Long) As Long

Here is an example:

Dim EntityParent As New EntityParent
Dim Count As Long
Count = EntityChild.GetEntityParentCount(OrgID, EntityID)

EntityParent.GetEntityParents Method

The GetEntityParents method will return a collection that contains all of the Entity's parents as Entity objects. This works exactly like the GetEntityChild method we just examined.

```
Public Function GetEntityParents(ByVal OrgID As Long, _{—}
                ByVal EntityID As Long, _{—}
                ByVal LoadType As EntityLoadType) _{—}
                As EntityList
Public Function GetEntityParents(ByVal OrgID As Long, _{—}
                ByVal EntityID As Long, _{—}
                ByVal LoadType As EntityLoadType, _{—}
                ByVal UserID As Long) _{—}
                As EntityList
```

If the UserID (the EntityID of the current user) parameter is specified, this method will utilize Raptive Security and will return only those parents that the user has been granted access.

EntityParent.GetEntityParentList Method

The GetEntityParentList method will return just the EntityID and Description of each child Entity. This works exactly like the GetEntityChildList method we just examined.

```
Public Function GetEntityParentList(ByVal OrgID As Long, _{—}
                ByVal EntityID As Long) _{—}
                As TypeTableList
Public Function GetEntityParentList(ByVal OrgID As Long, _{—}
                ByVal EntityID As Long, _{—}
                ByVal UserID As Long) _{—}
                As TypeTableList
```

If the UserID (the EntityID of the current user) parameter is specified, this method will utilize Raptive Security and will return only those Entities that the user has access to.

EntityParent.GetEntityParentListID Method

The GetEntityParentListID method will return the OrgID, EntityID, Description, and UniqueID fields for all parent Entities of the specified EntityID. This method has one overload:

```
Public Function GetEntityParentListID(ByVal OrgID As Long, _{—}
                ByVal EntityID As Long) _{—}
                As EntityIDList
Public Function GetEntityParentListID(ByVal OrgID As Long, _{—}
                ByVal EntityID As Long, _{—}
                ByVal UserID As Long) _{—}
                As EntityIDList
```

The list of parents is returned in the EntityIDList strongly-typed collection class containing EntityID objects. If the UserID (the EntityID of the current user) parameter is specified, this method will utilize Raptive Security and will return only those parents that the user has been granted access. Here is an example of loading the list of parent Entities to a list box:

```
Dim EntityParent As New EntityParent
Dim EntityID As New EntityID
Dim ParentList As New EntityIDList
ParentList = EntityParent.GetEntityParentListID(OrgID, EntityID)
ListBox1.ValueMember = “EntityID”
For Each ListItem In ParentList
    ListBox1.Items.Add(EntityID.Description & “ - ” &
    EntityID.UniqueID)
Next
```

EntityParent.GetEntityParentDataSet Method

The GetEntityParentListDataSet method will return a list of all parent Entities of the EntityID specified in a DataSet object. The DataSet will contain all of the fields in the Entity Table.

```
Public Function GetEntityParentDataSet(ByVal OrgID As Long, _{—}
                              ByVal EntityID As Long) As DataSet
Public Function GetEntityParentDataSet(ByVal OrgID As Long, _{—}
                ByVal EntityID As Long, _{—}
                ByVal UserID As Long) As DataSet
```

Here is an example showing the fields in the DataSet:

This method uses either the spGetEntityParentList stored procedure or the spGetEntityParentEntity Access stored procedure to return the data, depending on the value of the UserID parameter.

EntityParent.GetEntityParentDataReader Method

The GetEntityParentDataReader method will return a list of all parent Entities of the EntityID specified in a SqlDataReader object. The SqlDataReader will contain all of the fields in the Entity Table.

```
Public Function GetEntityParentDataReader(ByVal OrgID As Long, _{—}
                                      ByVal EntityID As Long)
                                      As SqlDataReader
Public Function GetEntityParentDataReader(ByVal OrgID As Lone, _{—}
                    ByVal EntityID As Long, _{—}
                    ByVal UserID As Long) _{—}
                    As SqlDataReader
```

The fields in the SqlDataReader will be the same as for the DataSet example shown above. This method uses either the spGetEntityParentList stored procedure or the spGetEntityParentEntityAccess stored procedure to return the data, depending on the value of the UserID parameter.
See Also Entity.EntityParent Class, Utils.TyppeTableList Class, Utils.TypTableItem Class, Entity.EntityIDList Class, Entity.EntityID Class

### Reading Entity Activity Template Data via Raptive.Net

How Activity Templates are Structured

Activities in Raptive begin with a Base Activity Template that can be thought of as a base class for the Activity. Like a base class in .Net, the Base Activity Template is used to implement abstraction and derived classes. The metadata for Base Activity Templates are stored in the ActivityType and ActivityAttributeType tables as shown below:

The ActivityType and ActivityAttributeType tables work identically to the EntityType and EntityAttributeType tables we examined earlier. There is one row for each Activity Template in the ActivityType table and the ActivityAttributeType table is a column-major table with one row for each Activity Attribute.

This schema allows the Raptive designer to create a Base Activity Template that can then be associated with multiple Entity Templates such as an Employee template, a Project template, and any other Entity Template that requires recording time. When the Raptive designer associates a Base Activity Template to an Entity Template (such as associating our example base Log Time Activity to the Employee Entity Template) they are creating an Entity/Activity Pair. We call the derived Activity Template an Entity Activity Template as opposed to a Base Activity Template.

Raptive creates what is effectively a derived class of the Base Activity Template by storing a copy of the Base Activity Template in the Activity and ActivityAttribute tables and making an entry in the EntityActivity table. This in turn creates the Entity/Activity Pair and the Entity Activity Template. Note that there is a direct correlation between the ActivityType and ActivityAttributeType tables used to store the Base Activity Template and the Activity and ActivityAttribute tables used to store the derived Activity Template—the two sets of tables are almost identical.

Once an Entity/Activity pair has been created and our example Log Time Activity is associated with the Employee Entity Template, the Raptive designer can use the Raptive UI/IDE to modify the Employee Log Time template as desired. This is akin to adding additional properties or methods to a derived class in .Net. This allows the Employee Log Time Activity to have Attributes different from the Project Log Time Activity even though both Activities inherited from the same Log Time Base Activity Template. The end result is that there are at least two Log Time Activity Templates: The Base Activity Template and the Activity Template for our example Employee Log Time Activity. You will seldom if ever access the Base Activity Template. You will however access the derived Activity Template often when working in Raptive.

When you access the Entity.EntityActivityTemplates property you are accessing the data for the derived Activity Template stored in the Activity and ActivityAttribute tables. So where is the actual Log Time data stored? Going back to our Employee Entity and the Log Time Activity example, when John Doe wants to record his time, he uses the Log Time Activity associated with his Employee Entity Template. The actual data for this entry is stored in the EntityEntry table using the Activity Template to define the “shape” of the information. We call this entry the Activity Entry.

The data in the EntityEntry table is keyed to the Activity Template so that Raptive can automatically handle changes made to any template without disrupting or destroying existing historical data stored in the EntityEntry table. This is one of the many things that set Raptive apart from any other database platform.

Understanding How the Data is Stored

You may have noticed from the table diagram shown at the beginning of this section that the three tables ActivityAttributeType, ActivityAttributeType, and EntityEntry look very similar:

Let's take a moment to look at the fields in these tables and how they are used when accessing Activity data:
The Attribute metadata for Base Activity Templates are stored in the ActivityAttributeType table and is keyed to the Entity Template and the ActivityType.
The Attribute metadata for Activity Templates (Entity/Activity Pairs) are stored in the ActivityAttribute table and is keyed to the EntityID and the ActivityID.
The Attributes metadata for Activity Entries are stored in the EntityEntry table and is keyed on the EntityID, the ActivityID, and a unique EntryID for each Activity Entry.
The first two tables are template tables that contain the metadata that defines each Attribute.
The RateAttribute field is a flag that indicates that this Attribute is a special Attribute used by Raptive to calculate billing rates. We will examine this field in greater detail a bit later.
The DefaultAttribute field is a flag that shows which Attribute is to be used for Activity History summaries.
The EntityEntry table contains the three data fields of ValueText, ValueNumber and ValueDateTime and the value of the Attribute will be stored in one or more of these three fields depending on the Data Type of the Attribute. These fields, together with the DecimalPlaces and TextLen fields work just like the Entity Attribute tables that we examined in detail in the previous section.
The EntityEntry.EntryDate field is a date/time stamp that shows when the Entry was made. This value will not change if an Attribute's data is later updated. The UpdateDate field will initially have the same value as the EntryDate field but the UpdateDate value will change to reflect any subsequent updates to the Attribute Entry.
The EntityEntry.EntryEntityID is the EntityID of the user who saves the Entry. The EntityEntry.EntryEntityName field is the name (the UniqueID) of the user who saves the Entry. This information is placed here to alleviate the need to join to the Entity tables to retrieve the UniqueID (name) of the user. Similarly, the UserLoginID field is the numeric login ID of the user and alleviates the need to join or to search the UserLogin table when requiring the user to provide a password to see the data.

Accessing Entity Activity Templates

An Entity may have zero or more Activities associated with the Entity. These Activities are represented as Activity Templates and are returned in a strongly-typed collection via the EntityActivityTemplates property. The class for this strongly-typed collection is the Activity.EntityActivityList class which will contain zero or more objects based on the Activity.EntityActivityTemplate class.

The Activity.EntityActivityTemplate class contains all of the fields in the Activity and ActivityAttribute tables:
OrgID
EntityType
TypeID
Description
Status
ActivityAttributes
UserID
UpdateDate

Here is an example of accessing the Entity Activities. For this example, we will load a ListBox with all of the Activities associated with the Entity and display the Activity name (the Description property) to the user:

Dim ActivityList As Activity.EntityActivityList
ActivityList = Entity.EntityActivityTemplates
ListBox1.DisplayMember = “Description”
ListBox1.ValueMember = “ActivityID”
Dim ActivityTemplate As Activity.EntityActivityTemplate
For Each ActivityTemplate In ActivityList
ListBox1.Items.Add(ActivityTemplate)
Next

The ListBox1 control will contain a list of all of the Activities associated with the Entity. At this point we can add code to the ListBox1_MouseDoubleClick event that will load the specified Activity Template to the ListBox2 control and display a list of the Activity Attributes:

Dim ActivityTemplate As Activity.EntityActivityTemplate
ActivityTemplate = ListBox1.Items(ListBox1.SelectedIndex)
Dim AttributeList As Activity.EntityActivityAttributeList
AttributeList = ActivityTemplate.ActivityAttributes
Dim ActivityAttribute As Activity.EntityActivityAttribute
ListBox2.DisplayMember = “AttributeDesc”
For Each ActivityAttribute In AttributeList
ListBox2.Items.Add(ActivityAttribute)
Next

Here is a diagram of the entire object structure for the preceding code examples:

There may be times when it is more appropriate to use a System.Data.DataSet object or the System.Data.SqlClient.SqlDataReader object to access Entity Template Attribute data. The class provides two methods to return these objects:

Public Function GetAttributesDataSet( ) As DataSet
Public Function GetAttributesDataReader( ) As SqlDataReader

Here is an example that returns the Activity Templates in a System.Data.DataSet object. Use this method when you want to bind the Attribute information to a control or want to work directly with the fields in the table:

Dim ActivityList As Activity.EntityActivityList
ActivityList = Entity.EntityActivityTemplates
Dim ActivityTemplate As Activity.EntityActivityTemplate
Dim ds As DataSet
ds = ActivityTemplate.GetAttributesDataSet

These methods use the spGetActivityAttribute_Detail stored procedure.

What Entity Activity Templates are Used for

Activity Templates provide the metadata for an Activity. Typically you will use this metadata whenever the user is entering a new Activity Entry or editing an existing Activity Entry. Here is an example that illustrates the concept. Suppose that we are working with an Employee Entity and that Entity has a Log Time Activity. Now the user needs to record a new Activity Entry and we have to display a page to allow the user to enter data.

Creating a new .aspx web page or Windows form for each Entity/Activity Pair could require the development team to write hundreds or thousands of pages. Not a very pleasant thought. A better solution, the Raptive solution, is to create one web page that can handle the input and editing of any Entity/Activity Pair. That is the approach that we used in the Raptive UI/IDE.

The Activity.aspx page is passed the EntityID and ActivityID of the Entity Activity that we are working with. A flag is included to tell us if this is a new Activity Entry or we are editing an existing entry. By reading the Activity Template metadata, we can build the input form dynamically and display something like this for a Log Time Activity:

This is a snapshot from the Raptive UI/IDE which uses a single page for entering or editing data for all Activity Templates. The metadata in the Activity Templates provides all of the information we need to dynamically build the input page based on the metadata of the Activity Template.
See Also Activity.ActivityList Class, Activity.ActivityTemplate Class,
   Activity.EntityActivityTemplate Class,
Activity.EntityActivityAttributeList Class,
   Activity.EntityActivityAttribute Class

### Reading Activity Entry Data via Raptive.Net

Now that we have seen how Activity Templates work and what they are used for, let's examine how to read Activity Entries. For this narrative we will be working with the same Employee—Wayne Hammerly Entity (EntityID 9163 in OrgID 577) that we have used previously. We will also say that the Employee Entity Template has two Activities associated, a Log Time Activity and a Log Expense Activity.

The Activity.ActivityHistory class is used to read existing Activity Entries. The class provides a number of methods to obtain Activity history information. The only property for the class is used to return a collection of summary data:
HistorySummaryList

Raptive.Net provides a number of methods and data formats for reading the history in order to accommodate a wide range of applications and needs:
Activity History Summary—When working with an Entity's Activity Entry history that may contain Activities based on multiple Activity Templates, the various “Summary” methods must be used. This is necessary because the Activity Attributes may be different for each Activity Template and the Attributes (fields) will not “line up”. The summary methods will return a single object or data row for each Activity Entry that contains a summary of the data in a standardized format that will line up in a grid. This is accomplished by including only the Activity Attribute that is defined as the Default Attribute for the Activity Template. When designing the Activity Template, the Raptive designer can specify which Activity Attribute will be used for the history summary by setting that Attribute's DefaultAttribute flag. This provides the Raptive designer the ability to specify that the “Hours” Attribute will be displayed for a Log Time Activity, the “Amount” Attribute will be displayed for a Log Expense Activity, and so on.
Activity History Detail—The various “Detail” methods return all of the data for the Activity Entry. To accomplish this and have the data “line up”, you must specify the single Activity Template (ActivityType) you wish to retrieve. The “Detail” methods are used when you want to display all of the Attributes for a specified Activity Template such as a Log Time Activity.

In this section we will examine both the History Summary and the History Detail methods.

Reading the Activity History Summary

ActivityHistory.LoadSummary Method

The ActivityHistory.LoadSummary method is used to load a summary of all of the Activity Entries for a given Entity for a specified date range. The summary will be returned in the HistorySummaryList property and will contain all of the Activity Entries, regardless of the Activity Type, for the specified date range. This is an overloaded method with two signatures:

```
Public Function LoadSummary(ByVal OrgID As Long, _{—}
            ByVal EntityID As Long, _{—}
            ByVal BeginDate As Date, _{—}
            ByVal EndDate As Date, _{—}
          Optional ByVal MaxRecords As Integer = 0) As Boolean
    Public Function LoadSummary(ByVal OrgID As Long, _{—}
                ByVal EntityID As Long, _{—}
                ByVal UserID As Long, _{—}
                ByVal BeginDate As Date, _{—}
                ByVal EndDate As Date, _{—}
              Optional ByVal MaxRecords As Integer = 0) As Boolean
```

If a UserID is specified, the LoadSummary method will utilize Raptive Security and only load the data if the UserID (the EntityID of the current user) has been granted access to the Entity.

The ActivityHistory.HistorySummaryList property returns a strongly-typed Activity.HistorySummaryList collection class that contains a collection of Activity.ActivityEntrySummary objects. Here is an example that loads the Activity Entries into a list box control:

```
Dim ActivityHistory As New Activity.ActivityHistory
Dim bLoaded As Boolean
bLoaded = ActivityHistory.LoadSummary(OrgID, EntityID, _{—}
                      “1/1/1999”, “9/4/2007”)
If bLoaded Then
    Dim HistoryList As New Activity.HistorySummaryList
    HistoryList = ActivityHistory.HistorySummaryList
    Dim Entry As Activity.ActivityEntrySummary
    For Each Entry In HistoryList
            ListBox1.Items.Add(Entry.ActivityName & “: ” &
            Entry.FormattedValue)
    Next
End If
```

ActivityEntrySummary Class

Let's take a moment to look at the ActivityEntrySummary data class that makes up the objects in the strongly-typed HistorySummaryList collection. This class exposes the following properties:
EntityID
EntityName
ActivityName
ActivityType
ActivityID
EntryID
DataType
Attribute
FormattedValue
FilterDate
EntryEntityID
EntryEntityName
UpdateDate

Here is a brief description of the properties:
EntityID—The EntityID of the Entity that this entry is associated with.
EntityName—The UniqueID (name) of the Entity this entry is associated with.
ActivityName—The name (Description) of the Activity Template of this entry.
ActivityType—The Type ID of the Activity Template that this entry is based on.
ActivityID—The ActivityID of the Activity.
EntryID—The unique EntityID for this entry.
DataType—The Data Type of the Attribute.
Attribute—The name (Description) of the Attribute. The DefaultAttribute field in the template defines which Attribute will be displayed in the History Summary.
FormattedValue—The formatted value of the Attribute.
FilterDate—The Date for the entry.
EntryEntityID—The EntityID of the user who entered this data.
EntryEntityName—The UniqueID (name) of the user who entered this data.
UpdateDate—The date that the Attribute was last updated.
See Also Activity.ActivityHistory Class, Activity.ActivityEntrySummary Class

ActivityHistory.GetSummaryDataSet Method

There may be times when you want to return either a System.Data.DataSet or a System.Data.SqlClient.SqlDataReader object in order to data bind to a grid. The ActivityHistory class provides a number of methods to facilitate data binding. The first is the GetSummaryDataSet method. This is an overloaded method with two signatures:

```
Public Function GetSummaryDataSet(ByVal OrgID AS Long, _{—}
            ByVal EntityID As Long, _{—}
            ByVal BeginDate As Date, _{—}
            ByVal EndDate As Date, _{—}
        Optional ByVal MaxRecords As Integer = 0) As DataSet
Public Function GetSummaryDataSet(ByVal OrgID As Long, _{—}
            ByVal EntityID As Long, _{—}
            ByVal UserID As Long, _{—}
            ByVal BeginDate As Date, _{—}
            ByVal EndDate As Date, _{—}
        Optional ByVal MaxRecords As Integer = 0) As DataSet
```

If a UserID is specified, the method will utilize Raptive Security and only load the data if the UserID (the EntityID of the current user) has been granted access to the Entity.

Here is an example of what these methods would return using our current example:

This method uses the spGetHistoryStandard stored procedure to return the data.
See Also: Activity.ActivityHistory Class,
Activity.ActivityHistory.GetSummaryDataSet Method
ActivityHistory.GetSummaryDataReader Method

The GetSummaryDataReader method returns a SqlDataReader object containing the same data as the method shown above. This is an overloaded method with two signatures:

```
Public Function GetSummaryDataReader(ByVal OrgID As Long, _{—}
            ByVal EntityID As Long, _{—}
            ByVal BeginDate As Date, _{—}
            ByVal EndDate As Date, _{—}
        Optional ByVal MaxRecords As Integer = 0) As DataReader
Public Function GetSummaryDataReader(ByVal OrgID As Long, _{—}
            ByVal EntityID As Long, _{—}
            ByVal UserID As Long, _{—}
            ByVal BeginDate As Date, _{—}
            ByVal EndDate As Date, _{—}
        Optional ByVal MaxRecords As Integer = 0) As DataReader
```

If a UserID is specified, the methods will utilize Raptive Security and only load the data if the UserID (the EntityID of the current user) has been granted access to the Entity. Here is an example of what these methods would return using our current example:

This method uses the spGetHistoryStandard stored procedure to return the data.

See Also Activity.ActivityHistory Class, Activity.ActivityHistory.GetSummaryDataReader Method

Reading the Activity History Detail

The ActivityHistory.GetDetailDataSet Method

The ActivityHistory.GetDetailDataSet method is used to read all of the information for the Activity Entries for a given Entity and Activity Type for a specified date range. The information for each Activity Entry within the specified date range will be returned as System.Data.DataSet object. This is an overloaded method with two signatures:

```
Public Function GetDetailDataSet(ByVal OrgID As Long, _{—}
            ByVal EntityID As Long, _{—}
            ByVal ActivityType As Long, _{—}
            ByVal BeginDate As Date, _{—}
            ByVal EndDate As Date) As DataSet
Public Function GetDetailDataSet(ByVal OrgID As Long, _{—}
            ByVal EntityID As Long, _{—}
            ByVal ActivityType As Long, _{—}
            ByVal UserID As Long, _{—}
            ByVal BeginDate As Date, _{—}
            ByVal EndDate As Date) As DataSet
```

If a UserID is specified, the method will utilize Raptive Security and only load the data if the UserID (the EntityID of the current user) has been granted access to the Entity. Here is an example of what these methods would return using our current example to return a history of all of the Log Expense Activities for our example Employee—Wayne Hammerly Entity:

This method uses the spGetHistoryActivity stored procedure to return the data.
See Also Activity.ActivityHistory Class, Activity.ActivityHistory.GetDetailDataSet Method

The ActivityHistory.GetDetailDataReader Method

The ActivityHistory.GetDetailDataReader method is used to read all of the information for the Activity Entries for a given Entity and Activity Type for a specified date range. The information for each Activity Entry within the specified date range will be returned as System.Data.SqlClient.SqlDataReader object. This is an overloaded method with two signatures:

```
Public Function GetDetailDataSet(ByVal OrgID As Long, _{—}
                ByVal EntityID As Long, _{—}
                ByVal ActivityType As Long, _{—}
                ByVal BeginDate As Date, _{—}
                ByVal EndDate As Date) As DataSet
Public Function GetDetailDataSet(ByVal OrgID As Long, _{—}
                ByVal EntityID As Long, _{—}
                ByVal ActivityType As Long, _{—}
                ByVal UserID As Long, _{—}
                ByVal BeginDate As Date, _{—}
                ByVal EndDate As Date) As DataSet
```

If a UserID is specified, the method will utilize Raptive Security and only load the data if the UserID (the EntityID of the current user) has been granted access to the Entity.

This method uses the spGetHistorActivity stored procedure to return the data.
See Also Activity.ActivityHistory Class, Activity.ActivityHistory.GetDetailDataSet Method

Reading a Specific Activity Entry

The ActivityEntry class provides access to a single Activity Entry. This class will allow you to read all of the information for an entry. This class exposes the following properties:
OrgID
EntityID
ActivityID
EntryID ActivityEntryAttributes

The ActivityEntryAttributes property returns the strongly-type collection containing all of the Activity Entry Attributes.

ActivityEntry.Load Method

The ActivityEntry.Load method is used to load a specified Activity Entry.

```
Public Function Load(ByVal OrgID As Long, _{—}
        ByVal EntityID As Long, _{—}
        ByVal ActivityID As Long, _{—}
        ByVal EntryID As Long) As Boolean
```

Here is an example of reading an Activity Entry. In this example, we will start by loading a summary of the Entity's Activity History into a list box as we saw in the example for the ActivityHistory class:

```
Dim ActivityHistory As New Activity.ActivityHistory
Dim bLoaded As Boolean
bLoaded = ActivityHistory.LoadSummary(OrgID, EntityID, _{—}
                      “1/1/1999”, “9/4/2007”)
If bLoaded Then
    Dim HistoryList As New Activity.HistorySummaryList
    HistoryList = ActivityHistory.HistorySummaryList
    Dim Entry As Activity.ActivityEntrySummary
    ListBox1.DisplayMember = “EntryID”)
    ListBox1.ValueMember = “ActivityName”
    For Each Entry In HistoryList
            ListBox1.Items.Add(Entry)
    Next
End If
```

This code example loads a summary of the Activity Entries into the ListBox1 control. Once the list box is populated, the user can click on any Entry so that we can respond to the user's action via the ListBox1_SelectedIndexChanged event as shown on the next page. Note that both examples assume the module-level variables of mOrgID and mEntityID have been set to the proper values of 577 and 9163 elsewhere in the application.

```
Private Sub ListBox1_SelectedIndexChanged(ByVal sender As
  System.Object, _{—} ByVal e As System.EventArgs) Handles
  ListBox1.SelectedIndexChanged
    Dim Entry As Activity.ActivityEntrySummary
    Entry = ListBox1.Items(ListBox1.SelectedIndex)
    Dim bAttrLoaded As Boolean
    Dim ActivityEntry As New ActivityEntry
    bEntryLoaded = ActivityEntry.Load(mlOrgID, mlEntityID, _{—}
          Entry.ActivityID, Entry.EntryID)
    If bEntryLoaded Then
      Dim Attributes As ActivityEntryAttributeList
      Attributes = ActivityEntry.ActivityEntryAttributes
      Dim Attribute As ActivityEntryAttribute
      For Each Attribute In Attributes
      ‘ListBox2.DisplayMember = “ActivityAttributeDesc”
      ‘ListBox2.ValueMember = “ActivityAttributeType”
      ‘ListBox2.Items.Add(Attribute)
      ListBox2.Items.Add(Attribute.ActivityAttributeDesc & _{—}
        “: ” & Attribute.ActivityAttributeValue)
      Next
    End If
End Sub
```

In this example, we read the ListBox1 control and obtained the instance of the selected item into the Entry object. The next step is to create a new ActivityEntry object and populate (load) it using the ActivityEntry.Load method. We then read the ActivityEntryAttributes property into the Attributes collection and loop through the collection reading each Attribute object in a For Each loop.

There are two ways that we can populate the control for this example. The first is to use the method that is remarked out and shown in green. This loads the entire object into the list box in case we want to edit the Attribute later. The second way (not remarked) shows one possible way to display the name of the Attribute (Attribute.ActivityAttributeDesc) and the Attribute's formatted value (Attribute.ActivityAttributeValue).

We are loading a list box control to keep the examples short. In normal use, you will probably bind to a DataGridView control or use multiple controls for the display of the Attributes.
See Also Activity.ActivityEntry Class, Activity.ActivityEntry.ActivityEntryAtyributeList Class, Activity.ActivityEntryAttribute Class

ActivityEntry.GetEntryDataSet Method

There will be times when it may be easier to work with a System.Data.DataSet object and bind the data to something like a DataGridView control. The GetEntryDataSet method will return a populated DataSet object that makes data binding easy:

```
Public Function GetEntryDataSet(ByVal OrgID As Long, _{—}
                ByVal EntityID As Long, _{—}
                ByVal ActivityID As Long, _{—}
                ByVal EntryID As Long) As DataSet
```

Here is an example of using the ActivityEntry.GetEntryDataSet method:

Dim ActivityEntry As New ActivityEntry
Dim ds As DataSet
ds = ActivityEntry.GetEntryDataSet(OrgID, EntityID, ActivityID,
EntryID)
DataGridView1.DataSource = ds
DataGridView1.DataMember = ds.Tables(0).ToString

And here is what the example above would display using a DataGridView control with no formatting:

This method uses the spGetEntityEntryDetail stored procedure to return the data.
See Also Activity.ActivityEntry Class, Activity.ActivityEntry.GetEntryDataSet Method

ActivityEntry.GetEntryDataReader Method

The GetEntryDataSet method returns a System.Data.SqlClient.SqlDataReader object populated with the Attributes of the Activity Entry.

```
Public Function GetEntryDataReader(ByVal OrgID As Long, _{—}
                ByVal EntityID As Long, _{—}
                ByVal ActivityID As Long, _{—}
                ByVal EntryID As Long) As SqlDataReader
```

Here is an example of loading the object with the Activity Entry:

Dim dr As SqlDataReader
dr = ActivityEntry.GetEntryDataReader(OrgID, EntityID,
ActivityID, EntryID)

This method uses the spGetEntityEntryDetail stored procedure to return the data.
See Also Activity.ActivityEntry Class, Activity.ActivityEntry.GetEntryDataReader Method

### Searching for an Entity via Raptive.Net

In this section we will examine the various classes and methods used to perform basic and common searches or queries of the Raptive database.

Entity.AttributeSearchParameter Class

The Entity.AttributeSearchParameter class is used to specify criteria for multi-criteria (parameter) Entity Attribute searches.

This class inherits the Base.AttributeSearchParameter class and has the following properties:
SearchAttribute
SqlOperator
EntityType
Criteria
Continuation
CategoryType

The SearchAttribute property is the name of the Attribute to search on. For example the “First Name” Attribute.

The SQLOperator property is an enumerated list of supported SQL operators:

```
Public Enum SQLOperators As Integer
    IsEqualTo = 0
    IsNotEqualTo = 1
    IsLike = 2
    IsNotLike = 3
    IsGreaterThan = 4
    IsLessThan = 5
    IsNotLessThan = 6
    IsBetween = 7
    IsNotBetween = 8
End Enum
The Criteria property is the string to search for. SQL wildcards are
supported, for example, Full Time or %Smith%.
The Continuation property is an enumerated list for joining parameters
together using an AND or OR construct:
Public Enum AndOrOperator As Integer
    Logical_AND = 1
    Logical_OR = 2
End Enum
```

The EntityType and CategoryType properties allow you to add these filters to the criteria at the parameter level. Optionally, you may set these values at the execution level.

Entity.EntitySearch Class

The EntitySearch class provides methods to allow you to search by Category Type, by Entity Type, by UniqueID, and by Entity Attributes.

Searching by UniqueID (Entity Name)

These methods will return a list of all of the Entities where the UniqueID matches the specified search criteria. You may also limit the search to return only Entities of a particular Entity Type (Entity Template).

EntitySearch.BuUniqueID Method

The EntitySearch.ByUniqueID method will return a list of all Entities where the UniqueID matches the specified search criteria. The UniqueID is generally the “name” of the Entity so this is basically a name lookup search. The method returns an EntityIDList collection containing EntityID objects. This is an overloaded method with two signatures:

```
Public Function ByUniqueID(ByVal OrgID As Long, _{—}
                ByVal EntityType As Long, _{—}
                ByVal Criteria As String) As EntityIDList
Public Function ByUniqueID(ByVal OrgID As Long, _{—}
                ByVal EntityType As Long, _{—}
                ByVal Criteria As String, _{—}
                ByVal UserID As Long) As EntityIDList
```

If the UserID (the EntityID of the current user) parameter is specified, this method will utilize Raptive Security and will return only those Entities that the user has been granted access.

If the EntityType parameter is set to 0, the ByUniqueID method will return a list of all Entities that match the Criteria parameter, regardless of the EntityType. Generally you will get better results by specifying the EntityType.

The Criteria property defines the string that you are looking for. The method uses the SQL LIKE operator which allows both full and partial matches. You may optionally use the SQL wildcard character (%) in the Criteria parameter. For example: Criteria “% Smith %” will be executed using the SQL construct of @Criteria LIKE ‘% Smith %’ to return all of the Entities that contain “Smith” such as “John Smith”, “Paul Smithfield” etc.

If the Criteria parameter is set to a blank string, and the EntityType parameter is set non-zero, the method will return all Entities of the specified Entity Type.

Here is an example that uses the Raptive Security and populates a list box with the returned Entity list:

```
Dim Search As New EntitySearch
Dim IDList As New EntityIDList
IDList = Search.ByUniqueID(OrgID, EntityType, Criteria, UserID)
Dim EntityID As EntityID
For Each EntityID In IDList
    ListBox1.Items.Add(EntityID.Description & “-” &
    EntityID.UniqueID)
Next
```

EntitySearch.ByUniqueIDDataset Method

The EntitySearch.ByUniqueIDDataSet method will return a list of all Entities where the UniqueID matches the specified search criteria. The method returns a DataSet object containing all of the fields in the Entity table. This is an overloaded method with two signatures:

```
Public Function ByUniqueIDDataSet(ByVal OrgID As Long, _{—}
                ByVal EntityType As Long, _{—}
                ByVal Criteria As String) As DataSet
Public Function ByUniqueIDDataSet(ByVal OrgID As Long, _{—}
                ByVal EntityType As Long, _{—}
                ByVal Criteria As String, _{—}
                ByVal UserID As Long) As DataSet
```

If the UserID (the EntityID of the current user) parameter is specified, this method will utilize Raptive Security and will return only those Entities that the user has been granted access.

If the EntityType parameter is set to 0, the method will return a list of all Entities that match the Criteria parameter, regardless of the EntityType. Generally you will get better results by specifying the EntityType.

The Criteria property defines the string that you are looking for. The method uses the SQL LIKE operator which allows both full and partial matches. You may optionally use the SQL wildcard character (%) in the Criteria parameter. For example: Criteria “% Smith %” will be executed using the SQL construct of @Criteria LIKE ‘% Smith %’ to return all of the Entities that contain “Smith” such as “John Smith”, “Paul Smithfield” etc.

If the Criteria parameter is set to a blank string, and the EntityType parameter is set non-zero, the method will return all Entities of the specified Entity Type.

Here is an example of using the ByUniqueIDDataSet method and loading a DataGridView control:

```
Dim Search As New EntitySearch
Dim ds As DataSet
If lUserID > 0 Then
  ds = Search.ByUniqueIDDataSet(lOrgID, lEntityType, sCriteria,
  lUserID)
Else
  ds = Search.ByUniqueIDDataSet(lOrgID, lEntityType, sCriteria)
End If
DataGridView1.ColumnHeadersDefaultCellStyle.Font = New
Font(“Tahoma”, 8)
DataGridView1.DefaultCellStyle.Font = New Font(“Tahoma”, 8)
DataGridView1.DataSource = ds
DataGridView1.DataMember = ds.Tables(0).ToString
```

EntitySearch.ByuUiqueIDDataReader Method

The EntitySearch.ByUniqueIDDataReader method will return a list of all Entities where the UniqueID matches the specified search criteria. The method returns a SqlDataReader object containing all of the fields in the Entity table. This is an overloaded method with two signatures:

```
Public Function ByUniqueIDDataReader(ByVal OrgID As Long, _{—}
                ByVal EntityType As Long, _{—}
                ByVal Criteria As String) _{—}
                As SqlDataReader
Public Function ByUniqueIDDataReader(ByVal OrgID As Long, _{—}
                ByVal EntityType As Long, _{—}
                ByVal Criteria As String, _{—}
                ByVal UserID As Long) _{—}
                As SqlDataReader
```

The parameters are the same as the EntitySearch.ByUniqueID method.

Searching by Entity Template

There may be times when you want to get a list of all Entities of a particular Entity Type, for example, a list of all Employees or Customers. Here is an easy way to generate such a list:

EntitySearch.ByEntityType Method

The EntitySearch.ByEntityType method will return a list of all Entities of the specified Entity Type (Entity Template). The method returns an EntityIDList collection containing EntityID objects. This is an overloaded method with two signatures:

```
Public Function ByEntityType(ByVal OrgID As Long, _{—}
            ByVal EntityType As Long) As EntityIDList
Public Function ByEntityType(ByVal OrgID As Long, _{—}
            ByVal EntityType As Long, _{—}
            ByVal UserID As Long) As EntityIDList
```

If the optional UserID parameter is specified, the method will utilize Raptive Security and only return Entities that the UserID (the EntityID of the current user) has been granted access to the Entity.

Here is an example that loads a list box control with the fully-qualified name of each Entity in the list:

```
Dim Search As New EntitySearch
Dim IDList As New EntityIDList
IDList = Search.ByEntityType(lOrgID, lEntityType)
Dim EntityID As EntityID
For Each EntityID In IDList
    ListBox1.Items.Add(EntityID.Description & “-” &
    EntityID.UniqueID)
Next
```

EntitySearch.ByEntityTypeDataSet Method

The EntitySearch.ByEntityTypeDataSet method will return a list of all Entities of the specified Entity Type (Entity Template). The method returns a DataSet containing all of the fields of the Entity table. This is an overloaded method with two signatures:

```
Public Function ByEntityTypeDataSet(ByVal OrgID As Long, _{—}
                ByVal EntityType As Long) As DataSet
Public Function ByEntityTypeDataSet(ByVal OrgID As Long, _{—}
                ByVal EntityType As Long, _{—}
                ByVal UserID As Long) As DataSet
```

If the optional UserID parameter is specified, the method will utilize Raptive Security and only return Entities that the UserID (the EntityID of the current user) has been granted access to the Entity.

EntitySearch.ByEntityTypeDataReader Method

The EntitySearch.ByEntityTypeDataReader method will return a list of all Entities of the specified Entity Type (Entity Template). The method returns an SqlDataReader object containing all of the fields of the Entity table. This is an overloaded method with two signatures:

```
Public Function ByEntityTypeDataReader(ByVal OrgID As Long, _{—}
                ByVal EntityType As Long) _{—}
                As SqlDataReader
Public Function ByEntityTypeDataReader(ByVal OrgID As Long, _{—}
                ByVal EntityType As Long, _{—}
                ByVal UserID As Long) _{—}
                As SqlDataReader
```

Searching by Category Type

As we examined in earlier sections of this manual, all Entity Templates are based on a CategoryType such as an Org Entity, User Entity, Report Entity, and so on. The methods examined in this section allow you to limit the returned Entities by their Category Type.

EntitySearch.ByCategoryType METHOD

The EntitySearch.ByCategoryType method will return a list of all Entities of the specified Entity Type (Entity Template). The method returns an EntityIDList collection containing EntityID objects. This is an overloaded method with two signatures:

```
Public Function ByCategoryType(ByVal OrgID As Long, _{—}
            ByVal CategoryType As Long) As EntityIDList
Public Function ByCategoryType(ByVal OrgID As Long, _{—}
            ByVal CategoryType As Long,_{—}
            ByVal UserID As Long) As EntityIDList
```

If the optional UserID parameter is specified, the method will utilize Raptive Security and only return Entities that the UserID (the EntityID of the current user) has been granted access to the Entity.

Here is an example that loads a list box control with the fully-qualified name of each Entity in the list:

```
Dim Search As New EntitySearch
Dim IDList As New EntityIDList
IDList = Search.ByCategoryType(lOrgID, lCategoryType)
Dim EntityID As EntityID
For Each EntityID In IDList
    ListBox1.Items.Add(EntityID.Description &
    “-” & EntityID.UniqueID)
Next
```

EntitySearch.ByCategoryTypeDataset Method

The EntitySearch.ByCategoryTypeDataSet method will return a list of all Entities of the specified Entity Type (Entity Template). The method returns a DataSet containing all of the fields of the Entity table. This is an overloaded method with two signatures:

```
Public Function ByCategoryTypeDataSet(ByVal OrgID As Long, _{—}
                      ByVal CategoryType As Long) As DataSet
Public Function ByCategoryTypeDataSet(ByVal OrgID As Long, _{—}
                      ByVal CategoryType As Long, _{—}
                      ByVal UserID As Long) As DataSet
```

If the optional UserID parameter is specified, the method will utilize Raptive Security and only return Entities that the UseriD (the EntityID of the current user) has been granted access to the Entity.

EntitySearch.ByCategoryTypeDataReader Method

The EntitySearch.ByCategoryTypeDataReader method will return a list of all Entities of the specified Entity Type (Entity Template). The method returns a SqlDataReader object containing all of the fields of the Entity table. This is an overloaded method with two signatures:

```
Public Function ByCategoryTypeDataReader(ByVal OrgID As Long, _{—}
                        ByVal CategoryType As Long) _{—}
                        As SqlDataReader
Public Function ByCategoryTypeDataReader(ByVal OrgID As Long, _{—}
                        ByVal CategoryType As Long, _{—}
                        ByVal UserID As Long) _{—}
                        As SqlDataReader
```

See Also Entity.EntitySearch Class, Entity.EntityIDList Class, Entity.EntityID Class

Searching on Entity Attributes—Single Parameter

The EntitySearch class provides two different means of searching Entity Attribute data. In this section we will examine the methods used to search on a single Attribute. In the next section, we examine the classes and methods used to create complex searches that use multiple parameters.

EntitySearch.ByAttribute Method

The EntitySearch.ByAttribute method will return a list of all Entities matching the specified search criteria. The criteria will consist of one specified Entity Attribute and a corresponding value to match. The method returns an EntityIDList collection containing EntityID objects. This is an overloaded method with two signatures:

```
Public Function ByAttribute(ByVal OrgID As Long, _{—}
                          ByVal EntityType As Long, _{—}
                          ByVal CategoryType As Long, _{—}
                          ByVal Attribute As String, _{—}
                          ByVal Criteria As String) As EntityIDList
Public Function ByAttribute(ByVal OrgID As Long, _{—}
                          ByVal EntityType As Long, _{—}
                          ByVal CategoryType As Long, _{—}
                          ByVal Attribute As String, _{—}
                          ByVal Criteria As String, _{—}
                          ByVal UserID As Long) As EntityIDList
```

If the UserID (the EntityID of the current user) parameter is specified, this method will utilize Raptive Security and will return only those Entities that the user has been granted access. If the EntityType parameter is set to 0, the ByUniqueID method will return a list of all Entities that match the Criteria parameter, regardless of the EntityType. Generally you will get better results by specifying the EntityType. If the CategoryType parameter is set to a value other than 0, the result set will be limited to Entities of the specified CategoryType. You should set either the EntityType parameter or the CategoryType parameter, but not both since specifying a single parameter negates the need for a specified Category Type.

The Attribute property is the name (AttributeDesc field) of the Attribute you wish to search. This value can be found using any of the Entity Template classes or methods. The Criteria property defines the string that you are looking for. The method uses the SQL LIKE operator which allows both full and partial matches. You may optionally use the SQL wildcard character (%) in the Criteria parameter. For example: Criteria=“& Smith %” will be executed using the SQL construct of @Criteria LIKE ‘% Smith %’ to return all of the Entities that contain “Smith” such as “John Smith”, “Paul Smithfield” etc.

If the Criteria parameter is set to a blank string, and either the EntityType parameter or the CategoryType parameter is set non-zero, the method will return all Entities of the specified Entity Type or Category Type.

Here is an example of using the method to find all of the Employees (EntityType=104) that are full time employees:

```
Dim EntityType As Long = 104
Dim CategoryType As Long = 0
Dim Attribute As String = “Employee Type”
Dim Criteria As String = “Full Time”
Dim IDList As EntityIDList
Dim Search As New EntitySearch
IDList = Search.ByAttribute(OrgID, EntityType, CategoryType,_{—}
                            Attribute, Criteria)
Dim EntityID As EntityID
For Each EntityID In IDList
    ListBox1.Items.Add(EntityID.Description & “ ... ” &
    EntityID.UniqueID)
Next
```

EntitySearch.ByAttributeDataSet Method

The EntitySearch.ByAttributeDataSet method will return a list of all Entities matching the specified search criteria. The criteria will consist of one specified Entity Attribute and a corresponding value to match. The method returns a DataSet object. This is an overloaded method with two signatures:

```
Public Function ByAttributeDataSet(ByVal OrgID As Long, _{—}
                              Byval EntityType As Long, _{—}
                              ByVal CategoryType As Long, _{—}
                              ByVal Attribute As String,
                              ByVal Criteria As String) As DataSet
Public Function ByAttributeDataSet(ByVal OrgID As Long, _{—}
                              ByVal EntityType As Long, _{—}
                              ByVal CategoryType As Long, _{—}
                              ByVal Attribute As String, _{—}
                              ByVal Criteria As String,
                              ByVal UserID As Long) As DataSet
```

This method has the same parameters as the ByAttribute method.

See Also Entity.EntitySearch Class, Entity.EntityIDList Class, Entity.EntityID Class

EntitySearch.ByAttributDataReader Method

The EntitySearch. ByAttributeDataReader method will return a list of all Entities matching the specified search criteria. The criteria will consist of one specified Entity Attribute and a corresponding value to match. The method returns a SqlDataReader object. This is an overloaded method with two signatures:

```
Public Function ByAttributeDataReader(ByVal OrgID As Long, _{—}
                                ByVal EntityType As Long, _{—}
                                ByVal CategoryType As Long, _{—}
                                ByVal Attribute As String,
                                ByVal Criteria As String) _{—}
                                As SqlDataReader
Public Function ByAttributeDataReader(ByVal OrgID As Long, _{—}
                                ByVal EntityType As Long, _{—}
                                ByVal CategoryType As Long, _{—}
                                ByVal Attribute As String, _{—}
                                ByVal Criteria As String,
                                ByVal UserID As Long) _{—}
                                As SqlDataReader
```

This method has the same parameters as the ByAttribute method.

Searching On Entity Attributes—Multiple Parameters
EntitySearch.ByAttribute Method

EntitySearch.AddParameter Method

The AddParameter method is used to add multiple parameters to a search.

Public Sub AddParameter(ByVal SearchParameter As
AttributeSearchParameter)
maSearchParameters.Add(SearchParameter)
End Sub

Here is an example that sets two parameters using a logical to return all of the Employees (EntityType 104) who are full time Sales Agents:

```
Dim EntitySearch As New EntitySearch
Dim Parameter1 As New AttributeSearchParameter(“Title”,
                        Enums.SQLOperators.IsLike, _{—}
                        “Sales Agent”, _{—}
                        Enums.AndOrOperator.Logical_AND)
Parameter1.EntityType = 104
EntitySearch.AddParameter(Parameter1)
Dim Parameter2 As New AttributeSearchParameter(“Employee Type”, _{—}
                        Enums.SQLOperators.IsLike, _{—}
                        “Full Time”)
Parameter2.EntityType = 104
EntitySearch.AddParameter(Parameter2)
```

For this example, we are setting two parameters and defining the EntityType criteria at the parameter level for each. This is handy when you want to use a logical Logical_OR and set different EntityType values for each parameter for example when searching for Employees or Contractors. Optionally we could set the EntityType criteria at the Execute level to span all parameters. Note that if you set the EntityType criteria at the parameter level, specify a value of 0 at the Execute level to avoid conflicts. Now that we have seen how to set multiple search criteria (parameters), let's examine the various methods that use these parameters.

EntitySearch.Execute Method

```
Public Function Execute(ByVal OrgID As Long, _{—}
              Optional ByVal EntityType As Long = 0, _{—}
              Optional ByVal CategoryType As Long = 0, _{—}
              Optional ByVal UserID As Long = 0) _{—}
              As EntityIDList
```

The Execute method will execute the parameterized search and return a collection of Entity IDs in the standard EntityIDList collection. The OrgID parameter is the only required parameter—the rest are optional. You may optionally specify an EntityType or CategoryType parameter that will apply to the overall query. For example, if you specify an EntityType of 104 (Employee in our examples), the query will filter the result set and return only Entities based on the Employee Entity Template. Note that if you specify an EntityType or a CategoryType as one or more of the parameters, you should set EntityType or CategoryType to 0 here to avoid logic conflicts.

If the UserID (the EntityID of the current user) parameter is specified, this method will utilize Raptive Security and will return only those Entities that the user has been granted access. Note that if you specify the UserID parameter you must set the preceding parameters to 0 or the value you require. Here is an example that will return and display a parameterized search using Raptive Security:

```
Dim EntitySearch As New EntitySearch
Dim Parameter1 As New AttributeSearchParameter(“Title”,
                        Enums.SQLOperators.IsLike, _{—}
                        “Sales Agent”, _{—}
                        Enums.AndOrOperator.Logical_AND)
Parameter1.EntityType = 104
EntitySearch.AddParameter(Parameter1)
Dim Parameter2 As New AttributeSearchParameter(“Employee Type”, _{—}
                          Enums.SQLOperators.IsLike, _{—}
                          “Full Time”)
Parameter2.EntityType = 104
EntitySearch.AddParameter(Parameter2)
  Dim IDList As EntityIDList
IDList = EntitySearch.Execute(OrgID, 0, 0, UserID)
Dim EntityID As EntityID
For Each EntityID In IDList
  ListBox1.Items.Add(EntityID.Description & “-” & EntityID.UniqueID)
Next
```

EntitySearch.ExecuteDataSet Method

The ExecuteDataSet method will execute the parameterized search and return a collection of Entity IDs in a DataSet.

```
Public Function ExecuteDataSet(ByVal OrgID As Long, _{—}
                  Optional ByVal EntityType As Long = 0, _{—}
                  Optional ByVal CategoryType As Long = 0, _{—}
                  Optional ByVal UserID As Long = 0) As DataSet
```

This method has the same parameters as the Execute method. The DataSet will contain all of the information in the Entity table for each returned Entity.

EntitySearch.ExecuteDataReader Method

The ExecuteDataReader method will execute the parameterized search and return a collection of Entity IDs in a SqlDataReader.

```
Public Function ExecuteDataReader(ByVal OrgID As Long, _{—}
                    Optional ByVal EntityType As Long = 0, _{—}
                    Optional ByVal CategoryType As Long = 0, _{—}
                    Optional ByVal UserID As Long = 0) _{—}
                    As SqlDataReader
```

This method has the same parameters as the Execute method. The SqlDataReader will contain all of the information in the Entity table for each returned Entity.
See Also Entity.EntitySearch Class, Entity.EntityIDList Class, Entity.EntityID Class

Searching by Entity Addresses

Entity.AddressSearch Class

Searching for an Entity (Customer, Employee, Vendor, etc.) on some part of their address is a fairly common task. The Entity.AddressSearch class provides just this type of search functionality.

AddressSearch.AddParameter Method

The method is used to add parameters to the search query:

### Public Sub AddParameter(ByVal SearchParameter As AddressSearchParameter)

The first step in searching (querying) for an Entity or a list of Entities on some Address criteria is to use the AddressSearchParameter class to set one or more parameters of your search criteria. Each instance of AddressSearchParameter will contain one search parameter such as State < > CA or PostCode=92660 or RecipientName Like % Smith %. You may define multiple parameters using logical AND and OR constructs.

The New constructor may be used to set the first parameter:

```
Public Sub New(Optional ByVal AddressField As AddressFields, _{—}
          Optional ByVal SQLOperator As SQLOperators, _{—}
          Optional ByVal Criteria As String, _{—}
          Optional ByVal Continuation As AndOrOperator)
```

The AddressField, SQLOperator, and Continuation parameters have Enums and Visual Studio's IntelliSense feature will allow you to select the correct values for these parameters. The AddressField parameter defines the field in the Address table to use for the criteria. The enumerated choices are:

```
Public Enum AddressFields
    RecipientName = 1
    Addr1 = 2
    Addr2 = 3
    Addr3 = 4
    City = 5
    State = 6
    PostCode = 7
    Country = 8
    Note = 9
End Enum
```

The SQLOperator parameter defines the SQL operator used to make up the query. The enumerated choices are:

```
Public Enum SQLOperators As Integer
    IsEqualTo = 0
    IsNotEqualTo = 1
    IsLike = 2
    IsNotLike = 3
    IsGreaterThan = 4
    IsLessThan = 5
    IsNotLessThan = 6
    IsBetween = 7
    IsNotBetween = 8
End Enum
```

The Criteria parameter defines the search criteria that you will fill in as a string. To find all of the Entities in the State of California (State=CA) you would specify:

Dim Parameter As New _{—}
AddressSearchParameter(AddressSearchParameter.AddressFields.State,_{—}
Enums.SQLOperators.IsEqualTo, “CA”)

To find all of the Entities in the zip code of 92660 (Postcode=92660) you would specify:

Dim Parameter As New _{—}
AddressSearchParameter(AddressSearchParameter.AddressFields.
PostCode,_ Enums.SQLOperators.IsEqualTo, “CA”)

The optional Continuation parameter is used to string multiple parameters together using logical AND and OR constructs. For example to find all of the Entities in either California or New York by adding the optional Continuation parameter set to .Logical_OR:

```
Dim Parameter As New _{—}
AddressSearchParameter(AddressSearchParameter.AddressFields.State, _{—}
              Enums.SQLOperators.IsEqualTo, “CA”, _{—}
              Enums.AndOrOperator.Logical_OR)
Dim Parameter1 As New _{—}
AddressSearchParameter(AddressSearchParameter.AddressFields.State, _{—}
              Enums.SQLOperators.IsEqualTo, “NY”)
```

You may also set the parameters using the properties of the class:

```
Dim Parameter As New AddressSearchParameter
With Parameter
    .RecipientName = “%Hammerly%”
    .SQLOperators = Enums.SQLOperators.IsLike
End With
```

AddressSearch.Execute Method

Once the search parameters have been specified, the search is query run by calling the Execute method. This is an overloaded method with three signatures:

```
Public Function Execute(ByVal OrgID As Long) As EntityIDList
Public Function Execute(ByVal OrgID As Long, _{—}
              ByVal EntityType As Long) As EntityIDList
Public Function Execute(ByVal OrgID As Long, _{—}
              ByVal EntityType As Long, _{—}
              ByVal AddressType As Long) As EntityIDList
```

The optional EntityType and AddressType parameters allow you to narrow the search to return only matching Entities of a specified Entity Type (Entity Template) and a specified Address Type. Optionally, you may set the EntityType and/or the AddressType parameters via the class's properties. For example:
Search.AddressType=2

Here is an example of setting a search query to get a list of all Entities where the State is either California (CA) or Washington (WA) and display the results in a list box:

```
Dim Parameter As New _{—}
AddressSearchParameter(AddressSearchParameter.AddressFields.State, _{—}
              Enums.SQLOperators.IsEqualTo, “CA”, _{—}
              Enums.AndOrOperator.Logical_OR)
Dim Parameter1 As New _{—}
AddressSearchParameter(AddressSearchParameter.AddressFields.State, _{—}
              Enums.SQLOperators.IsEqualTo, “NY”)
Dim Search As New AddressSearch( )
Search.AddParameter(Parameter)
Search.AddParameter(Parameter1)
Dim IDList As EntityIDList
IDList = Search.Execute(OrgID)
Dim EntityID As New EntityID
For Each EntityID In IDList
    ListBox1.Items.Add(EntityID.Description &
    “ - ” & EntityID.UniqueID)
Next
```

See Also Entity.AddressSearch Class, Entity.AddressSearchParameter Class,
Entity.EntityID Class

AddressSearch.GetDataSet Method

Once the search parameters have been specified using the Search.AddParameter method the GetDataSet method can be called to return a System.Data.DataSet object. This can be handy when binding to controls. This is an overloaded method with three signatures:

```
Public Function GetDataSet(ByVal OrgID As Long) As DataSet
Public Function GetDataSet(ByVal OrgID As Long, _{—}
                ByVal EntityType As Long) As DataSet
Public Function GetDataSet(ByVal OrgID As Long, _{—}
                ByVal EntityType As Long, _{—}
                ByVal AddressType As Long) As DataSet
```

This will return a DataSet object with the same fields as the Entity.EntityID class.

Dim ds As DataSet
ds = Search.GetDataSet(OrgID)

Once the search parameters have been specified using the Search.AddParameter method the GetDataReader method can be called to return a SqlDataReader object. This is an overloaded method with three signatures:

```
Public Function GetDataReader(ByVal OrgID As Long) As DataReader
Public Function GetDataReader(ByVal OrgID As Long, _{—}
                ByVal EntityType As Long) As DataReader
Public Function GetDataReader(ByVal OrgID As Long, _{—}
                ByVal EntityType As Long, _{—}
                ByVal AddressType As Long) As DataReader
```

This will return a System.Data.SqlClient.SqlDataReader object with the same fields as the Entity.EntityID class:

Dim dr As SqlDataReader
dr = Search.GetDataReader(OrgID)

See Also Entity.AddressSearch Class, Entity.AddressSearchParameter Class, Entity.EntityID Class

Searching by Entity Phones/Electronic Addresses

Entity.PhoneSearch Class

The class works just like the AddressSearch class we examined in the last section.

PhoneSearch.AddParameter Method

The AddParameter method is used to add parameters to the search query:

### Public Sub AddParameter(ByVal SearchParameter As AddressSearchParameter)

The first step in searching (querying) for an Entity or a list of Entities on the Phone criteria is to use the PhoneSearchParameter class to set the parameters of your search criteria. The New constructor may be used to set the first parameter:

Public Sub New(Optional ByVal PhoneField As PhoneFields = 0, _{—}

Optional ByVal SQLOperator As SQLOperators = 0, _{—}
Optional ByVal Criteria As String = “”, _{—}
Optional ByVal Continuation As AndOrOperator = 0)

The PhoneField, SQLOperator, and Continuation parameters have Enums and Visual Studio's IntelliSense feature will allow you to select the correct values for these parameters. The PhoneField parameter defines the field in the EntityPhone table to use for the criteria:

```
Public Enum PhoneFields
    PhoneValue = 1
    Note = 2
End Enum
```

The SQLOperator parameter defines the SQL operator used to make up the query. The enumerated choices are:

```
Public Enum SQLOperators As Integer
    IsEqualTo = 0
    IsNotEqualTo = 1
    IsLike = 2
    IsNotLike = 3
    IsGreaterThan = 4
    IsLessThan = 5
    IsNotLessThan = 6
    IsBetween = 7
    IsNotBetween = 8
End Enum
```

The Criteria parameter defines the search criteria that you will fill in as a string.

PhoneSearch.Execute Method

Once the search parameters have been specified, the search query run by calling the Execute method. This is an overloaded method with three signatures:

```
Public Function Execute(ByVal OrgID As Long) As EntityIDList
Public Function Execute(ByVal OrgID As Long, _{—}
                ByVal EntityType As Long) As EntityIDList
Public Function Execute(ByVal OrgID As Long, _{—}
                ByVal EntityType As Long, _{—}
                ByVal PhoneType As Long) As EntityIDList
```

The optional EntityType and PhoneType parameters allow you to narrow the search to return only matching Entities of a specified Entity Type (Entity Template) and a specified Phone Type. Optionally, you may set the EntityType and/or the PhoneType parameters via the class's properties. For example:
Search.EntityType=104

Here is an example that finds all of the Entities with a phone number in Area Code 949 and loads the Entities into a list box:

```
Dim Parameter As New _{—}
PhoneSearchParameter(PhoneSearchParameter.PhoneFields.PhoneValue,
        _{—} Enums.SQLOperators.IsLike, “949%”)
Dim Search As New PhoneSearch( )
Search.AddParameter(Parameter)
Dim IDList As EntityIDList
IDList = Search.Execute(577)
If IDList.Count > 0 Then
  Dim EntityID As New EntityID
    For Each EntityID In IDList
      ListBox2.Items.Add(EntityID.Description & “ - ” &
      EntityID.UniqueID)
  Next
End If
```

This class returns the same EntityID collection as the PhoneSearch class.
See Also Entity.PhoneSearch Class, Entity.PhoneSearchParameter Class, Entity.EntityID Class

### PhoneSearch.GetDataSet Method

Once the search parameters have been specified using the Search.AddParameter method the GetDataSet method can be called to return a System.Data.DataSet object. This can be handy when binding to controls. This is an overloaded method with three signatures:

```
Public Function GetDataSet(ByVal OrgID As Long) As DataSet
Public Function GetDataSet(ByVal OrgID As Long, _{—}
                ByVal EntityType As Long) As DataSet
Public Function GetDataSet(ByVal OrgID As Long, _{—}
                ByVal EntityType As Long, _{—}
                ByVal AddressType As Long) As DataSet
```

This will return a DataSet object with the same fields as the Entity.EntityID class:

Dim ds As DataSet
ds = Search.GetDataSet(OrgID)

PhoneSearch.GetDataReader Method

Once the search parameters have been specified using the Search.AddParameter method the GetDataReader method can be called to return a SqlDataReader object. This is an overloaded method with three signatures:

```
Public Function GetDataReader(ByVal OrgID As Long) As DataReader
Public Function GetDataReader(ByVal OrgID As Long, _{—}
                ByVal EntityType As Long) As DataReader
Public Function GetDataReader(ByVal OrgID As Long, _{—}
                ByVal EntityType As Long, _{—}
                ByVal AddressType As Long) As DataReader
```

This will return a System.Data.SqlClient.SqlDataReader object with the same fields as

the Entity.EntityID class:

Dim dr As SqlDataReader
dr = Search.GetDataReader(OrgID)

See Also Entity.PhoneSearch Class, Entity.PhoneSearchParameter Class, Entity.EntityID Class

Searching Activity Entry Data via Raptive.Net

Activity.ActivityAttributeSearchParameter Class

The Activity.ActivityAttributeSearchParameter class is used to specify criteria for multi-criteria (parameter) Activity Attribute searches. This class inherits from the Entity.AttributeSearchParameter class which is used to search on Entity Attributes. This class has the following properties:
Criteria
SqlOperator
EntryEntityID
ActivityType
SearchField
Continuation
BeginDate
EndDate

The first four are the same properties found in the Entity.AttributeSearchParameter class and are used the same way.

The EntryEntityID property is the ID of the user Entity that originally entered the Attribute.

The ActivityType property is used to limit the results to a specified Activity Type. The BeginDate and EndDate properties are used to set and optional date range filter to the parameter.

Activity.ActivitySearch Class

The Activity.ActivitySearch class provides a number of methods to allow you to search Activity Attributes and return Entity IDs, Activity Entry IDs, or entire Activity Entry records.

Returning Entity IDs—a Single Parameter ACTIVITYSEARCH.BYATTRIBUTE Method

The ByAttribute method allows you to quickly set and execute single parameter search and return a list of all of the Entities who have made entries matching the specified search criteria. This is an overloaded method with two signatures:

Public Function ByAttribute(ByVal OrgID As Long, _{—}

ByVal EntityID As Long, _{—}
ByVal EntityType As Long, _{—}
ByVal Attribute As String, _{—}
ByVal Criteria As String) As EntityIDList

Public Function ByAttribute(ByVal OrgID As Long, _{—}

ByVal EntityID As Long, _{—}
ByVal EntityType As Long, _{—}
ByVal Attribute As String, _{—}
ByVal Criteria As String, _{—}

ByVal UserID As Long) As EntityIDList

The EntityID and EntityType parameters allow you to set option filters to filter by EntityID and/or Entity Type as desired. Set the parameter to 0 if you do not want to utilize the filter. Note that you can create invalid criteria which return no results if you use conflicting filters such as specifying an EntityID with an incorrect EntityType. If the UserID (the EntityID of the current user) parameter is specified, this method will utilize Raptive Security and will return only those Entities that the user has been granted access. Here is an example that will search for an Attribute with the name “Activity Type” and containing a value of “Design”. The method will return a standard collection:

```
Attribute = “Activity Type”
Criteria = “Design”
Dim Search As New ActivitySearch
  Dim IDList As EntityIDList
IDList = Search.ByAttribute(OrgID, 0, 0, 0, Attribute, Criteria)
Dim EntityID As EntityID
For Each EntityID In IDList
    ListBox1.Items.Add(EntityID.Description & “ - ” &
    EntityID.UniqueID)
Next
```

Note that the EntityID, EntityType, and ActivityType parameters are all set to 0 since we did not want to use any of these filters for this particular query.

ActivitySearcy.ByAttributeDataSet Method

The ByAttributeDataSet method will return a list of all Entities matching the specified search criteria. The criteria will consist of one specified Activity Attribute and a corresponding value to match. The method returns a DataSet object. This is an overloaded method with two signatures:

Public Function ByAttributeDataSet(ByVal OrgID As Long, _{—}

ByVal EntityID As Long, _{—}
ByVal EntityType As Long, _{—}
ByVal Attribute As String, _{—}
ByVal Criteria As String) As DataSet

Public Function ByAttributeDataSet(ByVal OrgID As Long, _{—}

ByVal EntityID As Long, _{—}
ByVal EntityType As Long, _{—}
ByVal Attribute As String, _{—}
ByVal Criteria As String, _{—}
ByVal UserID AS Long) As DataSet

This method has the same parameters as the ByAttribute method and will return the same results as a DataSet.

ActivitySearch.ByAttributeDataReader Method

The ByAttributeDataReader method will return a list of all Entities matching the specified search criteria. The criteria will consist of one specified Activity Attribute and a corresponding value to match. The method returns a SqlDataReader object. This is an overloaded method with two signatures:

Public Function ByAttributeDataReader(ByVal OrgID As Long, _{—}

ByVal EntityID As Long, _{—}
ByVal EntityType As Long, _{—}
ByVal Attribute As String, _{—}

ByVal Criteria As String) As SqlDataReader

Public Function ByAttributeDataReader(ByVal OrgID As Long, _{—}

ByVal EntityID As Long, _{—}
ByVal EntityType As Long, _{—}
ByVal Attribute As String, _{—}
ByVal Criteria As String, _{—}
ByVal UserID As Long) As SqlDataReader

This method has the same parameters as the ByAttribute method and will return the same results as a SqlDataReader.

Returning Activity Entry IDs—a Single Parameter
ACTIVITYSEARCH.ADDPARAMETER METHOD
ACTIVITYSEARCH.GETENTITYID METHOD
ACTIVITYSEARCH.GETENTITYIDDATASET METHOD
ACTIVITYSEARCH.GETENTITYIDDATAREADER METHOD

Returning Activity Entry IDs—Multiple Search Parameters
ACTIVITYSEARCH.GETENTRYIDD METHOD
ACTIVITYSEARCH.GETENTRYIDDATASET METHOD
ACTIVITYSEARCH.GETENTRYIDDATAREADER METHOD

### Raptive.Net Entities and Inheritance

Working with Web Entities

Working with DMS Entities
Working with Report Entities
Working with Data Bin Entities
Working with KMS Entities

### Reading Entity Data Via SQL

We will start with the stored procedures that are used to read Entities. Most user interfaces perform many more reads than writes, and when developing an application in Raptive, you can easily create the first set of test Entities using the Raptive UI/IDE.

### Reading Entity Data via SQL—Secured

These stored procedures include the words “EntityAccess” in the name and will only include Entities that the user has been expressly granted permission to access:

spGetEntityAccessByType

This procedure returns all of the Entities that the user may access.

ALTER Procedure [dbo].[spGetEntityAccessByType](
@OrgID int,
@EntityID int)

The parameters are the OrgID and the user's EntityID. Thus to see all of the Entities that the user (9163) may access we would do:

In this example the Entity 9163 (which is the current user for these examples) can see the following Entities. We can see each Entity's ID (in the TargetEntityID field) as well as the AccessType (the permission level) and the CategoryType for the Target Entity. This provides the basic information you will typically use for a list of Entities that the user is permitted to view.

sPGetEntityAccessParentTree

This is the stored procedure that we use to populate the tree in the Raptive UI/IDE. It is quite similar to the spGetEntityAccessByType procedure above, but returns slightly different information including Parent/Child relationships so that it can be easily used by a tree.

spGetEntityAccessParentTree 577, 9144

Here is an example of the returned result:

The actual result contains 44 rows but we are only showing the first 12 here for readability and to convey the idea. The result set includes all of the information that is required for a tree view, including the ParentID and the path to the Tree Image that appears in the Raptive Tree.

### Building a Raptive Tree

The EntityID, EntityType, and EntityTypeDescription fields come from the Entity table and we have covered these values a number of times. The EntityName field is a concatenation of the EntityTypeDescription and UniqueID fields found in the Entity table. We use this format for the tree and concatenating these two fields in the stored procedure is more efficient than doing it in the UI.

The ImageName field comes from the TreeImage table that we have not yet examined. It contains the path and file name of the image file that the tree will use as an icon for the Entity. These icons are assigned and managed via the Raptive UI/IDE. The ParentID field is the key field for creating a tree. This data originates in the EntityParent table that we have not yet examined in detail. For now, suffice to say that each Entity in Raptive can have zero or more Parents. In this particular example, each Entity has only one Parent so there is only one row per Entity. If an Entity had multiple parents, it would appear multiple times in the result set, each with a different ParentID value.

Parent/Child relationships are typically set in the Raptive UI/IDE using the Set Parent button on the Entity's Attributes page. Naturally, this can be set via code as well. For now, we'll limit our discussion of Parent/Child relationships to how they work with this particular stored procedure and the tree. Note that there are a number of Entities with a ParentID of NULL. This indicates that the Entity should appear on the root of the tree:

If the ParentID field is not null, it will contain the EntityID of the parent Entity. We can use a feature of ADO.Net to organize this data into the proper form for a tree:

```
Dim sSQL s String
sSQL = “spGetEntityAccessParentTree ” & mOrgID.ToString & _{—}
  “,” & mlUserID.ToString
Dim adapter As New SqlDataAdapter(sSQL, dbCon)
Dim ds As New System.Data.Dataset( )
adapter.Fill(ds)
ds.EnforceConstraints = False
ds.Relations.Add(“NodeRelation”, ds.Tables(0).Columns(“EntityID”),
      ds.Tables(0).Columns(“ParentID”))
```

Note that the Relations.Add line is actually one physical line.

We can then populate the tree using VB.Net code such as this:

```
        Dim dbRow As System.Data.DataRow
    For Each dbRow In ds.Tables(0).Rows
      If (dbRow.IsNull(“ParentID”)) Then
        EntityID = dbRow(“EntityID”.ToString)
      EntityType = dbRow(“EntityType”.ToString)
        sEntityName = dbRow(“EntityName”.Trim.ToString)
        sImageName = “”
        If Not DBNull.Value.Equals(dbRow(“ImageName”)) Then
          sImageName = Replace(dbRow(“ImageName”.Trim.ToString), “/”, “\”)
        End If
        Dim newNode As ComponentArt.Web.UI.TreeViewNode
        newNode = CreateNode(sEntityName, sImageName, False)
      Dim sNavUrl = “SomePage.asp?EntityID=” & EntityID & _{—}
            “& View=LeftNav&EntityName=” & sEntityTypeDescription
      newNode.Target = “text”
      newNode.NavigateUrl = sNavUrl ’ handle the frames and append sNavUrl
          newNode.Value = mEntityID
        TreeView.Nodes.Add(newNode)
        PopulateSubTree(dbRow, newNode)
      End If
      Next dbRow
  Private Function CreateNode(ByVal text As String, ByVal imageurl As String
          ByVal expanded As Boolean) As ComponentArt.Web.UI.TreeViewNode
    Dim node As New ComponentArt.Web.UI.TreeViewNode( )
    node.Text = text
    node.ImageUrl = imageurl
    node.Expanded = expanded
      Return node
  End Function
  Private Sub PopulateSubTree(ByVal dbRow As System.Data.DataRow,
                ByVal node As ComponentArt.Web.UI.TreeViewNode)
          Dim childRow As System.Data.DataRow
          Dim EntityID As Long
          Dim sEntityName As String
          Dim sEntityTypeDescription As String
          Dim sImageName As String
          For Each childRow In dbRow.GetChildRows(“NodeRelation”)
            EntityID = childRow(“EntityID”.ToString)
            sEntityName = childRow(“EntityName”.Trim.ToString)
            sImageName = “”
            If Not DBNull.Value.Equals(childRow(“ImageName”)) Then
              sImageName = Replace(childRow(“ImageName”.Trim.ToString), “/”, “\”)
            End If
            Dim childNode As ComponentArt.Web.UI.TreeViewNode =
            CreateNode(sEntityName.ToString, “”, False)
            childNode.Value = mEntityID
            node.Nodes.Add(childNode)
            PopulateSubTree(childRow, childNode
          Next childRow
End Sub
```

This example gets the basic idea across. You'll modify your code to meet the requirements of the tree control or list control that you will use to display the information. The end result is a tree that looks something like this:

Note: The complete code for the tree used in the Raptive UI/IDE can be found in the folder \Raptive\Entry\Controls and the files NavBar.aspx and NavBar.aspx.vb. Raptive's Parent/Child relationships are especially well-suited to using a tree view. In this example we are using a commercially available tree control from Component Art (www.componentart.com) but almost any tree or list control can be used in much the same manner.

The basic idea here is to present the user only those Entities that the user has permissions to see. From that point on, we can use the EntityID supplied when the user clicks a node on the tree and then utilize any of the other stored procedures to access the data.

spGetEntityAccess

This procedure is used to check what permission the user has on a given Entity, if any:

ALTER Procedure [dbo].[spGetEntityAccess](
@OrgID int,
@EntityID int,
@TargetEntityID int)

The @EntityID parameter is EntityID of the current user and the @TargetEntityID parameter is the EntityID of the target Entity. Thus, to see the permissions that user 9163 has on Entity 9191 you would do:

spGetEntityAccess 577, 9163, 9191

This would return something like:

In this example, we see that user 9161 has AccessType 3 (Modify) permissions on Entity 9191. If no record is returned, the user has no access rights to the Entity. The returned AccessID is an internal pointer that is automatically generated and you can safely ignore.

Other EntityAccess Procedures

There are quite a few “EntityAccess” stored procedure for you to choose from. These variations on the same theme allow you to select the best stored procedure to meet your precise needs. All of the EntityAccess procedures implicitly implement Raptive security.

### Reading Entity Data via SQL—Unsecured

Let's look at some of the other procedures for reading data. These are optimized for speed and do not implicitly implement Raptive security. Once again, the idea here is that once the user has passed the security “gate” by selecting an Entity from a list generated by an EntityAccess procedure, you can use the speed optimized procedures.

spEntityCount

This procedure returns the number of Entities in the specified Organization.

```
ALTER PROCEDURE [dbo].[spEntityCount]
    @OrgID int,
  @Retval int = NULL OUTPUT
```

spEntity_Select

This procedure returns all of the information from the Entity table for a given EntityID.

```
ALTER PROCEDURE [dbo].[spEntity_Select]
    @OrgID int,
  @EntityID int
```

spEntity_Search

This procedure is a good basic search tool for looking up Entities. Here are the parameters:

```
ALTER PROCEDURE [dbo].[spEntity_Search] (
    @OrgID int,
    @ParentEntityID int,
  @EntityID int)
```

This procedure can be called four different ways to get different results:

spEntity_Search 577, null, null -- return all Entities for Org 577
spEntity_Search 577, null, 9163 -- return just info for Entity 9163
spEntity_Search 577, 9163, null -- return a list Entity 9163's children
spEntity_Search 577, 9163, 9601 -- verify that 9601 is a child of 9163

Here is an example of the return:

Note: Earlier versions of Raptive allowed different descriptions. In the current version of Raptive, the Description and EntityTypeDescription fields will always contain the same data. The EntityTypeDescription field is duplicated to maintain backwards compatibility.

spGetEntityIDbyUniqueID

This procedure will search for an Entity by the UniqueID. You can optionally narrow the search to return only Entities of a given EntityType and UniqueID.

```
ALTER PROCEDURE [dbo].[spGetEntityIDbyUniqueID]
    @OrgID int,
    @EntityTypeID int,
  @UniqueID varchar(200)
```

Here is an example of searching for Entities by the UniqueID:
spGetEntityIDbyUniqueID 577, null, ‘Wayne Hammerly’

Since there could be more than one Entity with a UniqueID but different Entity Types, you can narrow the search by specifying the EntityType as well:
spGetEntityIDbyUniqueID 577, 104 ‘Wayne Hammerly’

spGetEntityBy CatType

This procedure allows you to find all of the Entities of a given CategoryType. Here is an example that will return all of the Entities that have a CategoryType of 2 (User):

spGetEntityByCatType 577, 2

### Reading Entity Attribute Data via SQL

When building a custom UI for your Raptive database, you will almost always present the user with some means of selecting the Entity from a tree or list and then presenting the Entity Attributes for a single Entity based on the user's selection. Here are the commonly used Read procedures that work with the Entity Attributes table.

spIntEntityAttribute_Select

This procedure will return all of the information for all of Attributes for a specified Entity, ordered by the DisplayID.

ALTER Procedure [dbo].[spIntEntityAttribute_Select](
@OrgID int,
@EntityID int)

Here is the syntax to return the Attributes for our example Employee, Wayne Hammerly:

spIntEntityAttribute_Select 577, 9163

And here is what is returned:

At this point, we have all of the Attribute information for Employee—Wayne Hammerly (Entity 9163). Let's look at one of the many possible ways to display this data to a web page. The trick here is to get the proper value for the Attribute based on the Attribute's DataType. You may recall from our previous examinations that the actual data can be stored in the following fields based on the DataType:
ValueText—A field for storing alphanumeric values.
   TextLen—The length of the text if the DataType is an alphanumeric value.
ValueNumber—A field for storing numeric values.
   DecimalPlaces—The number of decimal places if the DataType is numeric.
ValueNumber—A field for storing date and time values.

Formatting Entity Attribute Values

When using stored procedures, we recommend that you create a Function that returns a single formatted value regardless of the Data Type. Here is some example code that uses the spIntEntityAttribute_Select procedure and a SqlDataReader object (dr1) to build a .FormattedValue based on the Data Tye. This code snippet is used in the Raptive.Entity.EntityAttribute class to set the FormattedValue property and is provided here as an example.

```
    Select Case iDataType
  Case 1 ‘ integer boolean
    If Not IsDBNull(dr1.Item(“ValueNumber”)) Then
        .ValueNumber = dr1.Item(“ValueNumber”)
        .FormattedValue = .ValueNumber.ToString
    End If
  Case 2 ‘ text
    .ValueText = dr1.Item(“ValueText”).ToString
    .FormattedValue = .ValueText.ToString
  Case 3 ‘ boolean
    If Not IsDBNull(dr1.Item(“ValueNumber”)) Then
        .ValueNumber = dr1.Item(“ValueNumber”)
        If CBool(.ValueNumber) = True Then
            .FormattedValue = “Yes/True”
        Else
          .FormattedValue = “No/False”
        End If
    End If
  Case 4, 7 ‘ number, Hours/Minutes
    If Not IsDBNull(dr1.Item(“ValueNumber”)) Then
        .ValueNumber = dr1.Item(“ValueNumber”)
        1ValueNumber = .ValueNumber * (10 \hat{ } (−iDecimalPlaces))
        .FormattedValue = 1ValueNumber.ToString
    End If
  Case 5 ‘ date
    If Not IsDBNull(dr1.Item(“ValueDateTime”)) Then
          .ValueDateTime = dr1.Item(“ValueDateTime”)
          .FormattedValue = .ValueDateTime.ToString
    End If
  Case 6 ‘ money
    If Not IsDBNull(dr1.Item(“ValueNumber”)) Then
        .ValueNumber = dr1.Item(“ValueNumber”)
        Dim dValueNumber As Double
        dValueNumber = .ValueNumber * (10 \hat{ } (−2))
        .FormattedValue = Format(dValueNumber, “Currency”)
    End If
  Case 8 ‘ Time
    If Not IsDBNull(dr1.Item(“ValueDateTime”)) Then
        .ValueDateTime = dr1.Item(“ValueDateTime”)
        Dim iHour As Integer
        Dim iMin As Integer
        Dim sQualifier As String = “”
        iHour = DatePart(“h”, .ValueDateTime)
        iMin = DatePart(“n”, .ValueDateTime)
        if miClockSetting = 12 Then
          If iHour > 12 Then
              iHour = iHour − 12
              sQualifier = “ pm”
          Else
              sQualifier = “ am”
          End If
        End If
        Dim sHour As String
        Dim sMin As String
        sHour = iHour.ToString
        If Len(sHour) = 1 Then sHour = “0” & sHour
        sMin = iMin.ToString
        If Len(sMin) = 1 Then sMin = sMin & “0”
        .FormattedValue = sHour.ToString & “;” & sMin.ToString & _{—}
                                                sQualifier
    End If
  Case 9 ‘ Dropdown
    If Not IsDBNull(dr1.Item(“ValueNumber”)) Then
        .ValueNumber = dr1.Item(“ValueNumber”)
        .ValueText = dr1.Item(“ValueText”).ToString
        .FormattedValue = .ValueText.ToString
    End If
  Case 10 ‘ Hours in Tenths
    If Not IsDBNull(dr1.Item(“ValueNumber”)) Then
        .ValueNumber = dr1.Item(“ValueNumber”)
        1ValueNumber = .ValueNumber
        Dim ihours As Int16
        ihours = 1ValueNumber \ 60
        Dim iremainder As Int16
        iremainder = 1ValueNumber − (ihours * 60)
        Dim iMins As Int16
        iMins = (iremainder \ 6)
        Dim sHour As String
        Dim sMin As String
        sHour = ihours.ToString
        If Len(sHour) = 1 Then sHour = “0” & sHour
        sMin = iMins.ToString
        If Len(sMin) = 1 Then sMin = sMin & “0”
        .FormattedValue = sHour.ToString & “;” & sMin.ToString
    End If
  Case 11 ‘Hours/Minutes
    If Not IsDBNull(dr1.Item(“ValueNumber”)) Then
        .ValueNumber = dr1.Item(“ValueNumber”)
        1ValueNumber = .ValueNumber
        Dim iHours As Int16
        iHours = Int(1ValueNumber / 60)
        Dim iMinutes As Int16
        iMinutes = 1ValueNumber − (iHours * 60)
        Dim newval As String
        newval = “0”
        If iHours <> 0 Then
          If iHours > 1 Then
              newval = iHours & “ Hours ”
          Else
              newval = iHours & “ Hour ”
          End If
        End If
        If iMinutes <> 0 Then
          If iMinutes > 1 Then
              newval = newval & iMinutes & “ Minutes”
          Else
              newval = newval & iMinutes & “ Minute”
          End If
        End If
        .FormattedValue = newval.ToString
    End If
  Case 12, 13, 14 ‘ Entities, CurrentUser Stamp, Current USer
    If Not IsDBNull(dr1.Item(“ValueNumber”)) Then
        .ValueNumber = dr1.Item(“ValueNumber”)
        1ValueNumber = .ValueNumber
        Dim LookupEntityID As Long
        LookupEntityID = 1ValueNumber
        If LookupEntityID <> 0 Then
          Dim dr2 As SqlDataReader
          sSQL = “spEntity...Search ” & OrgID.ToString & “, null,
          ” & _{—}
                                      LookupEntityID.ToString
          dr2 = EntityUtil.RunSQLReturnDataReader(sSQL)
          If dr2.HasRows Then
              dr2.Read( )
              .FormattedValue = dr2.Item(“UniqueID”).ToString
          Else
              .FormattedValue = “”
          End If
          dr2 = Nothing
        End If
    End If
  Case 15 ‘ Generated value
    If Not IsDBNull(dr1.Item(“ValueNumber”)) Then
        .ValueNumber = dr1.Item(“ValueNumber”)
        1ValueNumber = .ValueNumber
    End If
    .ValueText = dr1.Item(“ValueText”).ToString
    .FormattedValue = .ValueText
End Select
```

Notes: Data Type 12 is an Entity Relationship Attribute. Data Types 13 and 14 are Current Users.

sPEntityAttribute_Search

This procedure will return just the Entity Attribute specified by the EntityAttributeType.

```
ALTER PROCEDURE [dbo],[spEntityAttribute_Search] (
      @OrgID int,
      @EntityID int,
      @EntityAttributeType int)
```

This is handy when you are working with an Entity Template and need to retrieve information on a known Entity Attribute Type. It also returns information that would normally take 2 or more calls to obtain.

This procedure can be called two ways:

spEntityAttribute_Search 577, 9163, 1005
spEntityAttribute_Search 577, 9163, null

If the EntityAttributeType parameter is null, the procedure will return all of the Attributes for the Entity.

Here is an example where we want to return just the Last Name Attribute for an Employee. We can get the value of from either the EntityAttributeType table or from other stored procedures such as the spIntEntityAttribute_Select procedure we just examined.

spEntityAttribute_Search 577, 9163, 1005

The return contains 21 columns of data. For readability, we will return the one row on multiple lines of text:

Note: You must format the data using code such as the FormatValue function we examined in the previous section. Remember, DataTypes such as money will be returned in the ValueNumber field and will not have the decimal point in the correct place!

spAppEntityAttribute_Select

This procedure returns the Entity Attribute information and a formatted value for the selected Entity:

This procedure is will suited for situations where you want to simply display the Attributes for an Entity on a web page.

Note that this procedure will return an EntityID for following DataTypes:
12—Entity
13—Current User Updateable
14—Current User Stamp

You will probably want to display the data for these DataTypes as a hyperlink or using the UniqueID of the Entity. You can use spEntity_Search or spGetEntityAccessByType procedures to obtain the information on the EntityID value. At this point you may well question why we documented the FormatValue function using the spIntEntityAttribute_Select procedure when this stored procedure seems to do much the same thing with less code. We present both options to you so that you can choose what makes sense for your application. The idea here is that you use the spIntEntityAttribute_Select procedure when you need to utilize all of the information returned in that procedure on your page, and use spAppEntityAttribute_Select when you don't need the additional information.

spEntityAttribute_SearchByName

This procedure returns the same information as the spEntityAttribute_Search procedure we just examined, but allows you to search for the Attribute by name instead of the AttributeTypeID. This is handy when you do not know and do not want to look up the AttributeTypeID:

ALTER PROCEDURE [dbo].[spEntityAttribute_SearchByName](
@OrgID int,
@EntityID int,
@AttributeName varchar(255))

Here is an example of using this to find the value of the Last Name Attribute for Entity 9163:

spEntityAttribute_SearchByName 577, 9163, ‘Last Name’

This will return the same result set as the spEntityAttribute_Search procedure:

Reading Entity Activity Data via SQL

### Accessing Entity Relationships via SQL

### Searching for an Entity via SQL

### UPDATING/MODIFYING ENTITY DATA VIA RAPTIVE.NET

### UPDATING/MODIFYING ENTITY DATA VIA SQL

### UPDATING/MODIFYING ACTIVITY DATA VIA RAPTIVE.NET

### UPDATING/MODIFYING ACTIVITY DATA VIA SQL

### INSERTING ACTIVITY DATA VIA RAPTIVE.NET

### INSERTING ACTIVITY DATA VIA SQL

### CREATING A NEW ENTITY VIA RAPTIVE.NET

### CREATING A NEW ENTITY VIA SQL

### DELETING AN ENTITY VIA RAPTIVE.NET

### DELETING AN ENTITY VIA SQL

### THE RAPTIVE.NET OBJECT MODEL REFERENCE

The Raptive.Net Object Model provides access to the Raptive database via standard .Net classes. These classes are in the file \Raptive\bin\raptive.dll. The entire object model is located in the Raptive Namespace. Within this namespace are additional namespaces that divide the functionality into an easy to use structure:

### Raptive.Activity

ActivityInfo Class

### Namespace: Raptive.Activity

Assembly: Raptive.Activity (in Raptive.dll)

ActivityTemplate Class

### Namespace: Raptive.Activity

Assembly: Raptive.Activity (in Raptive.dll)

ActivityTemplateAttribute Class
Represents the schema of

### Namespace: Raptive.Activity

Assembly: Raptive.Activity (in Raptive.dll)

Activity Class

### Namespace: Raptive.Activity

Assembly: Raptive.Activity (in Raptive.dll)

ActivityAttribute Class
Represents the schema of

### Namespace: Raptive.Activity

Assembly: Raptive.Activity (in Raptive.dll)

ActivityHistory Class

### Namespace: Raptive.Activity

Assembly: Raptive.Activity (in Raptive.dll)

ActivityEntry Class

### Namespace: Raptive.Activity

Assembly: Raptive.Activity (in Raptive.dll)

Raptive.Data

DAL Class
Represents the schema of the DAL
   Namespace: Raptive. Data
   Assembly: Raptive.Data (in Raptive.dll)

Members:
RunSQLReturnDataReader
RunSQLReturnDataSet

Raptive.Definitions

Raptive.Entity

The Raptive.Entity namespace contains the classes used with Raptive Entities.

Address Class
Represents the schema of an Address in an Entity
   Namespace: Raptive. Entity
   Assembly: Raptive.Entity (in Raptive.dll)

The Address class is used to return an Entity Address, an Entity Contact Address, and a an Organization Address

### Methods:

Address, ClearPB Method

Clear (delete) the copy of this Address from the PropertyBag database. Typically this method is used by other classes but is available as a public method to handle specific instances when you wish to work at a finer level of granularity.

Address.LoadFromPB Method

Load with data from the PropertyBag database. The Address must already exist in the PropertyBag. Typically this method is used by other classes but is available as a public method to handle specific instances when you wish to work at a finer level of granularity.

Address.SavetoPB Method

Save a copy of this information to the PropertyBag database. Typically this method is used by other classes but is available as a public method to handle specific instances when you wish to work at a finer level of granularity.

AddressList Class
A strongly-typed collection of Address objects
Inherits System.Collections.ArrayList

### Namespace: Raptive.Entity

Assembly: Raptive.Entity (in Raptive.dll)

This class inherits the System.Collections.ArrayList class and is strongly-typed to only accept Address objects. Use this class just like you would use ArrayList.

Contact Class

Represents the schema of a Contact in an Entity

### Namespace: Raptive.Entity

Assembly: Raptive.Entity (in Raptive.dll)

### Property Notes:

The ContactAddresses property returns an AddressList collection containing Address objects.

The ContactPhones property returns a PhoneList collection containing Phone objects.

### Methods:

Contact.ClearPB Method

Clear (delete) the copy of this Address from the PropertyBag database. Typically this method is used by other classes but is available as a public method to handle specific instances when you wish to work at a finer level of granularity.

Contact.LoadFromPB Method

Load with data from the PropertyBag database. The Address must already exist in the PropertyBag. Typically this method is used by other classes but is available as a public method to handle specific instances when you wish to work at a finer level of granularity.

Contact.SavetoPB Method

Save a copy of this information to the PropertyBag database. Typically this method is used by other classes but is available as a public method to handle specific instances when you wish to work at a finer level of granularity.

ContactList Class
A strongly-typed collection of Contact objects
Inherits System.Collections.ArrayList

### Namespace: Raptive.Entity

Assembly: Raptive.Entity (in Raptive.dll)

This class inherits the System.Collections.ArrayList class and is strongly-typed to only accept Contact objects. Use this class just like you would use ArrayList.

### Entity Class

Represents the schema of an Entity

### Namespace: Raptive.Entity

Assembly: Raptive.Entity (in Raptive.dll)

Property Notes:

EntityAddresses returns an AddressList collection containing Address objects.
EntityAttributes returns an EntityAttributeList collection containing EntityAttribute objects.
EntityContacts returns a ContactList collection containing Contact objects.
EntityPhones returns a PhoneList collection containing Phone objects.

Each of these collection classes inherits the System.Collection.ArrayLists class.

### Methods:

Entity.Load Method

Read the Entity information from the Raptor database.

```
Public Function Load(ByVal OrgID As Long, ByVal EntityID As Long, _{—}
      ByVal LoadType As EntityLoadType) As Boolean
Public Function Load(ByVal OrgID As Long, ByVal EntityID As Long, _{—}
      ByVal LoadType As EntityLoadType, _{—}
      ByVal UserID As Long) As Boolean
```

### Parameters:

OrgID—The OrgID of the Organization.
EntityID—The EntityID of the Entity you wish to load.
LoadType—Specifies the type of load. There are three options and Visual Studio will display them via IntelliSense:
   Enums.EntityLoadType.Summary—Load only the information from the Entity table. Use this when you need the basic information such as the UniqueID, EntityType, or the CategoryType for the Entity.
   Enums.EntityLoadType.Detail—Load the information from the Entity and EntityAttribute tables. Use this when you need the Entity Attributes, but do not need or want the Address, Phone, and Contact information.
   Enums.EntityLoadType.LoadAll—Loads all of the information on the Entity including all Address, Phone, and Contact information.
UserID—If a UserID is specified, the Load method will utilize Raptive Security and only load the data if the UserID (the EntityID of the current user) as been granted access to the Entity.

### Example

```
Dim bLoaded As Boolean
Dim Entity As New Raptive.Entity.Entity
bLoaded = Entity.Load(OrgID, EntityID, _{—}
      Enums.EntityLoadType.LoadAll)
If bLoaded Then
  ‘ the entity is loaded with data
End If
```

See Also Raptive.EntityLoadType, Entity.Entity.Util.GetEntity, Entity.LoadFromPB

Entity.LoadFromPB Method

Read the Entity information from the PropertyBag database. The specified Entity must have already been saved to the PropertyBag using either the Entity.SaveToPB method or the spPBEntitylnsert stored procedure.

```
Public Function LoadFromPB(ByVal OrgID As Long, _{—}
      ByVal EntityID As Long, _{—}
      ByVal LoadType As EntityLoadType) As Boolean
```

### Parameters:

OrgID—The OrgID of the Organization.
EntityID—The EntityID of the Entity you wish to load.
LoadType—Specifies the type of load. There are three options and Visual Studio will display them via IntelliSense:
   Enums.EntityLoadType.Summary—Load only the information from the Entity table. Use this when you need the basic information such as the UniqueID, EntityType, or the CategoryType for the Entity.
   Enums.EntityLoadType.Detail—Load the information from the Entity and EntityAttribute tables. Use this when you need the Entity Attributes, but do not need or want the Address, Phone, and Contact information.
   Enums.EntityLoadType.LoadAll—Loads all of the information on the Entity including all Address, Phone, and Contact information.

Entity.ClearPB Method

Clear (delete) the copy of this Entity from the PropertyBag database. Typically this method is used by other classes but is available as a public method to handle specific instances when you wish to work at a finer level of granularity.

Entity.SavetoPB Method

Save a copy of this information to the PropertyBag database. Typically this method is used by other classes but is available as a public method to handle specific instances when you wish to work at a finer level of granularity.

Enums.EntityLoadType

A Public Enum (enumeration) that is used to specify how Entities are loaded.

```
Public Enum EntityLoadType As Integer
  Summary = 0 ' load just the Entity table info
  LoadAttributes = 1 ‘ load Entity and Entity Attributes info
  LoadAll = 2 ’ load all including address, phone, contact
End Enum
```

Here is an explanation of the values:
Enums.EntityLoadType.Summary—Load only the information from the Entity table. Use this when you need the basic information such as the UniqueID, EntityType, or the CategoryType for the Entity.
Enums.EntityLoadType.Detail—Load the information from the Entity and EntityAttribute tables. Use this when you need the Entity Attributes, but do not need or want the Address, Phone, and Contact information.
Enums.EntityLoadType.LoadAll—Loads all of the information on the Entity including all Address, Phone, and Contact information.

EntityAttribute Class

Represents the schema of an EntityAttribute in an Entity

### Namespace: Raptive.Entity

Assembly: Raptive.Entity (in Raptive.dll)

### Methods:

EntityAttribute.ClearPB Method

Clear (delete) the copy of this Attribute from the PropertyBag database. Typically this method is used by other classes but is available as a public method to handle specific instances when you wish to work at a finer level of granularity.

EntityAttribute.LoadFromPB Method

Load with data from the PropertyBag database. The Attribute must already exist in the PropertyBag. Typically this method is used by other classes but is available as a public method to handle specific instances when you wish to work at a finer level of granularity.

EntityAttribute.SavetoPB Method

Save a copy of this information to the PropertyBag database. Typically this method is used by other classes but is available as a public method to handle specific instances when you wish to work at a finer level of granularity.

EntityAttributeList Class
A strongly-typed collection of Entity Attribute objects
Inherits System.Collections.ArrayList

### Namespace: Raptive.Entity

Assembly: Raptive.Entity (in Raptive.dll)

This class inherits the System.Collections.ArrayList class and is strongly-typed to only accept EntityAttribute objects. Use this class just like you would use ArrayList.

EntityUtil Class
Class for Entity information and load methods
   Namespace: Raptive. Entity
   Assembly: Raptive.Entity (in Raptive.dll)

### GetEntityTemplateList Method

Public Function GetEntityTemplateList(ByVal OrgID As Long) _{—}
As EntityTemplateList

### GetEntityTemplateListBrief Method

### GetEntityTemplate Method

### GetEntity Method

### GetEntityChildCount Method

### GetEntityChild Method

### GetEntityChildList Method

### GetEntityParentCount Method

### GetEntityParent Method

### GetEntityParentList Method

### GetEntityChildCount

EntityTemplate Class

Namespace: Raptive. Entity
Assembly: Raptive.Entity (in Raptive.dll)

EntityTemplateAttribute Class
Represents the schema of an EntityTemplate
   Namespace: Raptive. Entity
   Assembly: Raptive.Entity (in Raptive.dll)

EntityTemplateAttributeList Class
A strongly-typed collection of EntityTemplateAttribute objects
Inherits System.Collections.ArrayList
   Namespace: Raptive. Entity
   Assembly: Raptive.Entity (in Raptive.dll)

EntityTemplateList Class
A strongly-typed collection of EntityTemplate objects
Inherits System.Collections.ArrayList
   Namespace: Raptive. Entity
   Assembly: Raptive.Entity (in Raptive.dll)

Phone Class
Represents the schema of a Phone in an Entity
   Namespace: Raptive. Entity
   Assembly: Raptive.Entity (in Raptive.dll)

PhoneList Class
A strongly-typed collection of Phone objects
Inherits System.Collections.ArrayList

### Namespace: Raptive.Entity

Assembly: Raptive.Entity (in Raptive.dll)

Raptive.Organization

Raptive.User

Raptive.Utils

Dropdown Class
Represents the schema of an dropdown list
   Namespace: Raptive. Utis
   Assembly: Raptive.Utils (in Raptive.dll)

### Property Notes:

The DropdownItems property returns a DropdownList collection containing DropdownItems objects.

### Methods:

Dropdown.GetAllDropdownLists

DropdownItem Class
Represents the schema of a DropdownItem
   Namespace: Raptive. Utis
   Assembly: Raptive.Utils (in Raptive.dll)

This class inherits the System.Collections.ArrayList class and is strongly-typed to only accept DropdownItem objects. Use this class just like you would use ArrayList.

DropdownList Class
A strongly-typed collection of DropdownItem objects
Inherits System.Collections.ArrayList

### Namespace:Raptive.Utils

Assembly: Raptive.Utils (in Raptive.dll)

TypeTableList Class
A strongly-typed collection of TypeTableItem objects
Inherits System.Collections.ArrayList

### Namespace:Raptive.Utils

Assembly: Raptive.Utils (in Raptive.dll)

TypeTableItem Class
Represents the schema of a TypeTableItem
   Namespace: Raptive. Utls
   Assembly: Raptive.Utils (in Raptive.dll)

What is claimed is:

1. A database architecture comprising:
a relational database management system;
a database schema;
the database schema being object oriented;
the database schema being entity centric; and,
the database schema running on the relational database management system.

2. The database architecture of claim 1 further comprising:
a plurality of entities stored in the database architecture;
each one of said entities being related to at least another one of said entities; and,
the relationship including at least one of an attribute relationship and a hierarchical relationship.

3. The database architecture of claim 2 wherein a plurality of the relationships comprise attribute and hierarchical relationships.

4. The database architecture of claim 3 wherein no primary keys are used.

5. The database architecture of claim 4 wherein no foreign keys are used.
